(19) United States
(12) Patent Application Publication
(10) Pub. No.: US 2023/0319860 A1
(43) Pub. Date: Oct. 5, 2023

(54) Communication Method, Apparatus, and System

(71) Applicant: Huawei Technologies Co., Ltd., Shenzhen (CN)

(72) Inventors: Yongxia Lyu, Shenzhen (CN); Ting Wang, Shanghai (CN); Jun Wang, Shanghai (CN); Jianglei Ma, Ottawa (CA)

(21) Appl. No.: 18/309,104

(22) Filed: Apr. 28, 2023

Related U.S. Application Data
(63) Continuation of application No. PCT/CN2021/125901, filed on Oct. 22, 2021.

(30) Foreign Application Priority Data
Oct. 31, 2020 (CN) 202011198190.4

(51) Int. Cl. H04W 72/51; H04W 72/232; H04W 72/04

(52) U.S. Cl. CPC H04W 72/51; H04W 72/04; H04W 72/232

(57) ABSTRACT

A communication method, apparatus, and system are provided, related to the field of communication technologies. The method includes, the terminal device determines a first value candidate set. The first value candidate set corresponds to a terminal type of the terminal device, and the first value candidate set includes a value candidate set of a radio resource control RRC parameter corresponding to the terminal type. The terminal device receives a first value from the network device. The first value includes a group of RRC parameter values in the first value candidate set. The terminal device performs communication based on the first value.

### CROSS-REFERENCE TO RELATED APPLICATIONS

This application is a continuation of International Application No. PCT/CN2021/125901, filed on Oct. 22, 2021, which claims priority to Chinese Patent Application No. 202011198190.4, filed on Oct. 31, 2020. The disclosures of the aforementioned applications are hereby incorporated by reference in their entireties.

### TECHNICAL FIELD

The present disclosure relates to the field of communication technologies, and in particular, to a communication method, apparatus, and system.

### BACKGROUND

In an existing new radio (NR) communication system, a network device may configure a plurality of RRC parameters for a terminal device by using radio resource control (RRC) signaling, so that the terminal device performs communication based on the plurality of RRC parameters.

Specifically, the network device may schedule the RRC signaling to send the plurality of RRC parameters to the terminal device through scheduling at a physical layer, for example, by controlling receiving and sending of downlink control information (DCI) and receiving and sending of a data channel.

However, the plurality of RRC parameters carried in the RRC signaling are pre-specified in a communication protocol, there are a large quantity of RRC parameters, and a same RRC parameter has a large quantity of values. Therefore, when configuring the plurality of RRC parameters for the terminal device, the network device needs to send a full value set of each RRC parameter to the terminal device, resulting in high RRC signaling overheads, high storage overheads of the terminal device, and high power consumption of the terminal device.

In addition, when the network device sends the DCI to the terminal device to schedule the RRC signaling or a data signal, because a format of the DCI is a fixed format pre-specified in the communication protocol, signaling overheads of the DCI are high, resulting in low spectral efficiency of the communication system and high power consumption of the terminal device.

### SUMMARY

In view of this, this application aims at providing a communication method, apparatus, and system, to resolve a technical problem that, when configuring a plurality of RRC parameters for a terminal device, a network device needs to send a full value set of each RRC parameter to the terminal device, resulting in high RRC signaling overheads, high storage overheads of the terminal device, and high power consumption of the terminal device.

According to a first aspect, an embodiment of this application provides a communication method. The method includes: A terminal device determines a first value candidate set. The first value candidate set corresponds to a terminal type of the terminal device, and the first value candidate set includes a value candidate set of a radio resource control RRC parameter corresponding to the terminal type. The terminal device receives a first value from a network device. The first value includes a group of RRC parameter values in the first value candidate set. The terminal device performs communication based on the first value.

According to the first aspect, the first value candidate set corresponding to the terminal type is determined based on the terminal type, so that the network device can determine the first value for the terminal device from the first value candidate set. This prevents the network device from sending a full value set of each RRC parameter to the terminal device, thereby reducing RRC signaling overheads, reducing storage overheads of the terminal device, and reducing power consumption of the terminal device.

In a possible design, a type of the RRC parameter corresponding to the terminal type includes one or more of the following: a data transmission configuration parameter, a channel state information CSI measurement and feedback configuration parameter, an initial access configuration parameter, a mobility configuration parameter, a power control configuration parameter, and a beam management configuration parameter.

In a possible design, the value candidate set of the RRC parameter indicates a configuration manner of the RRC parameter. The configuration manner includes a configuration parameter field, and the configuration parameter field includes a configuration parameter of the configuration manner. Alternatively, the configuration manner includes a configuration parameter.

Based on the possible design, a feasible solution is provided for designing the value candidate set of the RRC parameter.

In a possible design, the terminal device receives the first value candidate set from the network device.

In a possible design, before the terminal device receives the first value candidate set from the network device, the method further includes: the terminal device sends first request information to the network device, where the first request information is used to request the value candidate set of the RRC parameter corresponding to the terminal type.

In a possible design, the terminal device sends first feature information to the network device. The first feature information indicates the terminal type.

Based on the foregoing three possible designs, the network device can determine, based on the first request information or the first feature information sent by the terminal device, the first value candidate set corresponding to the terminal type of the terminal device, and send the first value candidate set to the terminal device. This provides a feasible solution for the terminal device to determine the first value candidate set.

In a possible design, when the terminal type is an enhanced mobile broadband eMBB device, a type of an RRC parameter corresponding to the eMBB includes the data transmission configuration parameter, the channel state information CSI measurement and feedback configuration parameter, the initial access configuration parameter, the mobility configuration parameter, the power control configuration parameter, and the beam management configuration parameter; and/or when the terminal type is an ultra-reliable low-latency communication URLLC device, a type of an RRC parameter corresponding to the URLLC includes the data transmission configuration parameter, the channel state information CSI measurement and feedback configuration parameter, and the beam management configuration parameter; and/or when the terminal type is an Internet of Things IoT device, a type of an RRC parameter corresponding to the IoT includes the data transmission configuration parameter, the initial access configuration parameter, and the mobility configuration parameter; and/or; when the terminal type is customer premises equipment CPE, a type of an RRC parameter corresponding to the CPE includes the data transmission configuration parameter and the channel state information CSI measurement and feedback configuration parameter.

Based on the possible design, the type of the RRC parameter corresponding to the terminal type can be determined based on the terminal type, to implement customization of the RRC parameter of the terminal type. This can meet a communication requirement of the terminal device and reduce the signaling overheads.

In a possible design, when the terminal type is the enhanced mobile broadband eMBB device, a value candidate set of a subcarrier spacing configuration parameter in the data transmission configuration parameter is 15 kHz, 30 kHz, 120 kHz, and 240 kHz, a value candidate set of a CSI reporting time domain configuration parameter in the CSI measurement and feedback configuration parameter is periodic reporting, aperiodic reporting, and semi-persistent reporting, and a value candidate set of a beam failure recovery timing parameter in the beam management configuration parameter is 10 ms, 20 ms, 40 ms, 60 ms, 80 ms, 100 ms, 150 ms, and 200 ms; and/or when the terminal type is the ultra-reliable low-latency URLLC communication device, a value candidate set of a subcarrier spacing configuration parameter in the data transmission configuration parameter is 30 kHz, 60 kHz, and 120 kHz, a value candidate set of a CSI reporting time domain configuration parameter in the CSI measurement and feedback configuration parameter is aperiodic reporting, and a value candidate set of a beam failure recovery timing parameter in the beam management configuration parameter is 10 ms, 20 ms, and 40 ms; and/or when the terminal type is the Internet of Things IoT device, a value candidate set of a subcarrier spacing configuration parameter in the data transmission configuration parameter is 15 kHz and 120 kHz; and/or; when the terminal type is the customer premises equipment CPE, a value of a subcarrier spacing configuration parameter in the data transmission configuration parameter is 15 kHz or 120 kHz, and a value candidate set of a CSI reporting time domain configuration parameter in the CSI measurement and feedback configuration parameter is periodic reporting.

Based on the possible design, the value candidate set of the RRC parameter corresponding to the terminal type can be determined based on the terminal type, to implement customization of the value candidate set of the RRC parameter of the terminal type. This can meet the communication requirement of the terminal device and reduce the signaling overheads.

In a possible design, the terminal type is determined based on one or more of the following factors: a service type, mobility, a transmission latency requirement, a channel environment, a reliability requirement, a coverage requirement, and a communication scenario.

Based on the possible design, the network device and/or the terminal device can determine the terminal type based on the foregoing factor, to determine, for the terminal type, an RRC parameter that meets the communication requirement. This reduces the signaling overheads.

According to a second aspect, an embodiment of this application provides a terminal device. The terminal device may implement functions performed by the terminal device in the first aspect or the possible designs of the first aspect, and the functions may be implemented by hardware executing corresponding software. The hardware or the software includes one or more modules corresponding to the functions, for example, a processing module and a transceiver module. The processing module is configured to determine a first value candidate set. The first value candidate set corresponds to a terminal type of the terminal device, and the first value candidate set includes a value candidate set of a radio resource control RRC parameter corresponding to the terminal type. The transceiver module is configured to receive a first value from a network device. The first value includes a group of RRC parameter values in the first value candidate set. The processing module is configured to perform communication based on the first value.

In a possible design, a type of the RRC parameter corresponding to the terminal type includes one or more of the following: a data transmission configuration parameter, a channel state information CSI measurement and feedback configuration parameter, an initial access configuration parameter, a mobility configuration parameter, a power control configuration parameter, and a beam management configuration parameter.

In a possible design, the value candidate set of the RRC parameter indicates a configuration manner of the RRC parameter. The configuration manner includes a configuration parameter field, and the configuration parameter field includes a configuration parameter of the configuration manner. Alternatively, the configuration manner includes a configuration parameter.

In a possible design, the transceiver module is further configured to receive the first value candidate set from the network device.

In a possible design, before receiving the first value candidate set from the network device, the transceiver module is further configured to send first request information to the network device. The first request information is used to request the value candidate set of the RRC parameter corresponding to the terminal type.

In a possible design, the transceiver module is further configured to send first feature information to the network device. The first feature information indicates the terminal type.

In a possible design, when the terminal type is an enhanced mobile broadband eMBB device, a type of an RRC parameter corresponding to the eMBB includes the data transmission configuration parameter, the channel state information CSI measurement and feedback configuration parameter, the initial access configuration parameter, the mobility configuration parameter, the power control configuration parameter, and the beam management configuration parameter; and/or when the terminal type is an ultra-reliable low-latency communication URLLC device, a type of an RRC parameter corresponding to the URLLC includes the data transmission configuration parameter, the channel state information CSI measurement and feedback configuration parameter, and the beam management configuration parameter; and/or when the terminal type is an Internet of Things IoT device, a type of an RRC parameter corresponding to the IoT includes the data transmission configuration parameter, the initial access configuration parameter, and the mobility configuration parameter; and/or; when the terminal type is customer premises equipment CPE, a type of an RRC parameter corresponding to the CPE includes the data transmission configuration parameter and the channel state information CSI measurement and feedback configuration parameter.

In a possible design, when the terminal type is the enhanced mobile broadband eMBB device, a value candidate set of a subcarrier spacing configuration parameter in the data transmission configuration parameter is 15 kHz, 30 kHz, 120 kHz, and 240 kHz, a value candidate set of a CSI reporting time domain configuration parameter in the CSI measurement and feedback configuration parameter is periodic reporting, aperiodic reporting, and semi-persistent reporting, and a value candidate set of a beam failure recovery timing parameter in the beam management configuration parameter is 10 ms, 20 ms, 40 ms, 60 ms, 80 ms, 100 ms, 150 ms, and 200 ms; and/or when the terminal type is the ultra-reliable low-latency communication URLLC device, a value candidate set of a subcarrier spacing configuration parameter in the data transmission configuration parameter is 30 kHz, 60 kHz, and 120 kHz, a value candidate set of a CSI reporting time domain configuration parameter in the CSI measurement and feedback configuration parameter is aperiodic reporting, and a value candidate set of a beam failure recovery timing parameter in the beam management configuration parameter is 10 ms, 20 ms, and 40 ms; and/or when the terminal type is the Internet of Things IoT device, a value candidate set of a subcarrier spacing configuration parameter in the data transmission configuration parameter is 15 kHz and 120 kHz; and/or; when the terminal type is the customer premises equipment CPE, a value of a subcarrier spacing configuration parameter in the data transmission configuration parameter is 15 kHz or 120 kHz, and a value candidate set of a CSI reporting time domain configuration parameter in the CSI measurement and feedback configuration parameter is periodic reporting.

In a possible design, the terminal type is determined based on one or more of the following factors: a service type, mobility, a transmission latency requirement, a channel environment, a reliability requirement, a coverage requirement, and a communication scenario.

According to a third aspect, an embodiment of this application provides a terminal device. The terminal device may be a terminal device or a chip or a system on a chip in a terminal device. The terminal device may implement functions performed by the terminal device in the foregoing aspects or the possible designs, and the functions may be implemented by hardware. In a possible design, the terminal device may include a transceiver and a processor. The transceiver and the processor may be configured to support the terminal device in implementing functions in any one of the first aspect or the possible designs of the first aspect. For example, the processor is configured to determine a first value candidate set. The first value candidate set corresponds to a terminal type of the terminal device, and the first value candidate set includes a value candidate set of a radio resource control RRC parameter corresponding to the terminal type. The transceiver is configured to receive a first value from a network device. The first value includes a group of RRC parameter values in the first value candidate set. The processor is configured to perform communication based on the first value. In another possible design, the terminal device may further include a memory. The memory is configured to store computer-executable instructions and data that are necessary for the terminal device. When the terminal device runs, the transceiver and the processor execute the computer-executable instructions stored in the memory, to enable the terminal device to perform the communication method according to any one of the first aspect or the possible designs of the first aspect.

For a specific implementation of the terminal device in the second aspect and the third aspect, refer to behavior functions of the terminal device in the communication method according to any one of the first aspect or the possible designs of the first aspect.

According to a fourth aspect, an embodiment of this application provides a communication method. The method includes: A network device determines a first value. The network device sends the first value to a terminal device. The first value includes a group of RRC parameter values in a first value candidate set. The first value candidate set corresponds to a terminal type of the terminal device, and the first value candidate set includes a value candidate set of a radio resource control RRC parameter corresponding to the terminal type.

According to the fourth aspect, the first value candidate set corresponding to the terminal type is determined based on the terminal type, so that the network device can determine the first value for the terminal device from the first value candidate set. This prevents the network device from sending a full value set of each RRC parameter to the terminal device, thereby reducing RRC signaling overheads, reducing storage overheads of the terminal device, and reducing power consumption of the terminal device.

In a possible design, a type of the RRC parameter corresponding to the terminal type includes one or more of the following: a data transmission configuration parameter, a channel state information CSI measurement and feedback configuration parameter, an initial access configuration parameter, a mobility configuration parameter, a power control configuration parameter, and a beam management configuration parameter.

In a possible design, the value candidate set of the RRC parameter indicates a configuration manner of the RRC parameter. The configuration manner includes a configuration parameter field, and the configuration parameter field includes a configuration parameter of the configuration manner. Alternatively, the configuration manner includes a configuration parameter.

Based on the possible design, a feasible solution is provided for designing the value candidate set of the RRC parameter.

In a possible design, the network device sends the first value candidate set to the terminal device.

In a possible design, before the network device sends the first value candidate set to the terminal device, the method further includes the network device receives first request information from the terminal device, where the first request information is used to request the value candidate set of the RRC parameter corresponding to the terminal type.

In a possible design, the network device receives first feature information from the terminal device. The first feature information indicates the terminal type.

Based on the foregoing three possible designs, the network device can determine, based on the first request information or the first feature information sent by the terminal device, the first value candidate set corresponding to the terminal type of the terminal device, and send the first value candidate set to the terminal device. This provides a feasible solution for the terminal device to determine the first value candidate set.

In a possible design, when the terminal type is an enhanced mobile broadband eMBB device, a type of an RRC parameter corresponding to the eMBB includes the data transmission configuration parameter, the channel state information CSI measurement and feedback configuration parameter, the initial access configuration parameter, the mobility configuration parameter, the power control configuration parameter, and the beam management configuration parameter; and/or when the terminal type is an ultra-reliable low-latency communication URLLC device, a type of an RRC parameter corresponding to the URLLC includes the data transmission configuration parameter, the channel state information CSI measurement and feedback configuration parameter, and the beam management configuration parameter; and/or when the terminal type is an Internet of Things IoT device, a type of an RRC parameter corresponding to the IoT includes the data transmission configuration parameter, the initial access configuration parameter, and the mobility configuration parameter; and/or; when the terminal type is customer premises equipment CPE, a type of an RRC parameter corresponding to the CPE includes the data transmission configuration parameter and the channel state information CSI measurement and feedback configuration parameter.

Based on the possible design, the type of the RRC parameter corresponding to the terminal type can be determined based on the terminal type, to implement customization of the RRC parameter of the terminal type. This can meet a communication requirement of the terminal device and reduce the signaling overheads.

In a possible design, when the terminal type is the enhanced mobile broadband eMBB device, a value candidate set of a subcarrier spacing configuration parameter in the data transmission configuration parameter is 15 kHz, 30 kHz, 120 kHz, and 240 kHz, a value candidate set of a CSI reporting time domain configuration parameter in the CSI measurement and feedback configuration parameter is periodic reporting, aperiodic reporting, and semi-persistent reporting, and a value candidate set of a beam failure recovery timing parameter in the beam management configuration parameter is 10 ms, 20 ms, 40 ms, 60 ms, 80 ms, 100 ms, 150 ms, and 200 ms; and/or when the terminal type is the ultra-reliable low-latency communication URLLC device, a value candidate set of a subcarrier spacing configuration parameter in the data transmission configuration parameter is 30 kHz, 60 kHz, and 120 kHz, a value candidate set of a CSI reporting time domain configuration parameter in the CSI measurement and feedback configuration parameter is aperiodic reporting, and a value candidate set of a beam failure recovery timing parameter in the beam management configuration parameter is 10 ms, 20 ms, and 40 ms; and/or when the terminal type is the Internet of Things IoT device, a value candidate set of a subcarrier spacing configuration parameter in the data transmission configuration parameter is 15 kHz and 120 kHz; and/or; when the terminal type is the customer premises equipment CPE, a value of a subcarrier spacing configuration parameter in the data transmission configuration parameter is 15 kHz or 120 kHz, and a value candidate set of a CSI reporting time domain configuration parameter in the CSI measurement and feedback configuration parameter is periodic reporting.

Based on the possible design, the value candidate set of the RRC parameter corresponding to the terminal type can be determined based on the terminal type, to implement customization of the value candidate set of the RRC parameter of the terminal type. This can meet the communication requirement of the terminal device and reduce the signaling overheads.

In a possible design, the terminal type is determined based on one or more of the following factors: a service type, mobility, a transmission latency requirement, a channel environment, a reliability requirement, a coverage requirement, and a communication scenario.

Based on the possible design, the network device and/or the terminal device can determine the terminal type based on the foregoing factor, to determine, for the terminal type, an RRC parameter that meets the communication requirement. This reduces the signaling overheads.

According to a fifth aspect, an embodiment of this application provides a network device. The network device may implement functions performed by the network device in the fourth aspect or the possible designs of the fourth aspect, and the functions may be implemented by hardware executing corresponding software. The hardware or the software includes one or more modules corresponding to the functions, for example, a processing module and a transceiver module. The processing module is configured to determine a first value. The transceiver module is configured to send the first value to a terminal device. The first value includes a group of RRC parameter values in a first value candidate set. The first value candidate set corresponds to a terminal type of the terminal device, and the first value candidate set includes a value candidate set of a radio resource control RRC parameter corresponding to the terminal type.

In a possible design, a type of the RRC parameter corresponding to the terminal type includes one or more of the following: a data transmission configuration parameter, a channel state information CSI measurement and feedback configuration parameter, an initial access configuration parameter, a mobility configuration parameter, a power control configuration parameter, and a beam management configuration parameter.

In a possible design, the value candidate set of the RRC parameter indicates a configuration manner of the RRC parameter. The configuration manner includes a configuration parameter field, and the configuration parameter field includes a configuration parameter of the configuration manner. Alternatively, the configuration manner includes a configuration parameter.

In a possible design, the transceiver module is further configured to send the first value candidate set to the terminal device.

In a possible design, before sending the first value candidate set to the terminal device, the transceiver module is further configured to receive first request information from the terminal device. The first request information is used to request the value candidate set of the RRC parameter corresponding to the terminal type.

In a possible design, the transceiver module is further configured to receive first feature information from the terminal device. The first feature information indicates the terminal type.

In a possible design, when the terminal type is an enhanced mobile broadband eMBB device, a type of an RRC parameter corresponding to the eMBB includes the data transmission configuration parameter, the channel state information CSI measurement and feedback configuration parameter, the initial access configuration parameter, the mobility configuration parameter, the power control configuration parameter, and the beam management configuration parameter; and/or when the terminal type is an ultra-reliable low-latency communication URLLC device, a type of an RRC parameter corresponding to the URLLC includes the data transmission configuration parameter, the channel state information CSI measurement and feedback configuration parameter, and the beam management configuration parameter; and/or when the terminal type is an Internet of Things IoT device, a type of an RRC parameter corresponding to the IoT includes the data transmission configuration parameter, the initial access configuration parameter, and the mobility configuration parameter; and/or; when the terminal type is customer premises equipment CPE, a type of an RRC parameter corresponding to the CPE includes the data transmission configuration parameter and the channel state information CSI measurement and feedback configuration parameter.

In a possible design, when the terminal type is the enhanced mobile broadband eMBB device, a value candidate set of a subcarrier spacing configuration parameter in the data transmission configuration parameter is 15 kHz, 30 kHz, 120 kHz, and 240 kHz, a value candidate set of a CSI reporting time domain configuration parameter in the CSI measurement and feedback configuration parameter is periodic reporting, aperiodic reporting, and semi-persistent reporting, and a value candidate set of a beam failure recovery timing parameter in the beam management configuration parameter is 10 ms, 20 ms, 40 ms, 60 ms, 80 ms, 100 ms, 150 ms, and 200 ms; and/or when the terminal type is the ultra-reliable low-latency communication URLLC device, a value candidate set of a subcarrier spacing configuration parameter in the data transmission configuration parameter is 30 kHz, 60 kHz, and 120 kHz, a value candidate set of a CSI reporting time domain configuration parameter in the CSI measurement and feedback configuration parameter is aperiodic reporting, and a value candidate set of a beam failure recovery timing parameter in the beam management configuration parameter is 10 ms, 20 ms, and 40 ms; and/or when the terminal type is the Internet of Things IoT device, a value candidate set of a subcarrier spacing configuration parameter in the data transmission configuration parameter is 15 kHz and 120 kHz; and/or; when the terminal type is the customer premises equipment CPE, a value of a subcarrier spacing configuration parameter in the data transmission configuration parameter is 15 kHz or 120 kHz, and a value candidate set of a CSI reporting time domain configuration parameter in the CSI measurement and feedback configuration parameter is periodic reporting.

In a possible design, the terminal type is determined based on one or more of the following factors: a service type, mobility, a transmission latency requirement, a channel environment, a reliability requirement, a coverage requirement, and a communication scenario.

According to a sixth aspect, an embodiment of this application provides a network device. The network device may be a network device or a chip or a system on a chip in a network device. The network device may implement functions performed by the network device in the foregoing aspects or the possible designs, and the functions may be implemented by hardware. In a possible design, the network device may include a transceiver and a processor. The transceiver and the processor may be configured to support the network device in implementing functions in any one of the fourth aspect or the possible designs of the fourth aspect. For example, the processor is configured to determine a first value. The transceiver is configured to send the first value to a terminal device. The first value includes a group of RRC parameter values in a first value candidate set. The first value candidate set corresponds to a terminal type of the terminal device, and the first value candidate set includes a value candidate set of a radio resource control RRC parameter corresponding to the terminal type. In another possible design, the network device may further include a memory. The memory is configured to store computer-executable instructions and data that are necessary for the network device. When the network device runs, the transceiver and the processor execute the computer-executable instructions stored in the memory, to enable the network device to perform the communication method according to any one of the fourth aspect or the possible designs of the fourth aspect.

For a specific implementation of the network device in the fifth aspect and the sixth aspect, refer to behavior functions of the network device in the communication method according to any one of the fourth aspect or the possible designs of the fourth aspect.

According to a seventh aspect, an embodiment of this application provides a communication method. The method includes: A terminal device receives first downlink control information DCI from a network device. The first DCI includes values of a plurality of DCI parameters, and the DCI parameter included in the first DCI corresponds to a terminal type of the terminal device. A candidate set of the value of the DCI parameter corresponds to the terminal type, and the candidate set includes at least one value of the DCI parameter corresponding to the terminal type. The terminal device performs communication based on the first DCI.

Based on the seventh aspect, DCI corresponding to the terminal device is determined for the terminal device in a customized manner based on the terminal type. This can reduce signaling overheads of the DCI, improve spectral efficiency of a communication system, and reduce power consumption of the terminal device.

In a possible design, that a terminal device receives first DCI from a network device includes: The terminal device determines a first DCI format. The first DCI format corresponds to the terminal type. The terminal device receives the first DCI from the network device based on the first DCI format.

Based on the possible design, a DCI format corresponding to the terminal device is determined for the terminal device in the customized manner based on the terminal type, so that the terminal device can receive the DCI from the network device based on the DCI format corresponding to the terminal device. This improves communication reliability.

In a possible design, the terminal device determines the candidate set of the value of the DCI parameter based on the first DCI format and a correspondence between a DCI format and the candidate set of the value of the DCI parameter.

Based on the possible design, the terminal device can parse, based on the correspondence between the DCI format and the candidate set of the value of the DCI parameter, the first DCI sent by the network device.

In a possible design, before the terminal device receives the first DCI from the network device, the method further includes: The terminal device receives indication information from the network device. The indication information indicates the DCI parameter corresponding to the terminal type and the candidate set of the value of the DCI parameter.

Based on the possible design, the terminal device can determine, based on the indication information sent by the network device, the DCI parameter corresponding to the terminal type and the candidate set of the value of the DCI parameter, and then parse the received first DCI.

In a possible design, before the terminal device receives the indication information from the network device, the method further includes: The terminal device sends second request information to the network device. The second request information is used to request the DCI parameter corresponding to the terminal type and the candidate set of the value of the DCI parameter.

In a possible design, the terminal device sends second feature information to the network device. The second feature information indicates the terminal type.

Based on the foregoing two possible designs, the terminal device can send the second request information or the second feature information to the network device, so that the network device determines, for the terminal device based on the second request information or the second feature information, the DCI parameter corresponding to the terminal type of the terminal device and the candidate set of the value of the DCI parameter.

In a possible design, when the terminal type is an enhanced mobile broadband eMBB device, a DCI parameter corresponding to the eMBB includes time domain resource assignment, frequency domain resource assignment, a bandwidth part BWP indicator, a modulation and coding scheme MCS, a new data indicator, a redundancy version, a hybrid automatic repeat request HARQ process number, HARQ timing, a transmit power control TPC command, an antenna port, precoding and a number of layers, a sounding reference signal SRS request, and a channel state information CSI request; and/or when the terminal type is an ultra-reliable low-latency communication URLLC device, a DCI parameter corresponding to the URLLC includes a time domain resource indicator, a frequency domain resource indicator, a modulation and coding scheme MCS, a new data indicator, a hybrid automatic repeat request HARQ process number, a transmit power control command, a sounding reference signal SRS request, and a channel state information CSI request; and/or when the terminal type is an Internet of Things IoT device, a DCI parameter corresponding to the IoT includes a frequency domain resource indicator, a modulation and coding scheme MCS, and a hybrid automatic repeat request HARQ process number; and/or when the terminal type is customer premises equipment CPE, a DCI parameter corresponding to the CPE includes time domain resource assignment, frequency domain resource assignment, a bandwidth part BWP indicator, a modulation and coding scheme MCS, a new data indicator, a redundancy version, a hybrid automatic repeat request HARQ process number, HARQ timing, a transmit power control TPC command, an antenna port, precoding and a number of layers, a sounding reference signal SRS request, and a channel state information CSI request.

Based on the possible design, the DCI parameter corresponding to the terminal type can be determined based on the terminal type, to implement customization of the DCI of the terminal type. This can meet a communication requirement of the terminal device and reduce the signaling overheads.

In a possible design, when the terminal type is the enhanced mobile broadband eMBB device, a quantity of bits corresponding to a candidate set of a value of the MCS parameter is 5, and a quantity of bits corresponding to a candidate set of a value of the HARQ process number parameter is 4; and/or when the terminal type is the ultra-reliable low-latency communication URLLC device, a quantity of bits corresponding to a candidate set of a value of the MCS parameter is 2 or 3, a quantity of bits corresponding to a candidate set of a value of the HARQ process number parameter is 1, a quantity of bits corresponding to a candidate set of a value of the sounding reference signal SRS request parameter is 1, and a quantity of bits corresponding to a candidate set of a value of the channel state information CSI request parameter is 1; and/or when the terminal type is the Internet of Things IoT device, a quantity of bits corresponding to a candidate set of a value of the MCS parameter is 2 or 3, and a quantity of bits corresponding to a candidate set of a value of the HARQ process number parameter is 1 or 2; and/or when the terminal type is the customer premises equipment CPE, a quantity of bits corresponding to a candidate set of a value of the MCS parameter is 2, 3, 4, or 5, and a quantity of bits corresponding to a candidate set of a value of the HARQ process number parameter is 4.

Based on the possible design, the candidate set of the value of the DCI parameter corresponding to the terminal type can be determined based on the terminal type, to implement customization of the candidate set of the value of the DCI parameter of the terminal type. This can meet the communication requirement of the terminal device and reduce the signaling overheads.

In a possible design, when the terminal type is an enhanced mobile broadband eMBB device, a DCI format corresponding to the eMBB is a format 1, and a DCI parameter corresponding to the format 1 and a candidate set of a value of the DCI parameter are as follows: A quantity of bits corresponding to a candidate set of a value of a modulation and coding scheme MCS parameter is 5, and a quantity of bits corresponding to a candidate set of a value of a hybrid automatic repeat request HARQ process number parameter is 4; and/or when the terminal type is an ultra-reliable low-latency communication URLLC device, a DCI format corresponding to the URLLC is a format 2, and a DCI parameter corresponding to the format 2 and a candidate set of a value of the DCI parameter are as follows: A quantity of bits corresponding to a candidate set of a value of a modulation and coding scheme MCS parameter is 2 or 3, a quantity of bits corresponding to a candidate set of a value of a hybrid automatic repeat request HARQ process number parameter is 1, a quantity of bits corresponding to a candidate set of a value of a sounding reference signal SRS request parameter is 1, and a quantity of bits corresponding to a candidate set of a value of a channel state information CSI request parameter is 1; and/or when the terminal type is an Internet of Things IoT device, a DCI format corresponding to the IoT is a format 3, and a DCI parameter corresponding to the format 3 and a candidate set of a value of the DCI parameter are as follows: A quantity of bits corresponding to a candidate set of a value of a modulation and coding scheme MCS parameter is 2 or 3, and a quantity of bits corresponding to a candidate set of a value of a hybrid automatic repeat request HARQ process number parameter is 1 or 2; and/or when the terminal type is customer premises equipment CPE, a DCI format corresponding to the IoT is a format 4, and a DCI parameter corresponding to the format 4 and a candidate set of a value of the DCI parameter are as follows: A quantity of bits corresponding to a candidate set of a value of a modulation and coding scheme MCS parameter is 2, 3, 4, or 5, and a quantity of bits corresponding to a candidate set of a value of a hybrid automatic repeat request HARQ process number parameter is 4.

Based on the possible design, the DCI format corresponding to the terminal type can be determined based on the terminal type, to implement customization of the DCI format corresponding to the terminal type. This helps the terminal device receive the DCI based on the DCI format corresponding to the terminal device, meets the communication requirement of the terminal device, and reduces the signaling overheads.

In a possible design, the terminal type is determined based on one or more of the following factors: a service type, mobility, a transmission latency requirement, a channel environment, a reliability requirement, a coverage requirement, and a communication scenario.

Based on the possible design, the network device and/or the terminal device can determine the terminal type based on the foregoing factor, to determine, for the terminal type, DCI that meets the communication requirement. This reduces the signaling overheads.

According to an eighth aspect, an embodiment of this application provides a terminal device. The terminal device may implement functions performed by the terminal device in the seventh aspect or the possible designs of the seventh aspect, and the functions may be implemented by hardware executing corresponding software. The hardware or the software includes one or more modules corresponding to the functions, for example, a transceiver module and a processing module. The transceiver module is configured to receive first downlink control information DCI from a network device. The first DCI includes values of a plurality of DCI parameters, and the DCI parameter included in the first DCI corresponds to a terminal type of the terminal device. A candidate set of the value of the DCI parameter corresponds to the terminal type, and the candidate set includes at least one value of the DCI parameter corresponding to the terminal type. The processing module is configured to perform communication based on the first DCI.

In a possible design, the processing module is further configured to determine a first DCI format. The first DCI format corresponds to the terminal type. The transceiver module is further configured to receive the first DCI from the network device based on the first DCI format.

In a possible design, the processing module is further configured to determine the candidate set of the value of the DCI parameter based on the first DCI format and a correspondence between a DCI format and the candidate set of the value of the DCI parameter.

In a possible design, the transceiver module is further configured to receive, by the terminal device, indication information from the network device. The indication information indicates the DCI parameter corresponding to the terminal type and the candidate set of the value of the DCI parameter.

In a possible design, before receiving the indication information from the network device, the transceiver module is further configured to send, by the terminal device, second request information to the network device. The second request information is used to request the DCI parameter corresponding to the terminal type and the candidate set of the value of the DCI parameter.

In a possible design, the transceiver module is further configured to send second feature information to the network device. The second feature information indicates the terminal type.

In a possible design, when the terminal type is an enhanced mobile broadband eMBB device, a DCI parameter corresponding to the eMBB includes time domain resource assignment, frequency domain resource assignment, a bandwidth part BWP indicator, a modulation and coding scheme MCS, a new data indicator, a redundancy version, a hybrid automatic repeat request HARQ process number, HARQ timing, a transmit power control TPC command, an antenna port, precoding and a number of layers, a sounding reference signal SRS request, and a channel state information CSI request; and/or when the terminal type is an ultra-reliable low-latency communication URLLC device, a DCI parameter corresponding to the URLLC includes a time domain resource indicator, a frequency domain resource indicator, a modulation and coding scheme MCS, a new data indicator, a hybrid automatic repeat request HARQ process number, a transmit power control command, a sounding reference signal SRS request, and a channel state information CSI request; and/or when the terminal type is an Internet of Things IoT device, a DCI parameter corresponding to the IoT includes a frequency domain resource indicator, a modulation and coding scheme MCS, and a hybrid automatic repeat request HARQ process number; and/or when the terminal type is customer premises equipment CPE, a DCI parameter corresponding to the CPE includes time domain resource assignment, frequency domain resource assignment, a bandwidth part BWP indicator, a modulation and coding scheme MCS, a new data indicator, a redundancy version, a hybrid automatic repeat request HARQ process number, HARQ timing, a transmit power control TPC command, an antenna port, precoding and a number of layers, a sounding reference signal SRS request, and a channel state information CSI request.

In a possible design, when the terminal type is the enhanced mobile broadband eMBB device, a quantity of bits corresponding to a candidate set of a value of the MCS parameter is 5, and a quantity of bits corresponding to a candidate set of a value of the HARQ process number parameter is 4; and/or when the terminal type is the ultra-reliable low-latency communication URLLC device, a quantity of bits corresponding to a candidate set of a value of the MCS parameter is 2 or 3, a quantity of bits corresponding to a candidate set of a value of the HARQ process number parameter is 1, a quantity of bits corresponding to a candidate set of a value of the sounding reference signal SRS request parameter is 1, and a quantity of bits corresponding to a candidate set of a value of the channel state information CSI request parameter is 1; and/or when the terminal type is the Internet of Things IoT device, a quantity of bits corresponding to a candidate set of a value of the MCS parameter is 2 or 3, and a quantity of bits corresponding to a candidate set of a value of the HARQ process number parameter is 1 or 2; and/or when the terminal type is the customer premises equipment CPE, a quantity of bits corresponding to a candidate set of a value of the MCS parameter is 2, 3, 4, or 5, and a quantity of bits corresponding to a candidate set of a value of the HARQ process number parameter is 4.

In a possible design, when the terminal type is an enhanced mobile broadband eMBB device, a DCI format corresponding to the eMBB is a format 1, and a DCI parameter corresponding to the format 1 and a candidate set of a value of the DCI parameter are as follows: A quantity of bits corresponding to a candidate set of a value of a modulation and coding scheme MCS parameter is 5, and a quantity of bits corresponding to a candidate set of a value of a hybrid automatic repeat request HARQ process number parameter is 4; and/or when the terminal type is an ultra-reliable low-latency communication URLLC device, a DCI format corresponding to the URLLC is a format 2, and a DCI parameter corresponding to the format 2 and a candidate set of a value of the DCI parameter are as follows: A quantity of bits corresponding to a candidate set of a value of a modulation and coding scheme MCS parameter is 2 or 3, a quantity of bits corresponding to a candidate set of a value of a hybrid automatic repeat request HARQ process number parameter is 1, a quantity of bits corresponding to a candidate set of a value of a sounding reference signal SRS request parameter is 1, and a quantity of bits corresponding to a candidate set of a value of a channel state information CSI request parameter is 1; and/or when the terminal type is an Internet of Things IoT device, a DCI format corresponding to the IoT is a format 3, and a DCI parameter corresponding to the format 3 and a candidate set of a value of the DCI parameter are as follows: A quantity of bits corresponding to a candidate set of a value of a modulation and coding scheme MCS parameter is 2 or 3, and a quantity of bits corresponding to a candidate set of a value of a hybrid automatic repeat request HARQ process number parameter is 1 or 2; and/or when the terminal type is customer premises equipment CPE, a DCI format corresponding to the IoT is a format 4, and a DCI parameter corresponding to the format 4 and a candidate set of a value of the DCI parameter are as follows: A quantity of bits corresponding to a candidate set of a value of a modulation and coding scheme MCS parameter is 2, 3, 4, or 5, and a quantity of bits corresponding to a candidate set of a value of a hybrid automatic repeat request HARQ process number parameter is 4.

In a possible design, the terminal type is determined based on one or more of the following factors: a service type, mobility, a transmission latency requirement, a channel environment, a reliability requirement, a coverage requirement, and a communication scenario.

According to a ninth aspect, an embodiment of this application provides a terminal device. The terminal device may be a terminal device or a chip or a system on a chip in a terminal device. The terminal device may implement functions performed by the terminal device in the foregoing aspects or the possible designs, and the functions may be implemented by hardware. In a possible design, the terminal device may include a transceiver and a processor. The transceiver and the processor may be configured to support the terminal device in implementing functions in any one of the seventh aspect or the possible designs of the seventh aspect. For example, the transceiver is configured to receive first downlink control information DCI from a network device. The first DCI includes values of a plurality of DCI parameters, and the DCI parameter included in the first DCI corresponds to a terminal type of the terminal device. A candidate set of the value of the DCI parameter corresponds to the terminal type, and the candidate set includes at least one value of the DCI parameter corresponding to the terminal type. The processor is configured to perform communication based on the first DCI. In another possible design, the terminal device may further include a memory. The memory is configured to store computer-executable instructions and data that are necessary for the terminal device. When the terminal device runs, the transceiver and the processor execute the computer-executable instructions stored in the memory, to enable the terminal device to perform the communication method according to any one of the seventh aspect or the possible designs of the seventh aspect.

For a specific implementation of the terminal device in the eighth aspect and the ninth aspect, refer to behavior functions of the terminal device in the communication method according to any one of the seventh aspect or the possible designs of the seventh aspect.

According to a tenth aspect, an embodiment of this application provides a communication method. The method includes: A network device determines first DCI. The first DCI includes values of a plurality of DCI parameters, and the DCI parameter included in the first DCI corresponds to a terminal type of a terminal device. A candidate set of the value of the DCI parameter corresponds to the terminal type, and the candidate set includes at least one value of the DCI parameter corresponding to the terminal type. The network device sends the first DCI to the terminal device.

Based on the tenth aspect, DCI corresponding to the terminal device is determined for the terminal device in a customized manner based on the terminal type. This can reduce signaling overheads of the DCI, improve spectral efficiency of a communication system, and reduce power consumption of the terminal device.

In a possible design, that the network device sends the first DCI to the terminal device includes: The network device sends a first DCI format to the terminal device, so that the terminal device receives the first DCI from the network device based on the first DCI format. The first DCI format corresponds to the terminal type.

Based on the possible design, a DCI format corresponding to the terminal device is determined for the terminal device in the customized manner based on the terminal type, so that the terminal device can receive the DCI from the network device based on the DCI format corresponding to the terminal device. This improves communication reliability.

In a possible design, before the network device sends the first DCI to the terminal device, the method further includes: The network device sends indication information to the terminal device. The indication information indicates the DCI parameter corresponding to the terminal type and the candidate set of the value of the DCI parameter.

Based on the possible design, the terminal device can determine, based on the indication information sent by the network device, the DCI parameter corresponding to the terminal type and the candidate set of the value of the DCI parameter, and then parse the received first DCI.

In a possible design, before the network device sends the indication information to the terminal device, the method further includes: The network device receives second request information from the terminal device. The second request information is used to request the DCI parameter corresponding to the terminal type and the candidate set of the value of the DCI parameter.

In a possible design, the network device receives second feature information from the terminal device. The second feature information indicates the terminal type.

Based on the foregoing two possible designs, the terminal device can send the second request information or the second feature information to the network device, so that the network device determines, for the terminal device based on the second request information or the second feature information, the DCI parameter corresponding to the terminal type of the terminal device and the candidate set of the value of the DCI parameter.

In a possible design, when the terminal type is an enhanced mobile broadband eMBB device, a DCI parameter corresponding to the eMBB includes time domain resource assignment, frequency domain resource assignment, a bandwidth part BWP indicator, a modulation and coding scheme MCS, a new data indicator, a redundancy version, a hybrid automatic repeat request HARQ process number, HARQ timing, a transmit power control TPC command, an antenna port, precoding and a number of layers, a sounding reference signal SRS request, and a channel state information CSI request; and/or when the terminal type is an ultra-reliable low-latency communication URLLC device, a DCI parameter corresponding to the URLLC includes a time domain resource indicator, a frequency domain resource indicator, a modulation and coding scheme MCS, a new data indicator, a hybrid automatic repeat request HARQ process number, a transmit power control command, a sounding reference signal SRS request, and a channel state information CSI request; and/or when the terminal type is an Internet of Things IoT device, a DCI parameter corresponding to the IoT includes a frequency domain resource indicator, a modulation and coding scheme MCS, and a hybrid automatic repeat request HARQ process number; and/or when the terminal type is customer premises equipment CPE, a DCI parameter corresponding to the CPE includes time domain resource assignment, frequency domain resource assignment, a bandwidth part BWP indicator, a modulation and coding scheme MCS, a new data indicator, a redundancy version, a hybrid automatic repeat request HARQ process number, HARQ timing, a transmit power control TPC command, an antenna port, precoding and a number of layers, a sounding reference signal SRS request, and a channel state information CSI request.

Based on the possible design, the DCI parameter corresponding to the terminal type can be determined based on the terminal type, to implement customization of the DCI of the terminal type. This can meet a communication requirement of the terminal device and reduce the signaling overheads.

In a possible design, when the terminal type is the enhanced mobile broadband eMBB device, a quantity of bits corresponding to a candidate set of a value of the MCS parameter is 5, and a quantity of bits corresponding to a candidate set of a value of the HARQ process number parameter is 4; and/or when the terminal type is the ultra-reliable low-latency communication URLLC device, a quantity of bits corresponding to a candidate set of a value of the MCS parameter is 2 or 3, a quantity of bits corresponding to a candidate set of a value of the HARQ process number parameter is 1, a quantity of bits corresponding to a candidate set of a value of the sounding reference signal SRS request parameter is 1, and a quantity of bits corresponding to a candidate set of a value of the channel state information CSI request parameter is 1; and/or when the terminal type is the Internet of Things IoT device, a quantity of bits corresponding to a candidate set of a value of the MCS parameter is 2 or 3, and a quantity of bits corresponding to a candidate set of a value of the HARQ process number parameter is 1 or 2; and/or when the terminal type is the customer premises equipment CPE, a quantity of bits corresponding to a candidate set of a value of the MCS parameter is 2, 3, 4, or 5, and a quantity of bits corresponding to a candidate set of a value of the HARQ process number parameter is 4.

Based on the possible design, the candidate set of the value of the DCI parameter corresponding to the terminal type can be determined based on the terminal type, to implement customization of the candidate set of the value of the DCI parameter of the terminal type. This can meet the communication requirement of the terminal device and reduce the signaling overheads.

In a possible design, when the terminal type is an enhanced mobile broadband eMBB device, a DCI format corresponding to the eMBB is a format 1, and a DCI parameter corresponding to the format 1 and a candidate set of a value of the DCI parameter are as follows: A quantity of bits corresponding to a candidate set of a value of a modulation and coding scheme MCS parameter is 5, and a quantity of bits corresponding to a candidate set of a value of a hybrid automatic repeat request HARQ process number parameter is 4; and/or when the terminal type is an ultra-reliable low-latency communication URLLC device, a DCI format corresponding to the URLLC is a format 2, and a DCI parameter corresponding to the format 2 and a candidate set of a value of the DCI parameter are as follows: A quantity of bits corresponding to a candidate set of a value of a modulation and coding scheme MCS parameter is 2 or 3, a quantity of bits corresponding to a candidate set of a value of a hybrid automatic repeat request HARQ process number parameter is 1, a quantity of bits corresponding to a candidate set of a value of a sounding reference signal SRS request parameter is 1, and a quantity of bits corresponding to a candidate set of a value of a channel state information CSI request parameter is 1; and/or when the terminal type is an Internet of Things IoT device, a DCI format corresponding to the IoT is a format 3, and a DCI parameter corresponding to the format 3 and a candidate set of a value of the DCI parameter are as follows: A quantity of bits corresponding to a candidate set of a value of a modulation and coding scheme MCS parameter is 2 or 3, and a quantity of bits corresponding to a candidate set of a value of a hybrid automatic repeat request HARQ process number parameter is 1 or 2; and/or when the terminal type is customer premises equipment CPE, a DCI format corresponding to the IoT is a format 4, and a DCI parameter corresponding to the format 4 and a candidate set of a value of the DCI parameter are as follows: A quantity of bits corresponding to a candidate set of a value of a modulation and coding scheme MCS parameter is 2, 3, 4, or 5, and a quantity of bits corresponding to a candidate set of a value of a hybrid automatic repeat request HARQ process number parameter is 4.

Based on the possible design, the DCI format corresponding to the terminal type can be determined based on the terminal type, to implement customization of the DCI format corresponding to the terminal type. This helps the terminal device receive the DCI based on the DCI format corresponding to the terminal device, meets the communication requirement of the terminal device, and reduces the signaling overheads.

In a possible design, the terminal type is determined based on one or more of the following factors: a service type, mobility, a transmission latency requirement, a channel environment, a reliability requirement, a coverage requirement, and a communication scenario.

Based on the possible design, the network device and/or the terminal device can determine the terminal type based on the foregoing factor, to determine, for the terminal type, DCI that meets the communication requirement. This reduces the signaling overheads.

According to an eleventh aspect, an embodiment of this application provides a network device. The network device may implement functions performed by the network device in the tenth aspect or the possible designs of the tenth aspect, and the functions may be implemented by hardware executing corresponding software. The hardware or the software includes one or more modules corresponding to the functions, for example, a processing module and a transceiver module. The processing module is configured to determine first DCI. The first DCI includes values of a plurality of DCI parameters, and the DCI parameter included in the first DCI corresponds to a terminal type of a terminal device. A candidate set of the value of the DCI parameter corresponds to the terminal type, and the candidate set includes at least one value of the DCI parameter corresponding to the terminal type. The transceiver module is configured to send the first DCI to the terminal device.

In a possible design, the transceiver module is further configured to send, by the network device, a first DCI format to the terminal device, so that the terminal device receives the first DCI from the network device based on the first DCI format. The first DCI format corresponds to the terminal type.

In a possible design, before sending the first DCI to the terminal device, the transceiver module is further configured to send indication information to the terminal device. The indication information indicates the DCI parameter corresponding to the terminal type and the candidate set of the value of the DCI parameter.

In a possible design, before sending the indication information to the terminal device, the transceiver module is further configured to receive second request information from the terminal device. The second request information is used to request the DCI parameter corresponding to the terminal type and the candidate set of the value of the DCI parameter.

In a possible design, the transceiver module is further configured to receive second feature information from the terminal device. The second feature information indicates the terminal type.

In a possible design, when the terminal type is an enhanced mobile broadband eMBB device, a DCI parameter corresponding to the eMBB includes time domain resource assignment, frequency domain resource assignment, a bandwidth part BWP indicator, a modulation and coding scheme MCS, a new data indicator, a redundancy version, a hybrid automatic repeat request HARQ process number, HARQ timing, a transmit power control TPC command, an antenna port, precoding and a number of layers, a sounding reference signal SRS request, and a channel state information CSI request; and/or when the terminal type is an ultra-reliable low-latency communication URLLC device, a DCI parameter corresponding to the URLLC includes a time domain resource indicator, a frequency domain resource indicator, a modulation and coding scheme MCS, a new data indicator, a hybrid automatic repeat request HARQ process number, a transmit power control command, a sounding reference signal SRS request, and a channel state information CSI request; and/or when the terminal type is an Internet of Things IoT device, a DCI parameter corresponding to the IoT includes a frequency domain resource indicator, a modulation and coding scheme MCS, and a hybrid automatic repeat request HARQ process number; and/or when the terminal type is customer premises equipment CPE, a DCI parameter corresponding to the CPE includes time domain resource assignment, frequency domain resource assignment, a bandwidth part BWP indicator, a modulation and coding scheme MCS, a new data indicator, a redundancy version, a hybrid automatic repeat request HARQ process number, HARQ timing, a transmit power control TPC command, an antenna port, precoding and a number of layers, a sounding reference signal SRS request, and a channel state information CSI request.

In a possible design, when the terminal type is the enhanced mobile broadband eMBB device, a quantity of bits corresponding to a candidate set of a value of the MCS parameter is 5, and a quantity of bits corresponding to a candidate set of a value of the HARQ process number parameter is 4; and/or when the terminal type is the ultra-reliable low-latency communication URLLC device, a quantity of bits corresponding to a candidate set of a value of the MCS parameter is 2 or 3, a quantity of bits corresponding to a candidate set of a value of the HARQ process number parameter is 1, a quantity of bits corresponding to a candidate set of a value of the sounding reference signal SRS request parameter is 1, and a quantity of bits corresponding to a candidate set of a value of the channel state information CSI request parameter is 1; and/or when the terminal type is the Internet of Things IoT device, a quantity of bits corresponding to a candidate set of a value of the MCS parameter is 2 or 3, and a quantity of bits corresponding to a candidate set of a value of the HARQ process number parameter is 1 or 2; and/or when the terminal type is the customer premises equipment CPE, a quantity of bits corresponding to a candidate set of a value of the MCS parameter is 2, 3, 4, or 5, and a quantity of bits corresponding to a candidate set of a value of the HARQ process number parameter is 4.

In a possible design, when the terminal type is an enhanced mobile broadband eMBB device, a DCI format corresponding to the eMBB is a format 1, and a DCI parameter corresponding to the format 1 and a candidate set of a value of the DCI parameter are as follows: A quantity of bits corresponding to a candidate set of a value of a modulation and coding scheme MCS parameter is 5, and a quantity of bits corresponding to a candidate set of a value of a hybrid automatic repeat request HARQ process number parameter is 4; and/or when the terminal type is an ultra-reliable low-latency communication URLLC device, a DCI format corresponding to the URLLC is a format 2, and a DCI parameter corresponding to the format 2 and a candidate set of a value of the DCI parameter are as follows: A quantity of bits corresponding to a candidate set of a value of a modulation and coding scheme MCS parameter is 2 or 3, a quantity of bits corresponding to a candidate set of a value of a hybrid automatic repeat request HARQ process number parameter is 1, a quantity of bits corresponding to a candidate set of a value of a sounding reference signal SRS request parameter is 1, and a quantity of bits corresponding to a candidate set of a value of a channel state information CSI request parameter is 1; and/or when the terminal type is an Internet of Things IoT device, a DCI format corresponding to the IoT is a format 3, and a DCI parameter corresponding to the format 3 and a candidate set of a value of the DCI parameter are as follows: A quantity of bits corresponding to a candidate set of a value of a modulation and coding scheme MCS parameter is 2 or 3, and a quantity of bits corresponding to a candidate set of a value of a hybrid automatic repeat request HARQ process number parameter is 1 or 2; and/or when the terminal type is customer premises equipment CPE, a DCI format corresponding to the IoT is a format 4, and a DCI parameter corresponding to the format 4 and a candidate set of a value of the DCI parameter are as follows: A quantity of bits corresponding to a candidate set of a value of a modulation and coding scheme MCS parameter is 2, 3, 4, or 5, and a quantity of bits corresponding to a candidate set of a value of a hybrid automatic repeat request HARQ process number parameter is 4.

In a possible design, the terminal type is determined based on one or more of the following factors: a service type, mobility, a transmission latency requirement, a channel environment, a reliability requirement, a coverage requirement, and a communication scenario.

According to a twelfth aspect, an embodiment of this application provides a network device. The network device may be a network device or a chip or a system on a chip in a network device. The network device may implement functions performed by the network device in the foregoing aspects or the possible designs, and the functions may be implemented by hardware. In a possible design, the network device may include a transceiver and a processor. The transceiver and the processor may be configured to support the network device in implementing functions in any one of the tenth aspect or the possible designs of the tenth aspect. For example, the processor is configured to determine first DCI. The first DCI includes values of a plurality of DCI parameters, and the DCI parameter included in the first DCI corresponds to a terminal type of a terminal device. A candidate set of the value of the DCI parameter corresponds to the terminal type, and the candidate set includes at least one value of the DCI parameter corresponding to the terminal type. The transceiver is configured to send the first DCI to the terminal device. In another possible design, the network device may further include a memory. The memory is configured to store computer-executable instructions and data that are necessary for the network device. When the network device runs, the transceiver and the processor execute the computer-executable instructions stored in the memory, to enable the network device to perform the communication method according to any one of the tenth aspect or the possible designs of the tenth aspect.

For a specific implementation of the network device in the eleventh aspect and the twelfth aspect, refer to behavior functions of the network device in the communication method according to any one of the tenth aspect or the possible designs of the tenth aspect.

According to a thirteenth aspect, a communication apparatus is provided. The communication apparatus includes one or more processors and one or more memories. The one or more memories are coupled to the one or more processors, and the one or more memories are configured to store computer program code or computer instructions. When the one or more processors execute the computer instructions, the communication apparatus is enabled to perform the communication method according to any one of the first aspect or the possible designs of the first aspect, or perform the communication method according to any one of the fourth aspect or the possible designs of the fourth aspect, or perform the communication method according to any one of the seventh aspect or the possible designs of the seventh aspect, or perform the communication method according to any one of the tenth aspect or the possible designs of the tenth aspect.

According to a fourteenth aspect, a computer-readable storage medium is provided. The computer-readable storage medium stores computer instructions or a program. When the computer instructions or the program is run on a computer, the computer is enabled to perform the communication method according to any one of the first aspect or the possible designs of the first aspect, or perform the communication method according to any one of the fourth aspect or the possible designs of the fourth aspect, or perform the communication method according to any one of the seventh aspect or the possible designs of the seventh aspect, or perform the communication method according to any one of the tenth aspect or the possible designs of the tenth aspect.

According to a fifteenth aspect, a computer program product including instructions is provided. When the computer program product runs on a computer, the computer is enabled to perform the communication method according to any one of the first aspect or the possible designs of the first aspect, or perform the communication method according to any one of the fourth aspect or the possible designs of the fourth aspect, or perform the communication method according to any one of the seventh aspect or the possible designs of the seventh aspect, or perform the communication method according to any one of the tenth aspect or the possible designs of the tenth aspect.

According to a sixteenth aspect, a communication apparatus is provided. The communication apparatus includes a processor and a communication interface. The processor is configured to read instructions. When being a chip, the communication apparatus may perform the communication method according to any one of the first aspect or the possible designs of the first aspect, or perform the communication method according to any one of the fourth aspect or the possible designs of the fourth aspect, or perform the communication method according to any one of the seventh aspect or the possible designs of the seventh aspect, or perform the communication method according to any one of the tenth aspect or the possible designs of the tenth aspect. When being a terminal device, the communication apparatus may perform the communication method according to any one of the first aspect or the possible designs of the first aspect, or perform the communication method according to any one of the seventh aspect or the possible designs of the seventh aspect. When being a network device, the communication apparatus may perform the communication method according to any one of the fourth aspect or the possible designs of the fourth aspect, or perform the communication method according to any one of the tenth aspect or the possible designs of the tenth aspect.

For a technical effect brought by any design manner in the thirteenth aspect to the sixteen aspect, refer to the technical effect brought by any possible design of the first aspect, or refer to the technical effect brought by any possible design of the fourth aspect, or refer to the technical effect brought by any possible design of the seventh aspect, or refer to the technical effect brought by any possible design of the tenth aspect. Details are not described again.

According to a seventeenth aspect, a communication system is provided. The communication system includes the terminal device in any one of the second aspect and the third aspect and the network device in any one of the fifth aspect and the sixth aspect, or the terminal device in any one of the eighth aspect and the ninth aspect and the network device in any one of the eleventh aspect and the twelfth aspect.

### BRIEF DESCRIPTION OF THE DRAWINGS

FIG. 1a is a schematic composition diagram of a communication system according to an embodiment of this application;

FIG. 1b is a schematic diagram of a protocol stack between a terminal device and a network device according to an embodiment of this application;

FIG. 1c is a schematic composition diagram of a communication system according to an embodiment of this application;

FIG. 2 is a schematic composition diagram of a communication apparatus according to an embodiment of this application;

FIG. 3a is a flowchart of a communication method according to an embodiment of this application;

FIG. 3b is a flowchart of a communication method according to an embodiment of this application;

FIG. 3c is a flowchart of a communication method according to an embodiment of this application;

FIG. 4 is a schematic diagram of a terminal type according to an embodiment of this application;

FIG. 5a is a flowchart of a communication method according to an embodiment of this application;

FIG. 5b is a flowchart of a communication method according to an embodiment of this application;

FIG. 5c is a flowchart of a communication method according to an embodiment of this application;

FIG. 6 is a schematic diagram of a DCI parameter according to an embodiment of this application;

FIG. 7 is a schematic diagram of a symbol according to an embodiment of this application;

FIG. 8 is a schematic composition diagram of a terminal device according to an embodiment of this application; and

FIG. 9 is a schematic composition diagram of a network device according to an embodiment of this application.

### DETAILED DESCRIPTION OF ILLUSTRATIVE EMBODIMENTS

Before embodiments of this application are described, technical terms in embodiments of this application are described.

In an existing new radio (NR) communication system, a network device may configure a plurality of RRC parameters for a terminal device by using radio resource control (RRC) signaling, so that the terminal device performs communication based on the plurality of RRC parameters. However, values of the plurality of RRC parameters carried in the RRC signaling are pre-specified in a communication protocol, there are a large quantity of RRC parameters, and a same RRC parameter has a large quantity of values. Therefore, when configuring the plurality of RRC parameters for the terminal device, the network device needs to indicate one value for each RRC parameter from a full value set of the RRC parameter and send the value to the terminal device, resulting in high RRC signaling overheads, high storage overheads of the terminal device, and high power consumption of the terminal device.

In addition, when sending the RRC parameter to the terminal device, the network device may schedule the RRC signaling to send the plurality of RRC parameters to the terminal device through scheduling at a physical layer, for example, by controlling receiving and sending of downlink control information (DCI) and receiving and sending of a data channel. However, when the network device sends the DCI to the terminal device to schedule the RRC signaling, because a format of the DCI is a fixed format pre-specified in the communication protocol, signaling overheads of the DCI are high, resulting in low spectral efficiency of the communication system and high power consumption of the terminal device.

To resolve the foregoing technical problem that, when configuring the plurality of RRC parameters for the terminal device, the network device needs to indicate the value for each RRC parameter from the full value set of the RRC parameter and send the value to the terminal device, resulting in the high RRC signaling overheads, the high storage overheads of the terminal device, and high power consumption of the terminal device, an embodiment of this application provides a communication method. The method includes: The terminal device determines a first value candidate set. The first value candidate set corresponds to a terminal type of the terminal device, and the first value candidate set includes a value candidate set of an RRC parameter corresponding to the terminal type. The terminal device receives a first value from the network device. The first value includes a group of RRC parameter values in the first value candidate set. The terminal device performs communication based on the first value. In this embodiment of this application, the first value candidate set corresponding to the terminal type is determined based on the terminal type, so that the network device can determine the first value for the terminal device from the first value candidate set. Compared with that the network device needs to indicate first value for each RRC parameter from the full value set of the RRC parameter and send the first value to the terminal device, this reduces RRC signaling overheads, storage overheads of the terminal device, and power consumption of the terminal device.

To resolve the foregoing technical problem that, when the network device sends the DCI to the terminal device to schedule the RRC signaling or a data signal, because the format of the DCI is the fixed format pre-specified in the communication protocol, the signaling overheads of the DCI are high, resulting in the low spectral efficiency of the communication system and high power consumption of the terminal device, an embodiment of this application provides a communication method. The method includes: The terminal device receives first DCI from the network device. The first DCI includes values of a plurality of DCI parameters, and the DCI parameter included in the first DCI corresponds to a terminal type of the terminal device. A candidate set of the value of the DCI parameter corresponds to the terminal type, and the candidate set includes at least one value of the DCI parameter corresponding to the terminal type. The terminal device performs communication based on the first DCI. In this embodiment of this application, DCI corresponding to the terminal device is determined for the terminal device based on the terminal type. This can reduce the signaling overheads of the DCI, improve the spectral efficiency of the communication system, and reduce power consumption of the terminal device.

The following describes implementations of embodiments of this application in detail with reference to the accompanying drawings in this specification.

The communication method provided in embodiments of this application may be applied to any communication system. The communication system may be a 3rd generation partnership project (3GPP) communication system, for example, a long term evolution (LTE) system, or may be a 5th generation (5G) mobile communication system, a new radio (NR) system, or an NR V2X system. The communication method may be alternatively applied to an LTE and 5G hybrid networking system, a device-to-device (D2D) communication system, a machine to machine (M2M) communication system, an Internet of Things (IoT), a frequency division duplex (FDD) system, a time division duplex (TDD) system, a satellite communication system, or another next-generation communication system. The communication system may be alternatively a non-3GPP communication system. This is not limited.

The communication method provided in embodiments of this application may be applied to various communication scenarios, for example, may be applied to one or more of the following communication scenarios: enhanced mobile broadband (eMBB), ultra-reliable low-latency communication (URLLC), machine type communication (MTC), the Internet of Things (IoT), a narrowband Internet of Things (NB-IoT), customer premises device (CPE), augmented reality (AR), virtual reality (VR), massive machine type communications (mMTC), device-to-device (D2D), vehicle-to-everything (V2X), and vehicle-to-vehicle (V2V).

It should be noted that, in embodiments of this application, the IoT (IoT) may include one or more of the NB-IoT, the MTC, the mMTC, and the like. This is not limited.

Embodiments of this application are applicable to both a homogeneous network scenario and a heterogeneous network scenario, and no limitation is imposed on a transmission point. Coordinated multipoint transmission may be performed between macro base stations, between micro base stations, or between a macro base station and a micro base station. Embodiments of this application are applicable to a frequency division multiplexing system, a time division multiplexing system, a duplex system, an access and backhaul system, a relay system, and the like. Embodiments of this application are applicable to a low-frequency scenario (sub 6G), and are also applicable to a high-frequency scenario (above 6G), terahertz, optical communication, and the like.

The eMBB may refer to a heavy-traffic mobile broadband service, for example, a three-dimensional (3D)/ultra-high-definition video. Specifically, the eMBB may further improve performance such as a network speed and user experience based on a mobile broadband service. For example, when a user watches a 4K high-definition video, a peak network speed may reach 10 Gbps.

The URLLC may refer to a service with high reliability, low latency, and very high availability. Specifically, the URLLC may include the following communication scenarios and applications: industrial application and control, traffic safety and control, remote manufacturing, remote training, remote surgery, self-driving, industrial automation, security protection, and the like.

The MTC may refer to a low-cost and coverage-enhanced service, and may also be referred to as M2M. The mMTC refers to a large-scale Internet of Things service.

The NB-IoT may be a service that has features such as wide coverage, a large quantity of connections, a low rate, low costs, low power consumption, and an excellent architecture. Specifically, the NB-IoT may include a smart water meter, smart parking, smart pet tracking, a smart bicycle, a smart smoke detector, a smart toilet, a smart vending machine, and the like.

The CPE may refer to a mobile signal access device that receives a mobile signal and forwards the mobile signal by using a Wi-Fi signal, or may refer to a device that converts a highspeed 4G or 5G signal into a Wi-Fi signal, and may support a large quantity of mobile terminals that can access the Internet at the same time. The CPE may be widely applied to wireless network access in a rural area, a town, a hospital, an organization, a factory, a residential community, or the like, and can reduce costs for deploying a wired network.

The V2X may enable communication between vehicles, between a vehicle and a network device, or between network devices to obtain a variety of traffic information such as a real-time road condition, road information, and pedestrian information, provide vehicle-mounted entertainment information, improve driving safety, reduce congestion, and improve traffic efficiency.

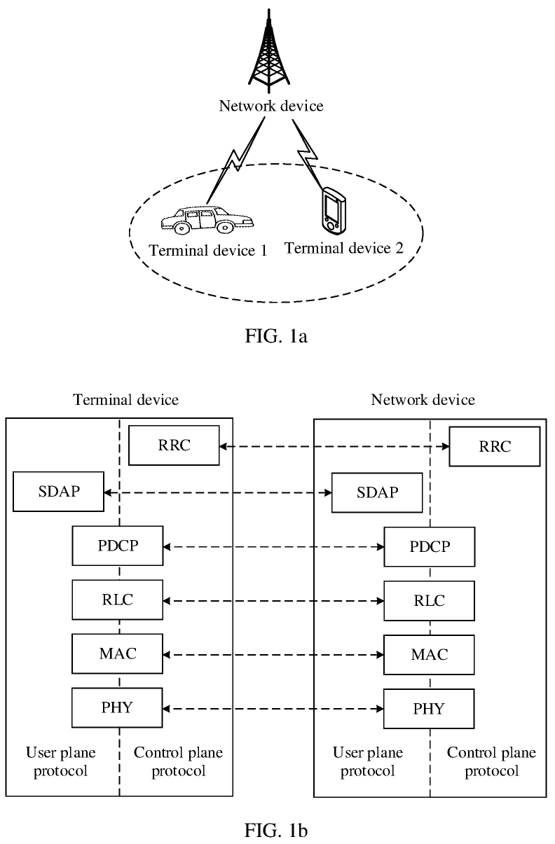

The following uses FIG. 1a as an example to describe the communication method provided in embodiments of this application.

FIG. 1a is a schematic diagram of a communication system according to an embodiment of this application. As shown in FIG. 1a, the communication system may include a terminal device and a network device.

The terminal device in FIG. 1a may be located in a cell coverage area of the network device. The terminal device may perform air-interface communication with the network device through an uplink (UL) or a downlink (DL). In a UL direction, the terminal device may send data to the network device through a physical uplink shared channel (PUSCH). In a DL direction, the network device may send, to the terminal device, a PDCCH carrying DCI, or may send data to the terminal through a physical downlink shared channel (PDSCH).

The physical uplink shared channel may also be referred to as the physical uplink shared channel for short. The physical downlink shared channel may also be referred to as the physical downlink shared channel for short.

Specifically, a schematic diagram of a network architecture is shown in FIG. 1b. The terminal device may include a physical layer (PHY), a media access control (MAC) layer, a radio link control (RLC) layer, a packet data convergence protocol (PDCP) layer, a service data adaptation protocol (SDAP) layer, and a radio resource control (RRC) layer. The terminal device may include a user plane protocol and a control plane protocol.

For example, the terminal device in FIG. 1a may be referred to as a terminal, user equipment (UE), a mobile station (MS), or a mobile terminal (MT), and may be a device that provides voice and/or data connectivity for a user. Specifically, the terminal device in FIG. 1a may be a mobile phone, an uncrewed aerial vehicle, a tablet computer, a computer with a wireless transceiver function, a handheld device with a wireless connection function, a vehicle-mounted device, or the like. The terminal device may be alternatively a palmtop computer, a mobile Internet device (MID), a wearable device, an eMBB terminal, a URLLC terminal, an MTC terminal, an NB-IoT terminal, a CPE terminal, a VR terminal, an AR terminal, a V2X terminal, a wireless terminal in industrial control, a wireless terminal in self-driving, a wireless terminal in telemedicine, a wireless terminal in a smart grid, a wireless terminal in transportation safety, a wireless terminal in a smart city, a wireless terminal in a smart home, a sensor, a cellular phone, a cordless phone, a session initiation protocol (SIP) phone, a wireless local loop (WLL) station, a personal digital assistant (PDA), a computing device, another processing device connected to a wireless modem, a vehicle-mounted terminal, a vehicle with a vehicle-to-vehicle (V2V) communication capability, an uncrewed aerial vehicle with an unmanned aerial vehicle (UAV)-to-unmanned aerial vehicle communication capability, a terminal device in a 5G network, a terminal device in a future evolved public land mobile network (PLMN), or the like. This is not limited.

The wearable device may also be referred to as a wearable intelligent device, and is a general term of wearable devices, such as glasses, gloves, watches, clothes, and shoes, that are developed by applying wearable technologies to intelligent designs of daily wear. The wearable device is a portable device that is directly worn on a body or integrated into clothes or an accessory of a user. The wearable device is not only a hardware device, but also implements a powerful function through software support, data exchange, and cloud interaction. Generalized wearable intelligent devices include full-featured and large-size devices that can implement complete or partial functions without depending on smartphones, such as smart watches or smart glasses, and devices that focus on only one type of application function and need to work with other devices such as smartphones, such as various smart bands or smart jewelry for monitoring physical signs.

In addition, the terminal device may be alternatively a terminal device in an Internet of Things (IoT) system. An IoT is an important part in future development of information technologies. A main technical feature of the IoT is to connect things to a network by using a communication technology, to implement an intelligent network for human-machine interconnection and thing-thing interconnection. An IoT technology can implement massive connections, deep coverage, and power saving for a terminal by using, for example, a narrowband (NB) technology.

In addition, the terminal device may further include sensors such as an intelligent printer, a train detector, and a gas station, and main functions of the terminal device include collecting data, receiving control information and downlink data of the network device, sending an electromagnetic wave, and transmitting uplink data to the network device.

The network device in FIG. 1a may be any device that has a wireless transceiver function, and may be configured to be responsible for functions related to an air interface, for example, a radio link maintenance function, a radio resource management function, and a part of mobility management functions. The radio link maintenance function is used to maintain a radio link between the network device and the terminal device, and is responsible for protocol conversion between radio link data and Internet Protocol (IP) data. The radio resource management function may include functions such as radio link establishment and release and radio resource scheduling and allocation. The part of mobility management functions may include configuring the terminal device to perform measurement, evaluating radio link quality of the terminal device, and determining a handover of the terminal device between cells.

Specifically, a schematic diagram of a protocol stack between the terminal device and the network device may be shown in FIG. 1b. A protocol stack of the network device may include a PHY layer, a MAC layer, an RLC layer, a PDCP layer, an SDAP layer, and an RRC layer. The protocol stack of the network device also includes a user plane protocol and a control plane protocol. Layers of the terminal device and the network device may be connected to each other for information transmission.

For example, the network device may be a device supporting wired access, or may be a device supporting wireless access. For example, the network device may be an access network (AN)/radio access network (RAN) device, and include a plurality of AN/ RAN nodes. The AN/ RAN node may be an access point (AP), a base station (nodeB, NB), an enhanced base station (enhanced nodeB, eNB), a next-generation base station (NR nodeB, gNB), a transmission reception point (TRP), a transmission point (TP), another access node, or the like.

Currently, examples of some RAN nodes may be a continuously evolved NodeB (gNB), the transmission reception point (TRP), an evolved NodeB (eNB), a radio network controller (RNC), a home base station (for example, a home evolved NodeB or a home NodeB, HNB), a Wi-Fi access point (AP), a wireless relay node, a wireless backhaul node, the transmission point (TP), a transmission and reception point (TRP), or the like, or may be an ngNB or a transmission point (TRP or TP) in a 5G system, for example, an NR system, or an antenna panel or a group of antenna panels of a base station in a 5G system, or may be a network node that constitutes a gNB or a transmission point, for example, a baseband unit (BBU) or a distributed unit (DU), a device that bears a base station function in D2D, V2X, or machine-to-machine (M2M) communication, a base station in a future communication system, or the like.

In some deployments, the gNB may include a centralized unit (CU) and a DU, and the gNB may further include an active antenna unit (AAU). The CU may implement some functions of the gNB, and the DU may implement some functions of the gNB. For example, the CU is responsible for processing a non-real-time protocol and service, and implements functions of a radio resource control RRC layer and a packet data convergence layer protocol (PDCP) layer. The DU is responsible for processing a physical layer protocol and a real-time service, to implement functions of a radio link control (RLC) layer, a media access control (MAC) layer, and a physical (PHY) layer. The AAU implements some physical layer processing functions, radio frequency processing, and a function related to an active antenna. Information at the RRC layer eventually becomes information at the PHY layer, or is changed from information at the PHY layer. Therefore, in this architecture, higher-layer signaling such as RRC layer signaling may also be considered as being sent by the DU or sent by the DU and the AAU. It may be understood that the network device may be a device including one or more of a CU node, a DU node, and an AAU node. In addition, the CU may be classified into a network device in an access network (RAN), or the CU may be classified into a network device in a core network (CN). This is not limited in this application.

The network device may serve a cell, and the terminal device communicates with the cell by using a transmission resource (for example, a frequency domain resource or a spectrum resource) allocated by the network device. The cell may belong to a macro base station (for example, a macro eNB or a macro gNB), or may belong to a base station corresponding to a small cell. The small cell herein may include a metro cell, a micro cell, a pico cell, a femto cell, and the like. These small cells have features of small coverage and low transmit power, and are applicable to providing a high-rate data transmission service.

In embodiments of this application, a measurement unit of communication time domain may be referred to as a time unit or a time scheduling unit. The time scheduling unit or the time unit may be a radio frame, a subframe, a slot, a mini-slot, a sub-slot, or the like. The time scheduling unit or the time unit may be alternatively one or more symbols or the like, and the symbol is a basic unit in time domain.

In embodiments of this application, a measurement unit of communication frequency domain may be referred to as a frequency domain resource element or a frequency domain scheduling unit. The frequency domain resource element may be a basic resource element (RE), a resource block, a resource block group, or the like. One resource block may include one or more resource elements. One resource block group may include one or more resource blocks. For example, a frequency domain resource element used for data transmission may include several basic resource elements, one RE may correspond to one subcarrier, and one physical resource block (PRB) includes X1 basic resource elements, where X1 is an integer greater than or equal to 1. For example, X1 is 12.

It should be noted that the terminal device and the network device in this embodiment of this application each may be one or more chips, or may be a system on a chip (SOC) or the like. FIG. 1a is merely an example diagram, and a quantity of devices included in FIG. 1a is not limited. Names of the devices and the links in FIG. 1a are not limited. In addition to the names shown in FIG. 1a, the devices and the links may have other names. For example, the terminal device communicates with the network device through a user equipment (Uu) interface, and the UL may be named as a Uu link or the like. This is not limited.

In addition, in addition to the devices shown in FIG. 1a, as shown in FIG. 1c, the communication system may further include a core network and an external network.

For example, a mobile network may be divided into three parts: a base station subsystem, a network subsystem, and a system support part. The network device may be located in the base station subsystem, and the core network may be located in the network subsystem.

Specifically, the core network may be configured to transmit a call request or a data request from the air interface to different external networks. The core network may be used as an interface provided by a bearer network for the external network, and may provide functions such as a user connection, user management, and a bearer connection.

For example, establishment of the user connection may include functions such as mobility management (MM), call management (CM), switching/routing, and recording notification. The user management may include functions such as user description, quality of service (QoS), user communication accounting, a virtual home environment (VHE) (for example, the virtual home environment is provided through a conversation with an intelligent network platform), and security (for example, a corresponding security measure provided by an authentication center, including security management for a mobile service and security processing for external network access). The bearer connection (access to) includes functions such as access to an external public switched telephone network (PSTN), an external circuit data network and a packet data network, the Internet, an intranet, a short message service (SMS) server of a mobile network. A basic service provided by the core network may include mobile office, electronic commerce, communication, an entertainment service, a travel, a location-based service, a telemetry service, a simple message transfer service (monitoring control), and the like.

The external network may be an operator network that provides a data transmission service for the user, for example, may be an operator network that provides an IP multimedia service (IMS) for the user. An application server may be deployed in a DN, and the application server may provide a data transmission service for the user. Specifically, the operator may include a public land mobile network (PLMN). The PLMN is a network established and operated by a government or an operator, approved by a government, for providing a land mobile communication service for the public, for example, may be a Mobile operator, a Unicom operator, or a Telecom operator.

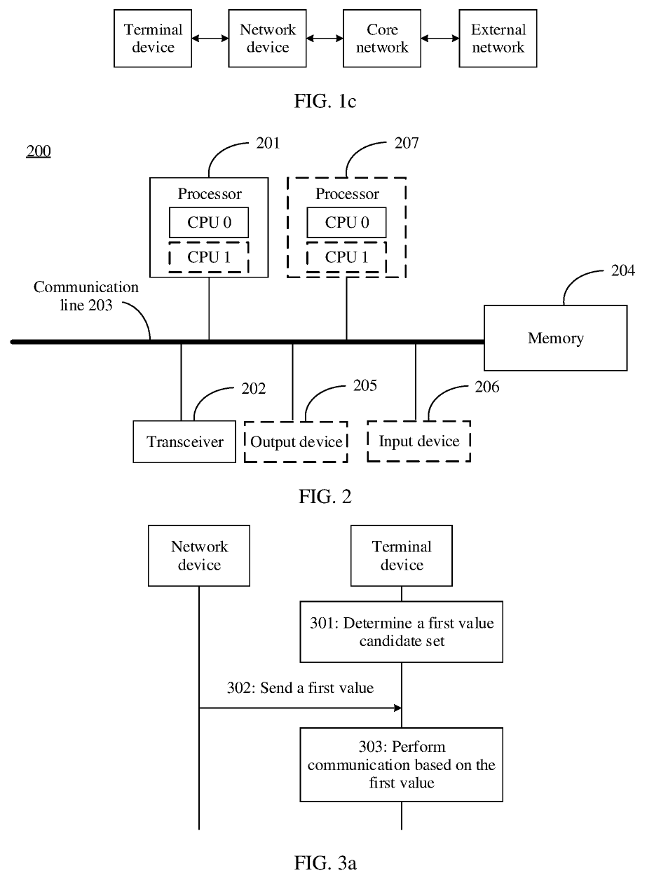

During specific implementation, as shown in FIG. 1a, the terminal device and the network device each may use a composition structure shown in FIG. 2, or include parts shown in FIG. 2. FIG. 2 is a schematic composition diagram of a communication apparatus 200 according to an embodiment of this application. The communication apparatus 200 may be a terminal device, or a chip or a system on a chip in a terminal device, or may be a network device, or a chip or a system on a chip in a network device. As shown in FIG. 2, the communication apparatus 200 includes a processor 201, a transceiver 202, and a communication line 203.

Further, the communication apparatus 200 may further include a memory 204. The processor 201, the memory 204, and the transceiver 202 may be connected to each other through the communication line 203.

The processor 201 is a central processing unit (CPU), a general-purpose processor, a network processor (NP), a digital signal processor (DSP), a microprocessor, a microcontroller, a programmable logic device (PLD), or any combination thereof. The processor 201 may be alternatively another apparatus having a processing function, for example, a circuit, a component, or a software module. This is not limited.

The transceiver 202 is configured to communicate with another device or another communication network. The another communication network may be an Ethernet, a radio access network (RAN), a wireless local area network (WLAN), or the like. The transceiver 202 may be a module, a circuit, a transceiver, or any apparatus that can implement communication.

The communication line 203 is configured to transmit information between the parts included in the communication apparatus 200.

The memory 204 is configured to store instructions. The instructions may be a computer program.

The memory 204 may be a read-only memory (ROM) or another type of static storage device that can store static information and/or instructions, may be a random access memory (RAM) or another type of dynamic storage device that can store information and/or instructions, or may be an electrically erasable programmable read-only memory (EEPROM), a compact disc read-only memory (CD-ROM) or another compact disc storage, an optical disc storage (including a compressed optical disc, a laser disc, an optical disc, a digital universal optical disc, a Blu-ray disc, or the like), a magnetic disk storage medium or another magnetic storage device, or the like. This is not limited.

It should be noted that the memory 204 may be independent of the processor 201, or may be integrated with the processor 201. The memory 204 may be configured to store instructions, program code, some data, or the like. The memory 204 may be located inside the communication apparatus 200, or may be located outside the communication apparatus 200. This is not limited. The processor 201 is configured to execute the instructions stored in the memory 204, to implement the communication method provided in the following embodiments of this application.

In an example, the processor 201 may include one or more CPUs, for example, a CPU 0 and a CPU 1 in FIG. 2.

In an optional implementation, the communication apparatus 200 includes a plurality of processors, for example, may further include a processor 207 in addition to the processor 201 in FIG. 2.

In an optional implementation, the communication apparatus 200 further includes an output device 205 and an input device 206. For example, the input device 206 is a device, for example, a keyboard, a mouse, a microphone, or a joystick, and the output device 205 is a device, for example, a display or a speaker.

It should be noted that the communication apparatus 200 may be a desktop computer, a portable computer, a network server, a mobile phone, a tablet computer, a wireless terminal, an embedded device, a chip system, or a device having a structure similar to the structure in FIG. 2. In addition, the composition structure shown in FIG. 2 does not constitute a limitation on the communication apparatus. In addition to the parts shown in FIG. 2, the communication apparatus may include more or fewer parts than the parts shown in the figure, or some parts may be combined, or there may be a different part layout.

In this embodiment of this application, the chip system may include a chip, or may include a chip and another discrete component.

In addition, for actions, terms, and the like in embodiments of this application, refer to each other. This is not limited. In embodiments of this application, names of messages exchanged between devices, names of parameters in the messages, or the like are merely examples. Other names may be alternatively used during specific implementation. This is not limited.

The communication method shown in embodiments of this application may be applied to communication between a first communication apparatus and a second communication apparatus. The first communication apparatus may be a terminal device or a network device. The second communication apparatus may be a terminal device or a network device. In the following embodiments, an example in which the first communication apparatus is a terminal device and the second communication apparatus is a network device is used for description. It should be noted that the communication method shown in embodiments of this application may be applied to communication between a terminal device and a network device, may be applied to communication between terminal devices, or may be applied to communication between network devices. Communication between the network devices may be coordinated multipoint transmission between macro base stations, between micro base stations, or between a macro base station and a micro base station.

With reference to the communication system shown in FIG. 1a, the following uses an example in which the communication method shown in embodiments of this application is applied to communication between the terminal device and the network device to describe the communication method provided in embodiments of this application. The terminal device may be any terminal device in the communication system, and the network device may be any network device in the communication system. The terminal device and the network device that are described in the following embodiments each may have the parts shown in FIG. 2.

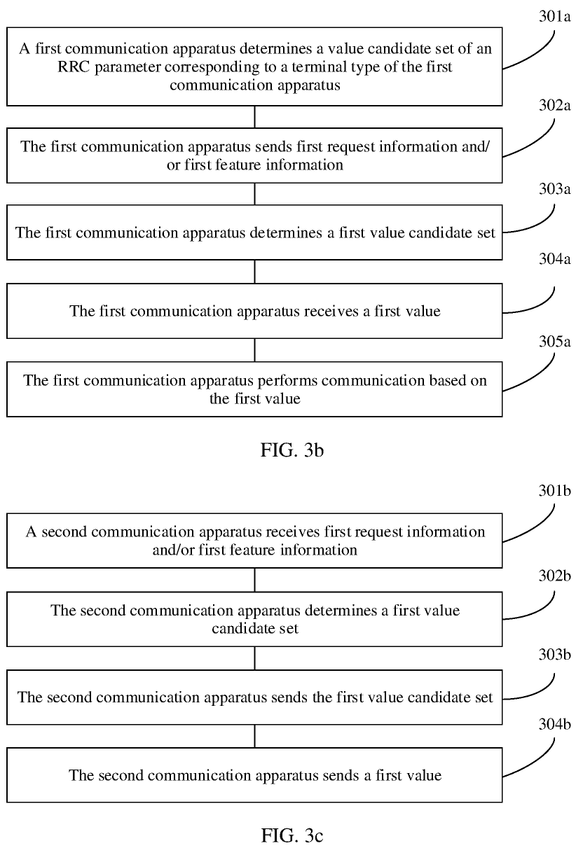

FIG. 3a is a flowchart of a communication method according to an embodiment of this application. As shown in FIG. 3a, the method may include the following steps.

Step 301: The terminal device determines a first value candidate set.

The first value candidate set may correspond to a terminal type of the terminal device, and the first value candidate set may include a value candidate set of an RRC parameter corresponding to the terminal type.

Optionally, a type of the RRC parameter may be one or more of the following: a data transmission configuration parameter, a channel state information (CSI) measurement and feedback configuration parameter, an initial access configuration parameter, a mobility configuration parameter, a power control configuration parameter, a beam management configuration parameter, another type of configuration parameter, and the like. This is not specifically limited in this application.

Optionally, the RRC parameter includes one or more of the following: a subcarrier spacing (SCS) configuration parameter, a CSI reporting frequency domain configuration parameter, a CSI reporting time domain configuration parameter, a channel quality information (CQI) table, beam failure recovery timing, a configured grant configuration parameter, a subband size indicator, a bandwidth part (BWP) configuration parameter, a code block group (CBG) configuration parameter, a beam failure instance max count configuration parameter, a CSI measurement configuration parameter, a physical uplink control channel (PUCCH) format configuration parameter, an RRC parameter in the protocol 38.331, another RRC parameter, and the like. This is not specifically limited in this application.

The configured grant configuration parameter may include one or more of the following: a frequency domain frequency hopping flag, a modulation and coding scheme (MCS) table, resource allocation, a quantity of repetitions, a K-repetition redundancy version, a periodicity, a configured grant configuration parameter in the protocol 38.331, another configured grant configuration parameter, and the like. This is not specifically limited in this application.

Optionally, a value candidate set of each RRC parameter is a subset of a full value set of the RRC parameter.

For example, for the SCS configuration parameter, an SCS includes 15 kHz, 30 kHz, 60 kHz, 120 kHz, 240 kHz, and another subcarrier spacing. This is not specifically limited in this application. For example, a value of the SCS configuration parameter may include at least one candidate set, and each candidate set may include one or more of 15 kHz, 30 kHz, 60 kHz, 120 kHz, 240 kHz, and a value of the another subcarrier spacing.

For example, in the CSI reporting frequency domain configuration parameter, a CSI reporting frequency domain manner may be a wideband, a subband, a CSI reporting band, and another CSI reporting frequency domain manner. This is not specifically limited in this application. For example, the CSI reporting frequency domain configuration parameter may include at least one candidate set, and each candidate set may include one or more of the wideband, the subband, the CSI reporting band, and another CSI reporting frequency domain configuration parameter.

For example, the CQI table may include a table 1, a table 2, a table 3, or another CQI table. This is not specifically limited in this application. For example, the CQI table may include at least one candidate set, and each candidate set may include one or more of the table 1, the table 2, the table 3, and the another CQI table. For example, the table 1 is a 64QAM normal-bit-rate CQI table, the table 2 is a 256QAM CQI table, and the table 3 is a 64QAM low-bit-rate CQI table. This is not specifically limited in this application. It should be noted that for specific descriptions of the table 1, the table 2, and the table 3, refer to related descriptions of the CQI table in an existing communication protocol. Details are not described again.

For example, in the subband size indicator, a subband size may include a value 1, a value 2, or another subband size. This is not specifically limited in this application. For example, the subband size indicator may include at least one candidate set, and each candidate set may include one or more of the value 1, the value 2, and the another subband size.

For example, in the beam failure recovery timing, a timer value may include 10 ms, 20 ms, 40 ms, 60 ms, 80 ms, 100 ms, 150 ms, 200 ms, and another timer value. This is not specifically limited in this application. For example, the beam failure recovery timing may include at least one candidate set, and each candidate set may include one or more of 10 ms, 20 ms, 40 ms, 60 ms, 80 ms, 100 ms, 150 ms, 200 ms, and the another timer value.

For example, the frequency hopping flag may include intra-slot (intraslot) frequency hopping and inter-slot (interslot) frequency hopping. This is not specifically limited in this application. For example, the frequency hopping flag may include at least one candidate set, and each candidate set may include one or more of the intra-slot frequency hopping and the inter-slot frequency hopping.

For example, the MCS table may be a 256QAM MCS table, a 64QAM normal-bit-rate MCS table, a 64QAM low-bit-rate MCS table, or another MCS table. This is not specifically limited in this application. For example, the MCS table may include at least one candidate set, and each candidate set may include one or more of the 256QAM MCS table, the 64QAM normal-bit-rate MCS table, the 64QAM low-bit-rate MCS table, and the another MCS table.

For example, the resource allocation may include a type 0, a type 1, dynamic switching, and another resource allocation manner. This is not specifically limited in this application. For example, the resource allocation may include at least one candidate set, and each candidate set may include one or more of the type 0, the type 1, the dynamic switching, and the another resource allocation manner.

For example, the quantity of repetitions may include one, two, four, eight, or the like. This is not specifically limited in this application. For example, the quantity of repetitions may include at least one candidate set, and each candidate set may include one or more of one, two, four, and eight.

For example, the K-repetition redundancy version may be 0, 2, 3, 1, or 0, 3, 0, 3, or 0, 0, 0, 0, or another redundancy version. This is not specifically limited in this application. For example, the K-repetition redundancy version may include at least one candidate set, and each candidate set may include one or more of the 0, 2, 3, 1, the 0, 3, 0, 3, or the 0, 0, 0, 0.

For example, the periodicity may include a plurality of values. The periodicity may include at least one candidate set, and each candidate set may include one or more of the periodicity values.

Optionally, the value candidate set of the RRC parameter indicates a configuration manner of the RRC parameter.

The configuration manner includes a configuration parameter field, and the configuration parameter field includes a configuration parameter of the configuration manner. Alternatively, the configuration manner includes a configuration parameter.

For example, the RRC parameter is the configured grant configuration parameter. A value candidate set of the configured grant configuration parameter may be used to indicate a configuration manner of the configured grant configuration parameter. The configuration manner may include the configuration parameter field. The configuration parameter field may include one or more of the frequency hopping flag, the MCS table, the resource allocation, the quantity of repetitions, the K-repetition redundancy version, and the periodicity. For example, the configuration parameter field includes the frequency hopping flag. The configuration parameter field may include a configuration parameter of the frequency hopping flag.

For another example, the RRC parameter is the SCS configuration parameter. A value candidate set of the SCS configuration parameter may be used to indicate a configuration manner of the SCS configuration parameter. The configuration manner may include a configuration parameter. For example, the configuration manner may include one or more of 15 kHz, 30 kHz, 60 kHz, 120 kHz, and 240 kHz.

Optionally, when the terminal type corresponding to the terminal device is determined, the terminal type corresponding to the terminal device is determined based on one or more of the following factors: a service type, mobility, transmission latency requirement, a channel environment, a reliability requirement, a coverage requirement, and a communication scenario.

The service type may be determined based on a size of service data. For example, the service type may include large-packet data, medium-packet data, and small-packet data. The mobility may include movement and fixation. The movement may also include irregular movement, movement along a fixed route, ultra-short-distance movement, and the like. The transmission latency requirement may include high transmission latency, low transmission latency, average transmission latency, and the like. The channel environment may include a variable channel environment, a stable channel environment, a relatively stable channel environment, and the like. The reliability requirement may include high reliability, low reliability, average reliability, and the like. The coverage requirement may include wide coverage, strong coverage, weak coverage, average coverage, deep coverage, and the like. The communication scenario may include a communication scenario included in the foregoing descriptions of the communication system, or the communication scenario may include uplink communication, downlink communication, uplink and downlink communication, sidelink communication, backhaul communication, access communication, relay communication, satellite communication, terahertz communication, optical communication, green communication, and the like. This is not limited.

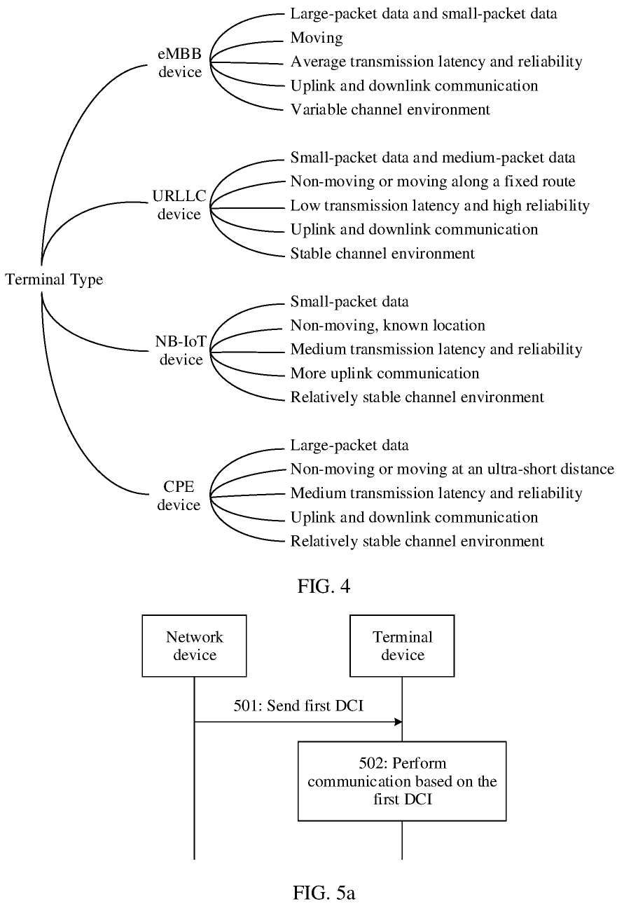

For example, as shown in FIG. 4, the terminal type includes an eMBB device, a URLLC device, an NB-IoT device, and a CPE device. The eMBB device is mainly configured to transmit the large-packet data, or may be configured to transmit the small-packet data, is generally in a moving state, has an average requirement for transmission latency and reliability, uplink and downlink communication, and a complex and variable channel environment, and may perform indoor communication and outdoor communication. For example, the eMBB device may be a mobile phone. The URLLC device is mainly configured to transmit the small-packet data, or may transmit the medium-packet data, is generally in a non-moving state, or may move along a fixed route, and has a higher requirement for transmission latency and reliability, that is, requires low transmission latency and high reliability, uplink and downlink communication, and a stable channel environment. For example, the URLLC device may be a factory device. The NB-IoT device is mainly configured to transmit small data, is generally in a non-moving state, and has a known location, a medium requirement for transmission latency and reliability, more uplink communication, and a relatively stable channel environment. For example, the NB-IoT device may be a smart water meter or a sensor. The CPE device is mainly configured to transmit the large-packet data, is generally in a non-moving state, or may perform ultra-short-distance movement, and has a medium requirement for transmission latency and reliability, uplink and downlink communication, and a relatively stable channel environment. For example, the CPE device may be a terminal device in a smart home, an AR, a VR, or the like. When the terminal type of the terminal device is determined, the terminal type corresponding to the terminal device may be determined to be the eMBB device, the URLLC device, the NB-IoT device, or the CPE device based on the service type, the mobility, the transmission latency requirement, the reliability requirement, the channel environment, and the communication scenario of the terminal device.

It should be noted that the eMBB device may also be described as eMBB, the URLLC device may also be described as URLLC, the NB-IoT device may also be described as an NB-IoT, the CPE device may also be described as a CPE, and a V2X device may also be described as V2X. This is not limited.

Optionally, the first value candidate set corresponding to the terminal type is determined based on the terminal type. The first value candidate set may include the value candidate set of the RRC parameter corresponding to the terminal type.

Optionally, different terminal types correspond to different first value candidate sets.

The value candidate set of the RRC parameter indicates the configuration manner of the RRC parameter. The configuration manner includes the configuration parameter field, and the configuration parameter field includes the configuration parameter of the configuration manner. Alternatively, the configuration manner includes the configuration parameter.

Specifically, a correspondence between the terminal type and the value candidate set of the RRC parameter may also include one or more the following: a correspondence between the terminal type and the type of the RRC parameter, a correspondence between the terminal type and the configuration manner corresponding to the RRC parameter, a correspondence between the terminal type and the configuration parameter field of the configuration manner corresponding to the RRC parameter, and a correspondence between the terminal type and the configuration parameter of the RRC parameter.

The following embodiment is a communication method. In the method, the RRC parameter can be customized based on the terminal type, to match a function with a terminal, optimally meet requirements of various devices, reduce signaling overheads, and reduce latency during parameter switching. This can reduce communication complexity and chip costs. This embodiment of this application may be used as an independent embodiment, or may be combined with another embodiment of the present disclosure. This is not specifically limited in this application.

In a possible implementation, there is the correspondence between the terminal type and the type of the RRC parameter.

The following embodiment is a method for designing the RRC parameter. In the method, the type of the RRC parameter can be customized based on the terminal type, to match a function type and the terminal, optimally meet the requirements of the various devices, reduce the signaling overheads, and reduce the latency during parameter switching. This can reduce communication complexity and the chip costs. This embodiment of this application may be used as an independent embodiment, or may be combined with another embodiment of the present disclosure. This is not specifically limited in this application.

Specifically, the different terminal types may correspond to different communication requirements. Therefore, the terminal device may not need to support at least one of the foregoing types of the RRC parameter. Therefore, a type that is of the RRC parameter and that is suitable for the terminal device to perform communication may be determined based on the terminal type, to meet different communication requirements of terminal devices of the different terminal types, and reduce the signaling overheads.

Optionally, the terminal device and/or the network device may determine a candidate set of the type of the RRC parameter based on the terminal type.

For example, there is a correspondence between the terminal type and the candidate set of the type of the RRC parameter. The correspondence may be predefined in a protocol, or may be notified by the network device to the terminal device by using higher layer signaling or physical layer signaling. This is not specifically limited in this application.

For example, when the terminal device is always in a static state, the terminal device may not need to support beam management, and the network device may not need to configure the beam management configuration parameter for the terminal device. When the terminal device always performs small-packet transmission or short-distance transmission, the terminal device may not need to support power control, and the network device may not need to configure the power control configuration parameter for the terminal device.

For example, when the terminal type is the eMBB, a type of an RRC parameter corresponding to the eMBB may include the data transmission configuration parameter, the CSI measurement and feedback configuration parameter, the initial access configuration parameter, the mobility configuration parameter, the power control configuration parameter, and the beam management configuration parameter.

For example, in the eMBB, the data transmission configuration parameter may include the SCS configuration parameter, the CSI measurement and feedback configuration parameter may include the beam failure recovery timing, and the beam management configuration parameter may include the CSI reporting time domain configuration parameter.

For example, when the terminal type is the URLLC, a type of an RRC parameter corresponding to the URLLC may include the data transmission configuration parameter, the channel state information CSI measurement and feedback configuration parameter, and the beam management configuration parameter.

According to the foregoing design, because the URLLC is mainly used for small-packet service transmission, power control may not be performed. This reduces complexity. In addition, the URLLC is mainly used in a static scenario or a moving scenario with a fixed path, and has a relatively stable channel state. Therefore, CSI measurement and feedback may not be performed, and low-rate transmission is used. This reduces power consumption and improves communication efficiency. In addition, in a scenario of a URLLC of a type, for example, a robotic arm, beam management may be performed to implement beam alignment, location prediction, and preparation for data transmission. This can reduce latency, meet a requirement for a precise operation and latency of a service, and improve communication efficiency.

For example, in the URLLC, the data transmission configuration parameter may include the SCS configuration parameter, the CSI measurement and feedback configuration parameter may include the CSI reporting time domain configuration parameter, and the beam management configuration parameter may include the CSI reporting time domain configuration parameter.

For example, when the terminal type is the NB-IoT, a type of an RRC parameter corresponding to the NB-IoT includes the data transmission configuration parameter, the initial access configuration parameter, and the mobility configuration parameter.

According to the foregoing design, because an application scenario of the NB-IoT can be a high-speed movement scenario, mobility management may be performed, and power control may not be performed. This reduces complexity. In addition, CSI measurement and feedback may not be performed either, and low-rate transmission is used. This reduces power consumption and improves communication efficiency.

For example, in the NB-IoT, the data transmission configuration parameter may include the SCS configuration parameter.

For example, when the terminal type is the CPE, a type of an RRC parameter corresponding to the CPE may include the data transmission configuration parameter and the channel state information CSI measurement and feedback configuration parameter.

For example, in the CPE, the data transmission configuration parameter may include the SCS configuration parameter, and the CSI measurement and feedback configuration parameter may include the CSI reporting time domain configuration parameter.

According to the foregoing design, because an application scenario of the CPE is mainly static big data transmission, a high power consumption mode can be used, and power control does not need to be performed. For example, sending at maximum power is performed. High-rate transmission is performed, and no mobility and no beam management are included. This reduces complexity and power consumption, and improves communication efficiency.

Specifically, a value candidate set of each RRC parameter corresponding to the terminal type may be further determined for the terminal type based on a communication requirement of the terminal type. The first value candidate set corresponding to the terminal type is a set of the value candidate sets of the RRC parameters corresponding to the terminal type.

For example, the RRC parameter is the SCS configuration parameter, and a full value set of the SCS configuration parameter includes 15 kHz, 30 kHz, 60 kHz, 120 kHz, and 240 kHz. The value candidate set of the SCS configuration parameter corresponding to the terminal type may be determined based on the terminal type.

Optionally, the terminal device and/or the network device may determine the value candidate set of the SCS configuration parameter based on the terminal type. This embodiment of this application may be used as an independent embodiment, or may be combined with another embodiment of this application. This is not specifically limited in this application.

For example, there is a correspondence between the terminal type and the value candidate set of the SCS configuration parameter. The correspondence may be predefined in a protocol, or may be notified by the network device to the terminal device by using higher layer signaling or physical layer signaling. This is not specifically limited in this application.

For example, a terminal type A may correspond to a value candidate set A of the SCS configuration parameter, a terminal type B may correspond to a value candidate set B of the SCS configuration parameter, ..., and a terminal type X may correspond to a value candidate set X of the SCS configuration parameter.

For example, when the terminal type is the eMBB, the value candidate set of the SCS configuration parameter may include 15 kHz, 30 kHz, 120 kHz, and 240 kHz.

According to the foregoing design, because the eMBB is mainly used for medium-and large-packet service transmission, and does not need to meet a requirement for low latency and reliability, a smaller subcarrier spacing, for example, 15 kHz or 30 kHz may be used for data transmission in a frequency band FR 1. This improves communication efficiency.

For example, when the terminal type is the URLLC, the value candidate set of the SCS configuration parameter may include 30 kHz, 60 kHz, 120 kHz, or 240 kHz.

According to the foregoing design, because the URLLC is mainly used for small-packet service transmission, and needs to meet a requirement for low latency and reliability, a relatively large subcarrier spacing, for example, 30 kHz or 60 kHz, may be used for data transmission in a frequency band FR 1, and a larger subcarrier spacing, for example, 120 kHz, is used for data transmission in a frequency band FR 2. This can meet the requirement for low latency and reliability, and perform repeated transmission for a plurality of times within a specific time unit.

For example, when the terminal type is the NB-IoT, the value candidate set of the SCS configuration parameter may include 15 kHz and 120 kHz.

According to the foregoing design, because the NB-IoT is mainly used for small-packet service transmission, and does not need to meet a requirement for low latency and reliability, a smaller subcarrier spacing, for example, 15 kHz, may be used in a frequency band FR 1, and a smaller subcarrier spacing, for example, 120 kHz, may be used for data transmission in a frequency band FR 2. This improves communication efficiency.

For example, when the terminal type is the CPE, a first value candidate set of the SCS configuration parameter may include 15 kHz and 120 kHz, and a second value candidate set of the SCS configuration parameter may include 30 kHz and 240 kHz.

According to the foregoing design, the CPE is mainly used for large-packet service transmission. Therefore, when a requirement for low latency and reliability does not need to be met, a smaller subcarrier spacing, for example, 15 kHz, may be used in a frequency band FR 1, and a smaller subcarrier spacing, for example, 120 kHz, may be used for data transmission in a frequency band FR 2. This improves communication efficiency. When a requirement for low latency and reliability needs to be met, a smaller subcarrier spacing, for example, 30 kHz, may be used in a frequency band FR 1, and a larger subcarrier spacing, for example, 240 kHz, may be used for data transmission in a frequency band FR 2. This meets a latency requirement and improves communication efficiency.

Further, frequency bands of different frequencies may correspond to different full value sets of the SCS configuration parameter.

For example, for the frequency range 1 (FR 1), a full value set of the SCS configuration parameter may include 15 kHz, 30 kHz, and 60 kHz, and for the frequency range 2 (FR 2), a full value set of the SCS configuration parameter may include 60 kHz, 120 kHz, and 240 kHz. The FR 1 may be a frequency band below 6 G, and the FR 2 may be a frequency band above 6 G.

Optionally, the terminal device and/or the network device may determine the value candidate set of the SCS configuration parameter based on the terminal type and a frequency band. This embodiment of this application may be used as an independent embodiment, or may be combined with another embodiment of this application. This is not specifically limited in this application.

For example, there is a correspondence between the terminal type, the frequency band, and the value candidate set of the SCS configuration parameter. The correspondence may be predefined in a protocol, or may be notified by the network device to the terminal device by using higher layer signaling or physical layer signaling. This is not specifically limited in this application.

For example, a terminal type A may correspond to, for an FR 1, a value candidate set A1 of the SCS configuration parameter, and may correspond to, for an FR 2, a value candidate set A2 of the SCS configuration parameter, a terminal type B may correspond to, for an FR 1, a value candidate set B1 of the SCS configuration parameter value, and may correspond to, for an FR 2, a value candidate set B2 of the SCS configuration parameter, ..., and a terminal type X may correspond to, for an FR 1, a value candidate set X1 of the SCS configuration parameter, and may correspond to, for an FR 2, a value candidate set X2 of the SCS configuration parameter.

For example, when the terminal type is the eMBB, for the FR 1, the value candidate set of the SCS configuration parameter may include 15 kHz and 30 kHz, and for the FR 2, the value candidate set of the SCS configuration parameter may include 120 kHz and 240 kHz. For specific analysis and descriptions, refer to the foregoing descriptions. Details are not described herein again.

For example, when the terminal type is the URLLC, for the FR 1, the value candidate set of the SCS configuration parameter may include 30 kHz and 60 kHz, and for the FR 2, the value candidate set of the SCS configuration parameter may include 120 kHz. For specific analysis and descriptions, refer to the foregoing descriptions. Details are not described herein again.

For example, when the terminal type is the NB-IoT, for the FR 1, the value candidate set of the SCS configuration parameter may and 15 kHz, and for the FR 2, the value candidate set of the SCS configuration parameter may include 120 kHz. For specific analysis and descriptions, refer to the foregoing descriptions. Details are not described herein again.

For example, when the terminal type is the CPE, for the FR 1, the value candidate set of the SCS configuration parameter may include 15 kHz, and for the FR 2, the value candidate set of the SCS configuration parameter may include 120 kHz. For specific analysis and descriptions, refer to the foregoing descriptions. Details are not described herein again.

In the foregoing embodiment, compared with designing the value candidate set of the SCS configuration parameter only based on the terminal type, designing the value candidate set of the SCS configuration parameter for the terminal type and the frequency band may further reduce the signaling overheads.

For example, the RRC parameter is the CSI reporting frequency domain configuration parameter, and a full value set of the CSI reporting frequency domain configuration parameter includes the wideband, the subband, and the CSI reporting band. A value candidate set of the CSI reporting frequency domain configuration parameter corresponding to the terminal type may be determined based on the terminal type.

Optionally, the terminal device and/or the network device may determine the value candidate set of the CSI reporting frequency domain configuration parameter based on the terminal type. This embodiment of this application may be used as an independent embodiment, or may be combined with another embodiment of this application. This is not specifically limited in this application.

For example, there is a correspondence between the terminal type and the value candidate set of the CSI reporting frequency domain configuration parameter. The correspondence may be predefined in a protocol, or may be notified by the network device to the terminal device by using higher layer signaling or physical layer signaling. This is not specifically limited in this application.

For example, the terminal type A may correspond to a value candidate set AC of the CSI reporting frequency domain configuration parameter, the terminal type B may correspond to a value candidate set BC of the CSI reporting frequency domain configuration parameter, ..., and the terminal type X may correspond to a value candidate set XC of the CSI reporting frequency domain configuration parameter.

For example, when the terminal type is the eMBB, the value candidate set of the CSI reporting frequency domain configuration parameter may include the wideband, the subband, and the CSI reporting band.

According to the foregoing design, a communication scenario of the eMBB includes an indoor scenario, an outdoor scenario, a high-movement-speed scenario, a low-movement-speed scenario, a static scenario, and the like. A channel state is relatively complex. Therefore, the value that is of the CSI reporting frequency domain configuration parameter for CSI measurement and feedback and that can be used can include the wideband, the subband, and the CSI reporting band. This meets requirements in various scenarios, performs on-demand indication, reduces power consumption, and improves communication efficiency.

For example, when the terminal type is the URLLC, the value candidate set of the CSI reporting frequency domain configuration parameter may include the wideband and the subband.

According to the foregoing design, because the URLLC is mainly used in a static scenario or a scenario of moving along a fixed path, and has a relatively stable channel state, the CSI reporting frequency domain configuration parameter and that is for CSI measurement and feedback and that can be used can be the wideband or the subband. This reduces power consumption and improves communication efficiency.

For example, when the terminal type is the NB-IoT, the value candidate set of the CSI reporting frequency domain configuration parameter may include the wideband and the subband.

According to the foregoing design, because an application scenario of the NB-IoT is mainly a static scenario, for example, a smart water meter, and a channel state is a relatively stable, the CSI reporting frequency domain configuration parameter that is for CSI measurement and feedback and that can be used can be the wideband. However, in a high-speed scenario of the NB-IoT, the CSI reporting frequency domain configuration parameter that is for CSI measurement and feedback and that can be used can be the subband. This meets requirements in various scenarios, performs on-demand indication, reduces power consumption, and improves communication efficiency.

For example, when the terminal type is the CPE, the value candidate set of the CSI reporting frequency domain configuration parameter may include the wideband.

According to the foregoing design, because an application scenario of the CPE is mainly static big data transmission, the used CSI reporting frequency domain configuration parameter for CSI measurement and feedback can be the wideband. This reduces complexity and power consumption, and improves communication efficiency.

For example, the RRC parameter is the CQI table, and a full value set of the CQI table includes the table 1, the table 2, and table 3. A value candidate set of the CQI table corresponding to the terminal type may be determined based on the terminal type. For example, the terminal type A may correspond to a value candidate set AQ of the CQI table, the terminal type B may correspond to a value candidate set BQ of the CQI table, ..., and the terminal type X may correspond to a value candidate set XQ of the CQI table.

For example, when the terminal type is the eMBB, the value candidate set of the CQI table may include the table 1, the table 2, and the table 3.

According to the foregoing design, because the eMBB is mainly used for medium-and large-packet service transmission, and also performs small-packet service transmission, a plurality of application scenarios are considered, and the value candidate set of the CQI table of the eMBB can be designed to include the table 1, the table 2, and the table 3. This meets requirements in different scenarios and improves communication efficiency.

For example, when the terminal type is the URLLC, the value candidate set of the CQI table may include the table 3.

According to the foregoing design, because the URLLC is mainly used for small-packet service transmission, and needs to meet a requirement for low latency and reliability, the value candidate set of the CQI table of the URLLC can be designed to include the table 3, namely, the 64QAM low-bit-rate CQI table. This meets a requirement for high reliability and improves communication efficiency.

For example, when the terminal type is the NB-IoT, a value candidate set of the CQI table may include the table 1.

According to the foregoing design, because the NB-IoT is mainly used for small-packet service transmission, and does not need to meet a requirement for low latency and reliability, the value candidate set of the CQI table of the URLLC can be designed to include the table 1, namely, the 64QAM normal-bit-rate CQI table. This meets the communication requirement and improves communication efficiency.

For example, when the terminal type is the CPE, the value candidate set of the CQI table may include the table 2 and the table 3.

According to the foregoing design, the CPE is mainly used for large-packet service transmission. Therefore, when a requirement for low latency and reliability does not need to be met, the value candidate set of the CQI table can be designed to include the table 2, namely, the 256QAM CQI table. This implements fast large packet transmission and improves communication efficiency. When a requirement for low latency and reliability needs to be met, the value candidate set of the CQI table can be designed to include the table 3, namely, the 64QAM low-bit-rate CQI table. This meets a reliability requirement and improves communication efficiency.

For example, the RRC parameter is the beam failure recovery timing, and a full value set of the beam failure recovery timing includes 10 ms, 20 ms, 40 ms, 60 ms, 80 ms, 100 ms, 150 ms, and 200 ms. A value candidate set of the beam failure recovery timing corresponding to the terminal type may be determined based on the terminal type.

Optionally, the terminal device and/or the network device may determine the value candidate set of the beam failure recovery timing based on the terminal type. This embodiment of this application may be used as an independent embodiment, or may be combined with another embodiment of this application. This is not specifically limited in this application.

For example, there is a correspondence between the terminal type and the value candidate set of the beam failure recovery timing. The correspondence may be predefined in a protocol, or may be notified by the network device to the terminal device by using higher layer signaling or physical layer signaling. This is not specifically limited in this application.

For example, the terminal type A may correspond to a value candidate set AT of the beam failure recovery timing, the terminal type B may correspond to a value candidate set BT of the beam failure recovery timing, ..., and the terminal type X may correspond to a value candidate set XT of the beam failure recovery timing.

For example, when the terminal type is the eMBB, the value candidate set of the beam failure recovery timing may include 10 ms, 20 ms, 40 ms, 60 ms, 80 ms, 100 ms, 150 ms, and 200 ms.

According to the foregoing design, a communication scenario of the eMBB includes an indoor scenario, an outdoor scenario, a high-movement-speed scenario, a low-movement-speed scenario, a static scenario, and the like. A channel state is relatively complex. Therefore, the value candidate set of the beam failure recovery timing can include a plurality of values such as 10 ms, 20 ms, 40 ms, 60 ms, 80 ms, 100 ms, 150 ms, and 200 ms. This meets requirements in various scenarios, performs on-demand indication, reduces power consumption, and improves communication efficiency.

For example, when the terminal type is the URLLC, the value candidate set of the beam failure recovery timing may include 10 ms, 20 ms, and 40 ms.

According to the foregoing design, because the URLLC is mainly applied to a static scenario or a scenario of moving along a fixed path, but needs to meet a requirement of low latency and high reliability, the value candidate set that is of the beam failure recovery timing and that can be used can include 10 ms, 20 ms, and 40 ms. This quickly implements beam recovery, reduces latency, and improves communication efficiency.

For example, when the terminal type is the NB-IoT, the value candidate set of the beam failure recovery timing may include 80 ms, 100 ms, 150 ms and 200 ms.

According to the foregoing design, because an application scenario of the NB-IoT is mainly a static scenario, for example, a smart water meter, and a channel state is relatively stable, the value candidate set that is of the beam failure recovery timing and that can be used can include 80 ms, 100 ms, 150 ms, and 200 ms. A value of the beam failure recovery timing is large, and on-demand indication is performed. This can reduce power consumption and improve communication efficiency.

For example, when the terminal type is the CPE, the value candidate set of the beam failure recovery timing may include 20 ms, 60 ms, and 80 ms.

According to the foregoing design, because an application scenario of the CPE is mainly static big data transmission, but a requirement for low latency and high reliability needs to be met in some scenarios, a used value candidate set of the beam failure recovery timing can include 20 ms, 60 ms, and 80 ms. This reduces complexity and latency, and improves communication efficiency.

For example, the RRC parameter is the CSI reporting time domain configuration parameter, and a full value set of the CSI reporting time domain configuration parameter includes periodic reporting, aperiodic reporting, and semi-persistent reporting. A value candidate set of the CSI reporting time domain configuration parameter corresponding to the terminal type may be determined based on the terminal type.

Optionally, the terminal device and/or the network device may determine the value candidate set of the CSI reporting time domain configuration parameter based on the terminal type. This embodiment of this application may be used as an independent embodiment, or may be combined with another embodiment of this application. This is not specifically limited in this application.

For example, there is a correspondence between the terminal type and the value candidate set of the CSI reporting time domain configuration parameter. The correspondence may be predefined in a protocol, or may be notified by the network device to the terminal device by using higher layer signaling or physical layer signaling. This is not specifically limited in this application.

For example, the terminal type A may correspond to a value candidate set AS of the CSI reporting time domain configuration parameter, the terminal type B may correspond to a value candidate set BS of the CSI reporting time domain configuration parameter, ..., and the terminal type X may correspond to a value candidate set XS of the CSI reporting time domain configuration parameter.

For example, when the terminal type is the eMBB, the value candidate set of the CSI reporting time domain configuration parameter may include the periodic reporting, the aperiodic reporting, and the semi-persistent reporting.

According to the foregoing design, a communication scenario of the eMBB includes an indoor scenario, an outdoor scenario, a high-movement-speed scenario, a low-movement-speed scenario, a static scenario, and the like. A channel state is relatively complex. Therefore, the value candidate set that is of the CSI reporting time domain configuration parameter and that can be used can include the periodic reporting, the aperiodic reporting, and the semi-persistent reporting. This meets requirements in various scenarios, performs on-demand indication, reduces power consumption, and improves communication efficiency.

For example, when the terminal type is the URLLC, the value candidate set of the CSI reporting time domain configuration parameter may include the aperiodic reporting.

According to the foregoing design, the URLLC is mainly used in a static scenario or a scenario of moving along a fixed path, has a relatively stable channel state, but needs to meet a requirement for low latency. Therefore, the CSI reporting time domain configuration parameter that is for CSI measurement and feedback and that can be used can be the aperiodic reporting, and on-demand indication is performed. This reduces power consumption and latency, and improves communication efficiency.

For example, when the terminal type is the CPE, the value candidate set of the CSI reporting time domain configuration parameter may include the periodic reporting.

According to the foregoing design, because an application scenario of the CPE is mainly static big data transmission, and a channel state is relatively stable, the used CSI reporting time domain configuration parameter for CSI measurement and feedback can be the periodic reporting. This reduces complexity and power consumption, and improves communication efficiency.

The set of the value candidate sets of the RRC parameters corresponding to the terminal type can be determined, as the first value candidate set corresponding to the terminal type, based on a correspondence between the terminal type and the value candidate set of each RRC parameter.

The terminal device may determine, in at least one of Manner 1 to Manner 4 based on a correspondence between the terminal type and the first value candidate set, the first value candidate set corresponding to the terminal type of the terminal device.

Manner 1: The first value candidate set is pre-specified in a communication protocol.

The RRC parameter corresponding to the terminal type and the value candidate set of each RRC parameter corresponding to the terminal type may be determined for the terminal type by using a training model, for example, machine learning or a neural network. Alternatively, the RRC parameter corresponding to the terminal type and the value candidate set of each RRC parameter corresponding to the terminal type may be determined based on a value of an RRC parameter configured by the network device for each terminal device within a period of time based on a communication requirement of each terminal device. Alternatively, the RRC parameter corresponding to the terminal type and the value candidate set of each RRC parameter corresponding to the terminal type may be determined based on communication experience.

For example, communication quality of the terminal device with different RRC parameter combinations and/or different candidate sets of a value of the RRC parameter may be determined by using a training model, for example, machine learning or a neural network, and the RRC parameter corresponding to the terminal type and the value candidate set of each RRC parameter corresponding to the terminal type may be determined based on the communication quality.

For another example, the terminal type A includes a terminal device 1, a terminal device 2, and a terminal device 3. An RRC parameter corresponding to the terminal type A and a value candidate set of each RRC parameter corresponding to the terminal type may be determined based on values of RRC parameters configured by the network device for the terminal device 1, the terminal device 2, and the terminal device 3 within a period of time.

Specifically, a first value candidate set corresponding to each terminal type may be written to the communication protocol, so that the network device and the terminal device determine, according to the communication protocol, the first value candidate set corresponding to the terminal type of the terminal device. This prevents the network device from sending the first value candidate set to the terminal device, reduces the signaling overheads, communication latency, and power consumption of the terminal.

Manner 2: The network device sends the first value candidate set to the terminal device.

The network device may determine, in a random access process or when the terminal device initially accesses a network, the first value candidate set corresponding to the terminal device based on the terminal type of the terminal device, and deliver the first value candidate set to the terminal device.

Alternatively, the network device may send the first value candidate set by using higher layer signaling or physical layer signaling, and the terminal device determines the first value candidate set according to an indication of the network device.

According to the foregoing solution, the network device can configure the first value candidate set. This implements configuration flexibility of the first value candidate set, better adapts to different scenarios, meets requirements of the different scenarios, reduces value indication overheads, and improves communication efficiency.

Manner 3: The terminal device sends first request information to the network device, and the network device sends the first value candidate set to the terminal device based on the first request information.

The first request information is used to request the value candidate set of the RRC parameter corresponding to the terminal type of the terminal device.

Optionally, the first request information includes a value candidate set that is of the RRC parameter corresponding to the terminal type and that is determined by the terminal device.

Specifically, the terminal device may determine, based on a communication requirement of the terminal device, the value candidate set that is of the RRC parameter and that is suitable for the terminal device to perform communication, and send the value candidate set of the RRC parameter to the network device. After receiving the value candidate set of the RRC parameter sent by the terminal device, the network device determines whether the terminal device can use the value candidate set of the RRC parameter. If yes, the network device sends the value candidate set of the RRC parameter to the terminal device as the first value candidate set. If no, the network device may determine, based on the terminal type of the terminal device, the first value candidate set corresponding to the terminal device, and send the first value candidate set to the terminal device.

According to the foregoing solution, the terminal device can send the recommended first value candidate set to the network device. This implements configuration flexibility of the first value candidate set, better meets a communication requirement of the terminal device, better adapts to different scenarios, meets requirements of the different scenarios, reduces value indication overheads, and improves communication efficiency.

Manner 4: The terminal device sends first feature information to the network device, and the network device sends the first value candidate set to the terminal device based on the first feature information.

The first feature information may be used to indicate the terminal type of the terminal device.

Optionally, the first feature information may be the terminal type of the terminal device, or may be a communication requirement used to indicate the terminal type of the terminal device. The communication requirement may be one or more of the service type, the mobility, the transmission latency requirement, the channel environment, the reliability requirement, the coverage requirement, and the communication scenario.

Specifically, the network device may determine the terminal type of the terminal device based on the first feature information sent by the terminal device, determine the first value candidate set corresponding to the terminal type, and send the first value candidate set to the terminal device.

According to the foregoing solution, the terminal device can send the first feature information to the network device, and the first value candidate set is determined based on the first feature information. This implements configuration flexibility of the first value candidate set, better meets a communication requirement of the terminal device, better adapts to different scenarios, meets requirements of the different scenarios, reduces value indication overheads, and improves communication efficiency.

Step 302: The network device sends a first value to the terminal device. Correspondingly, the terminal device receives the first value.

The first value includes a group of RRC parameter values in the first value candidate set.

Optionally, when the first value candidate set includes one value, for example, the first value candidate set includes only the first value, the network device may not send the first value to the terminal device. In this case, the terminal device and the network device may determine that the RRC parameter value is the first value.

Optionally, when the first value candidate set includes a plurality of values, for example, the first value candidate set includes the first value and a second value, the network device may not send the first value to the terminal device. In this case, the terminal device and the network device may determine that the RRC parameter value is a default value. The default value includes an RRC parameter value corresponding to the terminal type in the first value candidate set. To be specific, when the network device does not indicate an RRC parameter value to the terminal device, the RRC parameter value is the default value. When the terminal device does not receive an RRC parameter value indicated by the network device, the RRC parameter value is the default value.

Further, the default value of the RRC parameter value may be predefined in a protocol, or may be notified by the network device to the terminal device by using higher layer signaling or physical layer signaling.

In the foregoing manner, when the RRC parameter value is the default value, the signaling overheads can be reduced, and communication performance can be improved.

Specifically, the network device may determine the first value from the first value candidate set based on the first value candidate set corresponding to the terminal device, and send the first value to the terminal device.

For example, a first value candidate set corresponding to the terminal device A includes an SCS configuration parameter and a CSI reporting frequency domain configuration parameter, a value candidate set of the SCS configuration parameter includes 15 kHz, 30 kHz, 120 kHz, and 240 kHz, and a value candidate set of the CSI reporting frequency domain configuration parameter includes a wideband, a subband, and a CSI reporting band. The network device may determine a first value for the terminal device A based on a communication requirement of the terminal device. For example, the first value includes the SCS configuration parameter and the CSI reporting frequency domain configuration parameter, a value of the SCS configuration parameter is 15 kHz, and a value of the CSI reporting frequency domain configuration parameter is the wideband.

Step 303: The terminal device performs communication based on the first value.

According to the method shown in FIG. 3a, the first value candidate set corresponding to the terminal type is determined based on the terminal type, so that the network device can determine the first value for the terminal device from the first value candidate set. This reduces RRC signaling overheads, storage overheads of the terminal device, and power consumption of the terminal device.

Based on the method shown in FIG. 3a, alternatively, as shown in FIG. 3b, the communication method provided in embodiments of this application may be described from a perspective of a first communication apparatus.

FIG. 3b is a flowchart of a communication method according to an embodiment of this application. As shown in FIG. 3b, the method may include the following steps.

Step 301a: The first communication apparatus determines a value candidate set of an RRC parameter corresponding to a terminal type of the first communication apparatus.

Specifically, for specific descriptions of determining, by the first communication apparatus, the value candidate set of the RRC parameter corresponding to the terminal type of the first communication apparatus, refer to the specific descriptions of determining, by the terminal device, the value candidate set of the RRC parameter corresponding to the terminal type of the terminal device in step 301. Details are not described again.

It should be noted that the step may be omitted.

Step 302a: The first communication apparatus sends first request information and/or first feature information.

Specifically, for specific descriptions of sending the first request information and/or the first feature information by the first communication apparatus, refer to the specific descriptions of sending the first request information and/or the first feature information by the terminal device in step 301. Details are not described again.

It should be noted that the step may be omitted.

Step 303a: The first communication apparatus determines a first value candidate set.

Specifically, for specific descriptions of determining the first value candidate set by the first communication apparatus, refer to the related descriptions of determining the first value candidate set by the terminal device in step 301. Details are not described again.

Step 304a: The first communication apparatus receives a first value.

Specifically, for specific descriptions of receiving the first value by the first communication apparatus, refer to the related descriptions of receiving the first value by the terminal device in step 302. Details are not described again.

Step 305a: The first communication apparatus performs communication based on the first value.

Specifically, for specific descriptions of performing communication by the first communication apparatus based on the first value, refer to the related descriptions of performing communication by the terminal device based on the first value in step 303. Details are not described again.

Based on the methods shown in FIG. 3a and FIG. 3b, alternatively, as shown in FIG. 3c, the communication method provided in embodiments of this application may be described from a perspective of a second communication apparatus.

FIG. 3c is a flowchart of a communication method according to an embodiment of this application. As shown in FIG. 3c, the method may include the following steps.

Step 301b: The second communication apparatus receives the first request information and/or the first feature information.

Specifically, for specific descriptions of receiving the first request information and/or the first feature information by the second communication apparatus, refer to the specific descriptions of receiving the first request information and/or the first feature information by the network device in step 301. Details are not described again.

It should be noted that the step may be omitted.

Step 302b: The second communication apparatus determines the first value candidate set.

Specifically, for specific descriptions of determining the first value candidate set by the second communication apparatus, refer to the specific descriptions of determining the first value candidate set by the network device in step 301. Details are not described again.

Step 303b: The second communication apparatus sends the first value candidate set.

Specifically, for specific descriptions of sending the first value candidate set by the second communication apparatus, refer to the specific descriptions of sending the first value candidate set by the network device in step 301. Details are not described again.

Step 304b: The second communication apparatus sends the first value.

Specifically, for specific descriptions of sending the first value by the second communication apparatus, refer to the specific descriptions of sending the first value by the network device in step 302. Details are not described again.

This embodiment of this application may be used as an independent embodiment, or may be combined with another embodiment of this application. This is not specifically limited in this application.

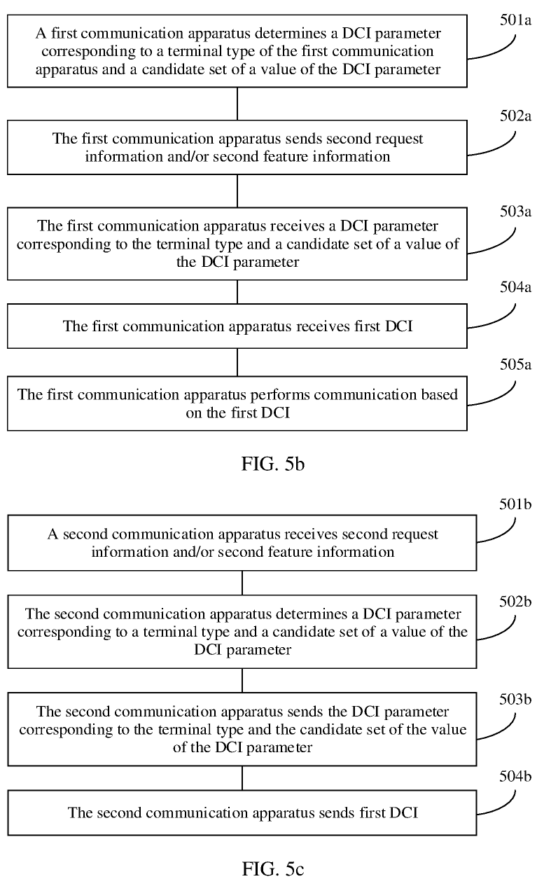

Similar to the method that is shown in FIG. 3a and that resolves the technical problem that, when configuring a plurality of RRC parameters for the terminal device, the network device needs to determine a first value for each RRC parameter from a full value set of the RRC parameter and send the first value to the terminal device, resulting in high RRC signaling overheads, high storage overheads of the terminal device, and high power consumption of the terminal device, as shown in FIG. 5a, a communication method is further provided in an embodiment of this application, to resolve a technical problem that, when a network device sends DCI to a terminal device to schedule RRC signaling and/or a data signal, because a format of the DCI is a fixed format pre-specified in a communication protocol, the signaling overheads of the DCI are high, resulting in low spectral efficiency of the communication system, and high power consumption of the terminal device.

FIG. 5a is a flowchart of the communication method according to the embodiment of this application. This embodiment of this application may be used as an independent embodiment, or may be combined with another embodiment of this application. This is not specifically limited in this application. As shown in FIG. 5a, the method may include the following steps.

Step 501: The network device sends first DCI to the terminal device. Correspondingly, the terminal device receives the first DCI.

The first DCI may include values of a plurality of DCI parameters, and the DCI parameter included in the first DCI corresponds to a terminal type of the terminal device. A candidate set of the value of the DCI parameter corresponds to the terminal type, and the candidate set includes at least one value of the DCI parameter corresponding to the terminal type.

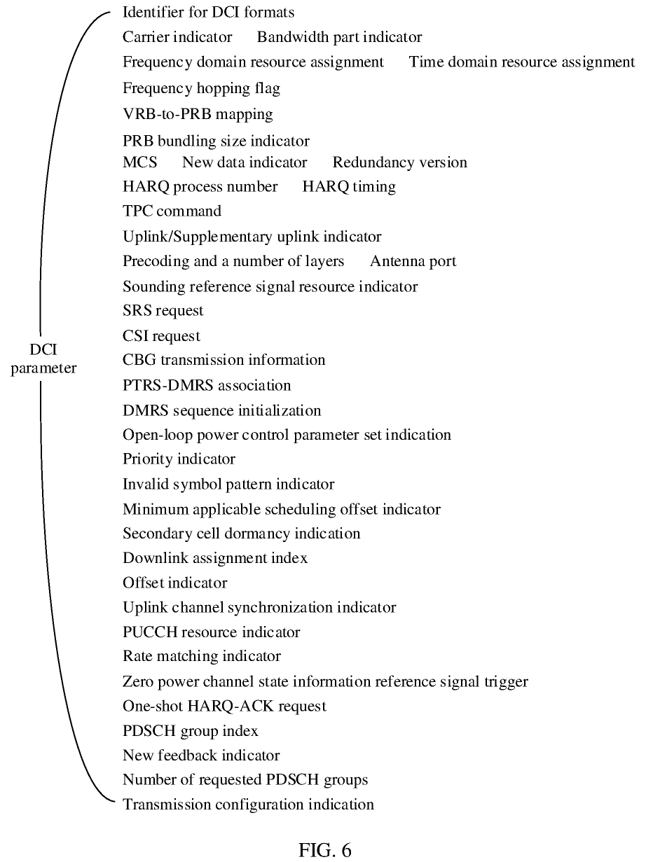

Optionally, as shown in FIG. 6, the DCI parameter may include one or more of the following: an identifier for DCI formats (uplink/downlink indicator), a carrier indicator, a bandwidth part indicator, frequency domain resource assignment, time domain resource assignment, a frequency hopping flag, a virtual resource block to physical resource block mapping (VRB-to-PRB mapping), a physical resource block bundling size indicator (PRB bundling size indicator), an MCS, a new data indicator, a redundancy version, a hybrid automatic repeat request process number (HARQ process number), HARQ timing, a transmit power control command for a scheduled physical uplink shared channel (TPC command for scheduled PUSCH), an uplink/supplementary uplink indicator (UL/SUL indicator), precoding and a number of layers, an antenna port, sounding reference signal resource indicator (SRS resource indicator), an SRS request, a CSI request, CBG transmission information (CBGTI), a phase tracking reference signal-demodulation reference signal association (PTRS-DMRS association), DMRS sequence initialization, an open-loop power control parameter set indication, a priority indicator, an invalid symbol pattern indicator, a minimum applicable scheduling offset indicator, a secondary cell dormancy indicator (SCell dormancy indication), a downlink assignment index, an offset indicator (beta_offset indicator), an uplink synchronization channel indicator (UL-SCH indicator), a PUCCH resource indicator, channel access (ChannelAccess-CPext), a rate matching indicator, a zero power channel state information-reference signal trigger (ZP CSI-RS trigger), a one-shot HARQ-ACK request, a PDSCH group index, a new feedback indicator, a number of requested PDSCH groups, a transmission configuration indication, and the like.

The DCI parameter corresponding to the terminal type may be determined based on the terminal type.

Optionally, the terminal device and/or the network device may determine the DCI parameter based on the terminal type. This embodiment of this application may be used as an independent embodiment, or may be combined with another embodiment of this application. This is not specifically limited in this application.

For example, there is a correspondence between the terminal type and the DCI parameter. The correspondence may be predefined in a protocol, or may be notified by the network device to the terminal device by using higher layer signaling or physical layer signaling. This is not specifically limited in this application.

It should be noted that, for descriptions of the terminal type, refer to the descriptions of the terminal type in step 301. Details are not described again.

Specifically, different terminal types may correspond to different communication requirements. Therefore, the terminal device may not need to support at least one or more of the foregoing DCI parameters. Therefore, a DCI parameter that is suitable for the terminal device to perform communication may be determined based on the terminal type, to meet different communication requirements of terminal devices of the different terminal types, and reduce the signaling overheads of DCI.

Optionally, the different terminal types correspond to different DCI parameter sets, and the DCI parameter set may include one or more of the foregoing DCI parameters. For example, a terminal type A may correspond to a DCI parameter set AD, a terminal type B may correspond to a DCI parameter set BD, ..., and a terminal type X may correspond to a DCI parameter set XD.

For example, when the terminal type is an eMBB, a DCI parameter corresponding to the eMBB may include the time domain resource assignment, the frequency domain resource assignment, the BWP indicator, the MCS, the new data indicator, the redundancy version, the HARQ process number, the HARQ timing, the TPC command, the antenna port, the precoding and the number of layers, the SRS request, and the CSI request.

For example, a DCI parameter corresponding to the eMBB may alternatively include the identifier for DCI formats (uplink/downlink indicator), the carrier indicator, the BWP indicator, the frequency domain resource assignment, the time domain resource assignment, the frequency hopping flag, the VRB-to-PRB mapping, the PRB bundling size indicator, the MCS, the new data indicator, the redundancy version, the HARQ process number, the HARQ timing, the TPC command, the uplink/supplementary uplink indicator, the precoding information and the number of layers, and the antenna port.

For example, when the terminal type is a URLLC, a DCI parameter corresponding to the URLLC may include the time domain resource indicator, the frequency domain resource indicator, the MCS, the new data indicator, the HARQ process number, the TPC command, the SRS request, and the CSI request.

According to the foregoing design, the URLLC is mainly used for small-packet service transmission. In addition, the URLLC is mainly used in a static scenario or a scenario of moving along a fixed path, and has a relatively stable channel state. Therefore, frequency hopping and VRB-to-PRB interleave mapping may not be performed. In other words, the DCI parameter may not include the frequency hopping flag and the VRB-to-PRB mapping. This reduces signaling overheads. In addition, to meet a requirement for low latency and high reliability, the URLLC may generally use low-rate transmission, and therefore, may use only a single antenna port to perform rank-1 transmission. This reduces power consumption and the signaling overheads, and improves communication efficiency. In other words, the DCI parameter may not include the precoding information and the number of layers and the antenna port. This reduces the signaling overheads. In addition, in a scenario of a URLLC of a type, for example, a robotic arm, beam management may be performed to implement beam alignment, location prediction, and preparation for data transmission. Therefore, the DCI parameter may include the SRS request and the CSI request. This can reduce latency, meet a requirement for a precise operation and latency of a service, and improve communication efficiency.

For example, a DCI parameter corresponding to the URLLC may alternatively include the frequency domain resource assignment, the MCS, the new data indicator, and the redundancy version.

In addition, a channel state is relatively stable in a static scenario or a scenario of moving along a fixed path. Therefore, the DCI parameter may not include the SRS request and the CSI request. This can reduce complexity and signaling overheads, meet a communication requirement, and improve communication efficiency.

For example, when the terminal type is an NB-IoT, a DCI parameter corresponding to the NB-IoT may include the frequency domain resource indicator, the MCS, and the HARQ process number.

According to the foregoing design, because an application scenario of the NB-IoT may be small-packet data transmission and is a static scenario, the DCI may not include the SRS request, the CSI request, the frequency hopping flag, the VRB-to-PRB mapping, the precoding information and the number of layers, and the antenna port, and low-rate transmission is used. This reduces signaling overheads and power consumption, and improves communication efficiency.

For example, a DCI parameter corresponding to the NB-IoT may alternatively include the MCS, the new data indicator, and the redundancy version.

According to the foregoing design, an application scenario of the NB-IoT can be small-packet data transmission, and the HARQ processes number can be designed to be 1. Therefore, the DCI may not include the HARQ process number. This reduces signaling overheads and power consumption, and improves communication efficiency.

For example, when the terminal type is CPE, a DCI parameter corresponding to the CPE may include the time domain resource assignment, the frequency domain resource assignment, the BWP indicator, the MCS, the new data indicator, the redundancy version, the HARQ process number, the HARQ timing, the TPC command, the antenna port, the precoding and the number of layers, the SRS request, and the CSI request.

According to the foregoing design, the CPE is mainly used for large-packet service transmission. In addition, the CPE is mainly used in a static scenario, and has a relatively stable channel state. Therefore, frequency hopping and VRB-to-PRB interleave mapping may not be performed. In other words, the DCI parameter may not include the frequency hopping flag and the VRB-to-PRB mapping. This reduces signaling overheads.

For example, a DCI parameter corresponding to the CPE may alternatively include the frequency domain resource assignment, the time domain resource assignment, the frequency hopping flag, the VRB-to-PRB mapping, the PRB bundling size indicator, the MCS, the new data indicator, the redundancy version, the precoding and the number of layers, and the antenna port.

In addition, a channel state is relatively stable in a static scenario. Therefore, the DCI parameter may not include the SRS request and the CSI request. This can reduce complexity and signaling overheads, meet a communication requirement, and improve communication efficiency.

According to the foregoing embodiment, a DCI parameter included in DCI can be customized, and the DCI parameter included in the DCI can be customized based on the terminal type or the terminal device, to match a parameter requirement and a communication requirement of the terminal type, and optimally meet communication requirements of various devices. This reduces the signaling overheads and storage overheads, and improves spectral efficiency.

Further, a DCI parameter set corresponding to uplink communication may be further determined for the terminal type based on an uplink communication requirement of the terminal type, and/or a DCI parameter set corresponding to downlink communication may be further determined for the terminal type based on a downlink communication requirement of the terminal type.

Optionally, the terminal device and/or the network device may determine the DCI parameter based on the terminal type and a communication link. This embodiment of this application may be used as an independent embodiment, or may be combined with another embodiment of this application. This is not specifically limited in this application.

The communication link in this embodiment of this application may include one or more of the following: an uplink communication link, a downlink communication link, a duplex communication link, a backhaul communication link, a sidelink, an access link, a relay communication link, and the like. In descriptions in this embodiment of this application, an uplink and a downlink are used as an example for description.

Optionally, different communication links may correspond to different DCI. The communication link DCI may be DCI used to schedule data transmission of the communication link. For example, the communication link DCI may include one or more of the following: uplink DCI, downlink DCI, duplex DCI, backhaul DCI, sidelink DCI, access link DCI, and relay DCI.

For example, there is a correspondence between the terminal type, the communication link, and the DCI parameter. The correspondence may be predefined in a protocol, or may be notified by the network device to the terminal device by using higher layer signaling or physical layer signaling. This is not specifically limited in this application.

For example, the terminal type A may correspond to an uplink DCI parameter set AD1, and correspond to a downlink DCI parameter set AD2, the terminal type B may correspond to an uplink DCI parameter set BD1, and correspond to a downlink DCI parameter set BD2, ..., and the terminal type X may correspond to an uplink DCI parameter set XD1, and correspond to a downlink DCI parameter set XD2.

For example, when the terminal type is the eMBB, an uplink DCI parameter corresponding to the eMBB may include an identifier for DCI formats (uplink/downlink indicator), a carrier indicator, a BWP indicator, frequency domain resource assignment, time domain resource assignment, a frequency hopping flag, a VRB-to-PRB mapping, a PRB bundling size indicator, an MCS, a new data indicator, a redundancy version, a HARQ process number, HARQ timing, a TPC command, an uplink/supplementary uplink indicator, precoding and a number of layers, and an antenna port.

For example, a downlink DCI parameter corresponding to the eMBB may include an identifier for DCI formats (uplink/downlink indicator), a carrier indicator, a BWP indicator, frequency domain resource assignment, time domain resource assignment, a frequency hopping flag, a VRB-to-PRB mapping, a PRB bundling size indicator, an MCS, a new data indicator, a redundancy version, a HARQ process number, HARQ timing, a TPC command, an uplink/supplementary uplink indicator, precoding and a number of layers, an antenna port, an SRS request, a CSI request, and CBG transmission information.

For example, when the terminal type is the URLLC, an uplink DCI parameter corresponding to the URLLC may include frequency domain resource assignment, an MCS, a new data indicator, and a redundancy version.

For example, a downlink DCI parameter corresponding to the URLLC may include frequency domain resource assignment, an MCS, a new data indicator, a redundancy version, and a CSI request.

For example, when the terminal type is the IoT, an uplink DCI parameter corresponding to the IoT may include an MCS, a new data indicator, and a redundancy version.

For example, a downlink DCI parameter corresponding to the NB-IoT may include an MCS, a new data indicator, a redundancy version, and a CSI request.

For example, when the terminal type is the CPE, an uplink DCI parameter corresponding to the CPE may include frequency domain resource assignment, time domain resource assignment, a frequency hopping flag, a VRB-to-PRB mapping, a PRB bundling size indicator, an MCS, a new data indicator, a redundancy version, precoding and a number of layers, and an antenna port.

For example, a downlink DCI parameter corresponding to the CPE may include frequency domain resource assignment, time domain resource assignment, a frequency hopping flag, a VRB-to-PRB mapping, a PRB bundling size indicator, an MCS, a new data indicator, a redundancy version, precoding and a number of layers, an antenna port, an SRS request, and a CSI request.

According to the foregoing embodiment, DCI parameters included in the DCI of the different communication links can be customized, and the DCI parameters included in the DCI can be customized based on requirements of different communication links of the terminal type or the terminal device, to match the parameter requirement and a communication link requirement of the terminal type, and optimally meet communication link requirements of the various devices. This reduces the signaling overheads and the storage overheads, and improves spectral efficiency.

Specifically, a candidate set of a value of each DCI parameter corresponding to the terminal type may be further determined for the terminal type based on a communication requirement of the terminal type.

Optionally, the terminal device and/or the network device may determine the candidate set of the value of the DCI parameter based on the terminal type. This embodiment of this application may be used as an independent embodiment, or may be combined with another embodiment of this application. This is not specifically limited in this application.

For example, there is a correspondence between the terminal type and the candidate set of the value of the DCI Parameter. The correspondence may be predefined in a protocol, or may be notified by the network device to the terminal device by using higher layer signaling or physical layer signaling. This is not specifically limited in this application. Determining, for the terminal type based on the communication requirement of the terminal type, the candidate set of the value of each DCI parameter corresponding to the terminal type includes: determining, based on the terminal type, a quantity of bits corresponding to the candidate set of the value of the DCI parameter corresponding to the terminal type, and determining, based on the terminal type, at least one value in the candidate set of the value of the DCI parameter corresponding to the terminal type.

For example, the DCI parameter is the TPC command. A quantity of bits corresponding to a candidate set of a value of the TPC command corresponding to the terminal type and the candidate set of the value of the TPC command corresponding to the terminal type may be determined based on the terminal type.

Optionally, the terminal device and/or the network device may determine, based on the terminal type, the quantity of bits corresponding to the candidate set of the value of the TPC command and the candidate set of the value of the TPC command corresponding to the terminal type. This embodiment of this application may be used as an independent embodiment, or may be combined with another embodiment of this application. This is not specifically limited in this application.

For example, there is a correspondence between the terminal type, the quantity of bits corresponding to the candidate set of the value of the DCI parameter, and the candidate set of the value of the TPC command corresponding to the terminal type. The correspondence may be predefined in a protocol, or may be notified by the network device to the terminal device by using higher layer signaling or physical layer signaling. This is not specifically limited in this application.

For example, a quantity of bits corresponding to a candidate set of a value of a TPC command corresponding to the terminal type A is AT1, and the candidate set of the value of the TPC command corresponding to the terminal type A is a candidate set T1; a quantity of bits corresponding to a candidate set of a value of a TPC command corresponding to the terminal type B is AT2, and the candidate set of the value of the TPC command corresponding to the terminal type B is a candidate set T2; ...; a quantity of bits corresponding to a candidate set of a value of a TPC command corresponding to the terminal type X is ATX, and the candidate set of the value of the TPC command corresponding to the terminal type X is a candidate set TX.

The quantity of bits corresponding to the candidate set of the value of the TPC command may be at least 1 bit. When the quantity of bits corresponding to the candidate set of the value of the TPC command is 1 bit, the candidate set of the value of the TPC command may include a value 1 and a value 2. When the quantity of bits corresponding to the candidate set of the value of the TPC command is 2 bits, the candidate set of the value of the TPC command may include a value 1, a value 2, a value 3, and a value 4.

For example, when the terminal type is the eMBB, a quantity of bits corresponding to a candidate set of a value of a TPC command corresponding to the eMBB may be determined based on a communication requirement of the eMBB.

For example, the quantity of bits corresponding to the candidate set of the value of the TPC command corresponding to the eMBB may be 2 bits, and the candidate set of the value of the TPC command may include a value 1, a value 2, a value 3, and a value 4. When the TPC command is 00, it may indicate that the value of the TPC command is the value 1. When the TPC command is 01, it may indicate that the value of the TPC command is the value 2. When the TPC command is 10, it may indicate that the value of the TPC command is the value 3. When the TPC command is 11, it may indicate that the value of the TPC command is the value 4.

Further, a value in the candidate set of the value of the TPC command corresponding to the eMBB may be determined based on the communication requirement of the eMBB.

For example, when the TPC command indicates an accumulated value of δ_{PUSCH,b,f,c} or δ_{SRS,b,f,c}, the value 1 may be –1 dB, the value 2 may be 0 dB, the value 3 may be 1 dB, and the value 4 may be 3 dB.

For another example, when the TPC command indicates an absolute value of δ_{PUSCH,b,f,c} or δ_{SRS,b,f,c}, the value 1 may be –4 dB, the value 2 may be –1 dB, the value 3 may be 1 dB, and the value 4 may be 4 dB.

For example, when the terminal type is the URLLC, a quantity of bits corresponding to a candidate set of a value of a TPC command corresponding to the URLLC may be determined based on a communication requirement of the URLLC.

For example, the quantity of bits corresponding to the candidate set of the value of the TPC command corresponding to the URLLC may be 1 bit, and the candidate set of the value of the TPC command may include a value 1, and a value 2. When the TPC command is 0, it may indicate that the value of the TPC command is the value 1. When the TPC command is 1, it may indicate that the value of the TPC command is the value 2.

Further, a value in the candidate set of the value of the TPC command corresponding to the URLLC may be determined based on the communication requirement of the URLLC.

For example, when the TPC command indicates an accumulated value of δ_{PUSCH,b,f,c} or δ_{SRS,b,f,c}, the value 1 may be –1 dB, and the value 2 may be 0 dB.

For another example, when the TPC command indicates an absolute value of δ_{PUSCH,b,f,c} or δ_{SRS,b,f,c}, the value 1 may be –1 dB, and the value 2 may be 1 dB.

For example, when the terminal type is the NB-IoT, a quantity of bits corresponding to a candidate set of a value of a TPC command corresponding to the NB-IoT may be determined based on a communication requirement of the NB-IoT.

For example, the quantity of bits corresponding to the candidate set of the value of the TPC command corresponding to the NB-IoT may be 1 bit, and the candidate set of the value of the TPC command may include a value 1, and a value 2. When the TPC command is 0, it may indicate that the value of the TPC command is the value 1. When the TPC command is 1, it may indicate that the value of the TPC command is the value 2.

Further, a value in the candidate set of the value of the TPC command corresponding to the NB-IoT may be determined based on the communication requirement of the NB-IoT.

For example, when the TPC command indicates an accumulated value of δ_{PUSCH,b,f,c} or δ_{SRS,b,f,c}, the value 1 may be 0 dB, and the value 2 may be 1 dB.

For another example, when the TPC command indicates an absolute value of δ_{PUSCH,b,f,c} or δ_{SRS,b,f,c}, the value 1 may be 1 dB, and the value 2 may be 4 dB.

For example, when the terminal type is the CPE, a quantity of bits corresponding to a candidate set of a value of a TPC command corresponding to the CPE may be determined based on a communication requirement of the CPE.

For example, the quantity of bits corresponding to the candidate set of the value of the TPC command corresponding to the CPE may be 1 bit, and the candidate set of the value of the TPC command may include a value 1, and a value 2. When the TPC command is 0, it may indicate that the value of the TPC command is the value 1. When the TPC command is 1, it may indicate that the value of the TPC command is the value 2.

Further, a value in the candidate set of the value of the TPC command corresponding to the CPE may be determined based on the communication requirement of the CPE.

For example, when the TPC command indicates an accumulated value of δ_{PUSCH,b,f,c} or δ_{SRS,b,f,c}, the value 1 may be –1 dB, and the value 2 may be 0 dB.

For another example, when the TPC command indicates an absolute value of δ_{PUSCH,b,f,c} or δ_{SRS,b,f,c}, the value 1 may be –1 dB, and the value 2 may be 1 dB.

According to the foregoing embodiment, the candidate set of the value of the TPC command included in the DCI can be customized, and the candidate set of the value of the TPC command included in the DCI can be customized based on the terminal type or the terminal device, to match the parameter requirement and the communication requirement of the terminal type, and optimally meet the communication requirements of the various devices. This reduces the signaling overheads and the storage overheads, and improves spectral efficiency.

For example, the DCI parameter is the MCS. A quantity of bits corresponding to a candidate set of a value of the MCS corresponding to the terminal type and the candidate set of the value of the MCS corresponding to the terminal type may be determined based on the terminal type. For example, a quantity of bits corresponding to a candidate set of a value of an MCS corresponding to the terminal type A is AM1, and the candidate set of the value of the MCS corresponding to the terminal type A is a candidate set M1; a quantity of bits corresponding to a candidate set of a value of an MCS corresponding to the terminal type B is AM2, and the candidate set of the value of the MCS corresponding to the terminal type B is a candidate set M2; ...; a quantity of bits corresponding to a candidate set of a value of an MCS corresponding to the terminal type X is AMX, and the candidate set of the value of the MCS corresponding to the terminal type X is a candidate set MX.

The quantity of bits corresponding to the candidate set of the value of the MCS may be at least 1 bit. When the quantity of bits corresponding to the candidate set of the value of the MCS is 1 bit, the candidate set of the value of the MCS may include a value 1 and a value 2. When the quantity of bits corresponding to the candidate set of the value of the MCS is 2 bits, the candidate set of the value of the MCS may include a value 1, a value 2, a value 3, and a value 4. When the quantity of bits corresponding to the candidate set of the MCS value is 3 bits, the candidate set of the value of the MCS may include a value 1, a value 2, a value 3, a value 4, a value 5, a value 6, a value 7, and a value 8.

For example, when the terminal type is the eMBB, a quantity of bits corresponding to a candidate set of a value of an MCS corresponding to the eMBB may be determined based on a communication requirement of the eMBB.

For example, the quantity of bits corresponding to the candidate set of the value of the MCS corresponding to the eMBB may be 5 bits, and the candidate set of the value of the MCS may include a value 0, a value 1, ..., and a value 31. When the MCS is 00000, it may indicate that the value of the MCS is the value 0; when the MCS is 00001, it may indicate that the value of the MCS is the value 1; ...; or when the MCS is 11111, it may indicate that the value of the MCS is a value 31.

Further, a value in the candidate set of the value of the MCS corresponding to the eMBB may be determined based on the communication requirement of the eMBB.

For example, the candidate set of the value of the MCS may be one or more of Table 1 to table 3. Specifically, the candidate set of the value of the MCS may include one or more rows in table 1 to table 3.

TABLE 1

(PDSCH MCS index table 1)

| MCS | Modulation order | Target bit rate Rx [1024] | Spectral efficiency |
|---|---|---|---|
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 466 | 2.7305 |
| 19 | 6 | 517 | 3.0293 |
| 20 | 6 | 567 | 3.3223 |
| 21 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |
| 29 | 2 | Reserved | |
| 30 | 4 | Reserved | |
| 31 | 6 | Reserved | |

TABLE 2

(PDSCH MCS index table 2)

| MCS | Modulation order | Target bit rate Rx [1024] | Spectral efficiency |
|---|---|---|---|
| 0 | 2 | 120 | 0.2344 |
| 1 | 2 | 193 | 0.3770 |
| 2 | 2 | 308 | 0.6016 |
| 3 | 2 | 449 | 0.8770 |
| 4 | 2 | 602 | 1.1758 |
| 5 | 4 | 378 | 1.4766 |
| 6 | 4 | 434 | 1.6953 |
| 7 | 4 | 490 | 1.9141 |
| 8 | 4 | 553 | 2.1602 |
| 9 | 4 | 616 | 2.4063 |
| 10 | 4 | 658 | 2.5703 |
| 11 | 6 | 466 | 2.7305 |
| 12 | 6 | 517 | 3.0293 |
| 13 | 6 | 567 | 3.3223 |
| 14 | 6 | 616 | 3.6094 |
| 15 | 6 | 666 | 3.9023 |
| 16 | 6 | 719 | 4.2129 |
| 17 | 6 | 772 | 4.5234 |
| 18 | 6 | 822 | 4.8164 |
| 19 | 6 | 873 | 5.1152 |
| 20 | 8 | 682.5 | 5.3320 |
| 21 | 8 | 711 | 5.5547 |
| 22 | 8 | 754 | 5.8906 |
| 23 | 8 | 797 | 6.2266 |
| 24 | 8 | 841 | 6.5703 |
| 25 | 8 | 885 | 6.9141 |
| 26 | 8 | 916.5 | 7.1602 |
| 27 | 8 | 948 | 7.4063 |
| 28 | 2 | Reserved | |
| 29 | 4 | Reserved | |
| 30 | 6 | Reserved | |
| 31 | 8 | Reserved | |

TABLE 3

(PDSCH MCS index table 3)

| MCS | Modulation order | Target bit rate Rx [1024] | Spectral efficiency |
|---|---|---|---|
| 0 | 2 | 30 | 0.0586 |
| 1 | 2 | 40 | 0.0781 |
| 2 | 2 | 50 | 0.0977 |
| 3 | 2 | 64 | 0.1250 |
| 4 | 2 | 78 | 0.1523 |
| 5 | 2 | 99 | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 4 | 340 | 1.3281 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 6 | 438 | 2.5664 |
| 22 | 6 | 466 | 2.7305 |
| 23 | 6 | 517 | 3.0293 |
| 24 | 6 | 567 | 3.3223 |
| 25 | 6 | 616 | 3.6094 |
| 26 | 6 | 666 | 3.9023 |
| 27 | 6 | 719 | 4.2129 |
| 28 | 6 | 772 | 4.5234 |
| 29 | 2 | Reserved | |
| 30 | 4 | Reserved | |
| 31 | 6 | Reserved | |

For example, when the terminal type is the URLLC, a quantity of bits corresponding to a candidate set of a value of an MCS corresponding to the URLLC may be determined based on a communication requirement of the URLLC.

For example, the quantity of bits corresponding to the candidate set of the value of the MCS corresponding to the URLLC may be 3 bits, and the candidate set of the value of the MCS may include a value 0, a value 1, ..., and a value 7. When the MCS is 000, it may indicate that the value of the MCS is the value 0; when the MCS is 001, it may indicate that the value of the MCS is the value 1; ...; or when the MCS is 111, it may indicate that the value of the MCS is a value 7.

Further, a value in the candidate set of the value of the MCS corresponding to the URLLC may be determined based on the communication requirement of the URLLC.

For example, the candidate set of the value of the MCS may be table 4.

TABLE 4

| MCS | Modulation order | Target bit rate Rx [1024] | Spectral efficiency |
|---|---|---|---|
| 0 | 2 | 78 | 0.1523 |
| 1 | 2 | 120 | 0.2344 |
| 2 | 2 | 193 | 0.3770 |
| 3 | 2 | 251 | 0.4902 |
| 4 | 4 | 340 | 1.3281 |
| 5 | 4 | 378 | 1.4766 |
| 6 | 6 | 438 | 2.5664 |
| 7 | 6 | 466 | 2.7305 |

For example, when the terminal type is the NB-IoT, a quantity of bits corresponding to a candidate set of a value of an MCS corresponding to the NB-IoT may be determined based on a communication requirement of the NB-IoT.

For example, the quantity of bits corresponding to the candidate set of the value of the MCS corresponding to the NB-IoT may be 2 bits, and the candidate set of the value of the MCS may include a value 0, a value 1, a value 2, and a value 3. When the MCS is 00, it may indicate that the value of the MCS is the value 0. When the MCS is 01, it may indicate that the value of the MCS is the value 1. When the MCS is 10, it may indicate that the value of the MCS is the value 2. When the MCS is 11, it may indicate that the value of the MCS is the value 3.

Further, a value in the candidate set of the value of the MCS corresponding to the NB-IoT may be determined based on the communication requirement of the NB-IoT.

For example, the candidate set of the value of the MCS may be table 5.

TABLE 5

| MCS | Modulation order | Target bit rate Rx [1024] | Spectral efficiency |
|---|---|---|---|
| 0 | 2 | 120 | 0.2344 |
| 1 | 2 | 193 | 0.3770 |
| 2 | 2 | 308 | 0.6016 |
| 3 | 2 | 449 | 0.8770 |

It should be noted that, when being 2 bits or 3 bits, the quantity of bits corresponding to the candidate set of the value of the MCS may correspond to a specific value of the MCS, and the candidate set of the value of the MCS is applicable to a scenario in which a channel and interference are relatively stable, for example, artificial intelligence training (AI training) or a factory scenario.

According to the foregoing embodiment, the candidate set of the value of the MCS included in the DCI can be customized, and the candidate set of the value of the MCS included in the DCI can be customized based on the terminal type or the terminal device, to match the parameter requirement and the communication requirement of the terminal type, and optimally meet the communication requirements of the various devices. This reduces the signaling overheads and the storage overheads, and improves spectral efficiency.

Optionally, for the specific value of the MCS, the network device sends an uplink specific value of the MCS to the terminal device, and the terminal device sends a downlink specific value of the MCS to the network device, or the network device sends an uplink specific value of the MCS and a downlink specific value of the MCS to the terminal device.

It should be noted that, in addition to the foregoing DCI parameter described by using the example, a candidate set of a value of another DCI parameter corresponding to the terminal type and a quantity of bits corresponding to the candidate set of the value of the DCI parameter may be determined based on the terminal type.

Based on the foregoing correspondence between the terminal type and the DCI parameter and the correspondence between the terminal type and the candidate set of the value of the DCI parameter, corresponding to each DCI parameter corresponding to the terminal device, the network device and/or the terminal device may determine, in one or more of Manners 1 to 4, the DCI parameter corresponding to the terminal type and the candidate set of the value of the DCI parameter.

Manner 1: The DCI parameter corresponding to the terminal type and the candidate set of the value of the DCI parameter are pre-specified in a communication protocol.

An RRC parameter corresponding to the terminal type, each DCI parameter corresponding to the terminal type, and the candidate set of the value of the DCI parameter may be determined for the terminal type by using a training model, for example, machine learning or a neural network. Alternatively, the DCI parameter corresponding to the terminal type and the candidate set of the value of each DCI parameter corresponding to the terminal type may be determined based on a value of a DCI parameter configured by the network device for each terminal device within a period of time based on a communication requirement of each terminal device. Alternatively, the DCI parameter corresponding to the terminal type and the candidate set of the value of each DCI parameter corresponding to the terminal type may be determined based on communication experience.

For example, communication quality of the terminal device with different DCI parameter combinations and/or different candidate sets of the value of the DCI parameter may be determined by using a training model, for example, machine learning or a neural network, and the DCI parameter corresponding to the terminal type and the candidate set of the value of each DCI parameter corresponding to the terminal type may be determined based on the communication quality.

For another example, the terminal type A includes a terminal device 1, a terminal device 2, and a terminal device 3. A DCI parameter corresponding to the terminal type A and a candidate set of a value of each DCI parameter corresponding to the terminal type may be determined based on values of DCI parameters configured by the network device for the terminal device 1, the terminal device 2, and the terminal device 3 within a period of time.

Specifically, a DCI parameter corresponding to each terminal type and a candidate set of a value of the DCI parameter may be written to the communication protocol, so that the network device and the terminal device determine, according to the communication protocol, the DCI parameter corresponding to the terminal type of the terminal device and the candidate set of the value of the DCI parameter. This prevents the network device from sending the DCI parameter corresponding to the terminal type and the candidate set of the value of the DCI parameter to the terminal device, reduces the signaling overheads, communication latency, and power consumption of the terminal.

Manner 2: The network device sends indication information to the terminal device.

The indication information may be used to indicate the DCI parameter corresponding to the terminal type and the candidate set of the value of the DCI parameter.

In a random access process or when the terminal device initially accesses a network, the network device may determine, based on the terminal type of the terminal device, the DCI parameter corresponding to the terminal type and the candidate set of the value of the DCI parameter, and deliver the DCI parameter corresponding to the terminal type and the candidate set of the value of the DCI parameter to the terminal device.

Alternatively, the network device may send the DCI parameter and the candidate set of the value of the DCI parameter by using higher layer signaling or physical layer signaling, and the terminal device determines the DCI parameter and the candidate set of the value of the DCI parameter according to an indication of the network device.

According to the foregoing solution, the network device can configure the DCI parameter and the candidate set of the value of the DCI parameter. This implements configuration flexibility of the DCI parameter and the candidate set of the value of the DCI parameter, better adapts to different scenarios, meets requirements of the different scenarios, reduces value indication overheads, and improves communication efficiency.

Specifically, the network device may determine, by using the method shown in Manner 1, the DCI parameter corresponding to the terminal type and the candidate set of the value of the DCI parameter. Details are not described again.

For example, the DCI parameter includes the TPC command. In a random access process or when the terminal device initially accesses a network, the network device may determine, based on the terminal type of the terminal device, the quantity of bits corresponding to the candidate set of the value of the TPC command corresponding to the terminal type and a value of the TPC command in the candidate set, and send the quantity of bits and the value to the terminal device.

For example, the DCI parameter includes the MSC. In a random access process or when the terminal device initially accesses a network, the network device may determine, based on the terminal type of the terminal device, the quantity of bits corresponding to the candidate set of the value of the MSC corresponding to the terminal type and a value of the MSC in the candidate set, and send the quantity of bits and the value to the terminal device.

Manner 3: The terminal device sends second request information to the network device, and the network device sends, to the terminal device based on the second request information, the DCI parameter corresponding to the terminal type and the candidate set of the value of the DCI parameter.

The second request information is used to request the DCI parameter corresponding to the terminal type of the terminal device and the candidate set of the value of the DCI parameter.

Optionally, the second request information includes a DCI parameter corresponding to the terminal type and a candidate set of a value of the DCI parameter that are determined by the terminal device.

Specifically, the terminal device may determine, based on a communication requirement of the terminal device, the DCI parameter and the candidate set of the value of the DCI parameter that are suitable for the terminal device to perform communication, and send the DCI parameter and the candidate set of the value of the DCI parameter to the network device. After receiving the DCI parameter and the candidate set of the value of the DCI parameter that are sent by the terminal device, the network device determines whether the terminal device can use the DCI parameter and the candidate set of the value of the DCI parameter. If yes, the network device sends the DCI parameter and the candidate set of the value of the DCI parameter to the terminal device as the DCI parameter corresponding to the terminal type and the candidate set of the value of the DCI parameter. If no, the network device may determine, based on the terminal type of the terminal device, the DCI parameter corresponding to the terminal type and the candidate set of the value of the DCI parameter, and send the DCI parameter and the candidate set of the value of the DCI parameter to the terminal device.

Both the network terminal and the terminal device may determine, by using the method shown in Manner 1, the DCI parameter corresponding to the terminal type and the candidate set of the value of the DCI parameter. Details are not described again.

For example, the DCI parameter includes the TPC command. The terminal device may send, to the network device, a quantity of bits corresponding to the candidate set of the value of the TPC command and a value of the TPC command in the candidate set that are determined by the terminal device. The network device determines, based on the quantity of bits corresponding to the candidate set of the value of the TPC command and the value of the TPC command in the candidate set that are sent by the terminal device, whether the terminal device can use the quantity of bits corresponding to the candidate set of the value of the TPC command and the value of the TPC command in the candidate set. If yes, the network device sends the quantity of bits corresponding to the candidate set of the value of the TPC command and the value of the TPC command in the candidate set to the terminal device as the quantity of bits corresponding to the candidate set of the value of the TPC command corresponding to the terminal type and a value of the TPC command in the candidate set. If no, the network device may determine, based on the terminal type of the terminal device, the quantity of bits corresponding to the candidate set of the value of the TPC command corresponding to the terminal type and a value of the TPC command in the candidate set, and send the quantity of bits corresponding to the candidate set of the value of the TPC command and the value of the TPC command in the candidate set to the terminal device.

For example, the DCI parameter includes the MCS. The terminal device may send, to the network device, a quantity of bits corresponding to the candidate set of the value of the MCS and a value of the MCS in the candidate set that are determined by the terminal device. The network device determines, based on the quantity of bits corresponding to the candidate set of the value of the MCS and the value of the MCS in the candidate set that are sent by the terminal device, whether the terminal device can use the quantity of bits corresponding to the candidate set of the value of the MCS and the value of the MCS in the candidate set. If yes, the network device sends the quantity of bits corresponding to the candidate set of the value of the MCS and the value of the MCS in the candidate set to the terminal device as the quantity of bits corresponding to the candidate set of the value of the MCS corresponding to the terminal type and a value of the MCS in the candidate set. If no, the network device may determine, based on the terminal type of the terminal device, the quantity of bits corresponding to the candidate set of the value of the MCS corresponding to the terminal type and a value of the MCS in the candidate set, and send the quantity of bits corresponding to the candidate set of the value of the MCS and the value of the MCS in the candidate set to the terminal device.

According to the foregoing solution, the terminal device can send the recommended DCI parameter and candidate set of the value of the DCI parameter to the network device. This implements configuration flexibility of the DCI parameter and the candidate set of the value of the DCI parameter, better meets a communication requirement of the terminal device, better adapts to different scenarios, meets requirements of the different scenarios, reduces value indication overheads, and improves communication efficiency.

Manner 4: The terminal device sends second feature information to the network device, and the network device sends, to the terminal device based on the second feature information, the DCI parameter corresponding to the terminal type and the candidate set of the value of the DCI parameter.

The second feature information may be used to indicate the terminal type of the terminal device.

Optionally, the second feature information may be the terminal type of the terminal device, or may be a communication requirement used to indicate the terminal type of the terminal device. The communication requirement may be one or more of a service type, mobility, a transmission latency requirement, a channel environment, a reliability requirement, a coverage requirement, and a communication scenario.

Specifically, the network device may determine the terminal type of the terminal device based on the second feature information sent by the terminal device, determine the DCI parameter corresponding to the terminal type and the candidate set of the value of the DCI parameter, and send the DCI parameter and the candidate set of the value of the DCI parameter to the terminal device.

For example, the DCI parameter includes the TPC command. The terminal device may send the second feature information to the network device. The network device determines the terminal type of the terminal device based on the second feature information, determines the quantity of bits corresponding to the candidate set of the value of the TPC command corresponding to the terminal type and a value of the TPC command in the candidate set, and sends the quantity of bits corresponding to the candidate set of the value of the TPC command and the value of the TPC command in the candidate set to the terminal device.

For example, the DCI parameter includes the MCS. The terminal device may send the second feature information to the network device. The network device determines the terminal type of the terminal device based on the second feature information, determines the quantity of bits corresponding to the candidate set of the value of the MCS corresponding to the terminal type and a value of the MCS in the candidate set, and sends the quantity of bits corresponding to the candidate set of the value of the MCS and the value of the MCS in the candidate set to the terminal device.

According to the foregoing solution, the terminal device can send the second feature information to the network device, and the DCI parameter and the candidate set of the value of the DCI parameter can be determined by using the second feature information. This implements configuration flexibility of the DCI parameter and the candidate set of the value of the DCI parameter, better meets a communication requirement of the terminal device, better adapts to different scenarios, meets requirements of the different scenarios, reduces value indication overheads, and improves communication efficiency.

Based on the foregoing correspondence between the terminal type and the DCI parameter and the correspondence between the terminal type and the candidate set of the value of the DCI parameter, the candidate set of the value of the DCI parameter corresponding to the terminal type may be determined for the terminal type, and the first DCI corresponding to the terminal type may be determined based on the candidate set of the value of the DCI parameter corresponding to the terminal type. This embodiment of this application may be used as an independent embodiment, or may be combined with another embodiment of this application. This is not specifically limited in this application.

For example, when the terminal type is the eMBB, the first DCI may include the MCS parameter and the HARQ process number. A quantity of bits corresponding to a candidate set of a value of the MCS parameter is 5, and a quantity of bits corresponding to a candidate set of a value of the HARQ process number is 4.

For example, when the terminal type is the URLLC, the first DCI may include the MCS parameter, the HARQ process number, the SRS request, and the CSI request. A quantity of bits corresponding to a candidate set of a value of the MCS parameter is 2 or 3. A quantity of bits corresponding to a candidate set of a value of the HARQ process number is 1. A quantity of bits corresponding to a candidate set of a value of the SRS request is 1. A quantity of bits corresponding to a candidate set of a value of the CSI request is 1.

According to the foregoing design, the URLLC is mainly used for small-packet service transmission. In addition, the URLLC is mainly used in the static scenario or the scenario of moving along a fixed path, and has the relatively stable channel state. Therefore, the candidate set of the value of the MCS parameter may include four or eight values, that is, the corresponding quantity of bits is 2 or 3. Compared with a case in which the quantity of bits is 5, this can reduce the signaling overheads. In addition, to meet a requirement for low latency and high reliability, the URLLC may generally use low-rate transmission, and therefore, may use only a single antenna port to perform rank-1 transmission. This reduces power consumption and the signaling overheads, and improves communication efficiency. In other words, the DCI parameter may not include the precoding information and the number of layers and the antenna port. This reduces the signaling overheads. In addition, in the scenario of the URLLC of the type, for example, the robotic arm, beam management may be performed to implement beam alignment, location prediction, and preparation for data transmission. Therefore, the DCI parameter may include the SRS request and the CSI request. In addition, a measurement case is simple, and only a 1-bit SRS request and a 1-bit CSI request may be configured. Compared with a case in which the eMBB has more SRS or CSI configurations, this can reduce the signaling overheads and improve communication efficiency. In addition, data packets of the URLLC are mainly small packets. Therefore, a small quantity of HARQ process numbers may be used, and when the HARQ process number is indicated, this reduces the signaling overheads and improves communication efficiency.

For example, when the terminal type is the IoT, the first DCI may include the MCS parameter and the HARQ process number. A quantity of bits corresponding to a candidate set of a value of the MCS parameter is 2 or 3, and a quantity of bits corresponding to a candidate set of a value of the HARQ process number parameter is 1 or 2.

According to the foregoing design, because an application scenario of the IoT may be small-packet data transmission and is the static scenario, the candidate set of the value of the MCS parameter may include four or eight values, that is, the corresponding quantity of bits is 2 or 3. Compared with a case in which the quantity of bits is 5, this reduces the signaling overheads. In addition, data packets of the URLLC are mainly small packets. Therefore, a small quantity of HARQ process numbers may be used, and when the HARQ process number is indicated, this reduces the signaling overheads and improves communication efficiency.

For example, when the terminal type is the CPE, the first DCI may include the MCS parameter and the HARQ process number. A quantity of bits corresponding to a candidate set of a value of the MCS parameter is 2, 3, 4, or 5, and a quantity of bits corresponding to a candidate set of a value of the HARQ process number parameter is 4.

According to the foregoing design, the CPE is mainly used for large-packet service transmission. In addition, the CPE is mainly used in the static scenario, and has the relatively stable channel state. Therefore, the candidate set of the value of the MCS parameter may include four or eight values, that is, the corresponding quantity of bits is 2 or 3. Compared with a case in which the quantity of bits is 5, this can reduce the signaling overheads. In addition, a quantity of values in the candidate set of the value of the MCS parameter may be flexibly configured, to be applicable to different communication scenarios. This meets different communication requirements, and reduces the signaling overheads. In addition, data packets of the CPE are mainly large packets. Therefore, a large quantity of HARQ process numbers may be used. This improves communication efficiency.

According to the foregoing solution, the DCI parameter and the candidate set of the value of the DCI parameter can be determined based on the terminal type. This implements configuration flexibility of the DCI parameter and the candidate set of the value of the DCI parameter, better meets the communication requirement of the terminal device, better adapts to the different scenarios, meets the requirements of the different scenarios, reduces the value indication overheads, and improves communication efficiency.

Step 502: The terminal device performs communication based on the first DCI.

Specifically, the terminal device may determine the value of each DCI parameter in the first DCI based on the candidate set of the value of the DCI parameter corresponding to the terminal type of the terminal device and the first DCI, and perform communication based on the value of each DCI parameter in the first DCI.

Optionally, when the candidate set of the value of the DCI parameter includes one value, for example, a candidate set of a value of a first DCI parameter includes only a first value of the first DCI parameter, the network device may not send the first DCI parameter to the terminal device. In this case, the terminal device and the network device may determine that the value of the first DCI parameter is the first value.

Optionally, when the candidate set of the value of the DCI parameter includes a plurality of values, for example, a candidate set of a value of a first DCI parameter includes a first value and the second value, the network device may not send the first value to the terminal device. In this case, the terminal device and the network device may determine that the value of the first DCI parameter is a default value. The default value includes a value of the first DCI parameter corresponding to the terminal type in the candidate set of the value of the first DCI parameter. To be specific, when the network device does not indicate the value of the first DCI parameter to the terminal device, the value of the first DCI parameter is the default value. When the terminal device does not receive the value of the first DCI parameter indicated by the network device, the value of the first DCI parameter is the default value.

Further, the default value of the first DCI parameter may be predefined in a protocol, or may be notified by the network device to the terminal device by using higher layer signaling or physical layer signaling.

In the foregoing manner, when the value of the first DCI parameter is the default value, the signaling overheads can be reduced, and communication performance can be improved.

In this embodiment of this application, the DCI parameter included in the DCI corresponding to the terminal type and the candidate set of the value of the DCI parameter are determined based on the terminal type, so that the network device can determine the DCI parameter for the terminal device from the candidate set of value of the DCI parameter. This reduces the signaling overheads, reduces storage overheads of the terminal device, meets the communication requirements of the different terminal types, and reduces power consumption of the terminal device.

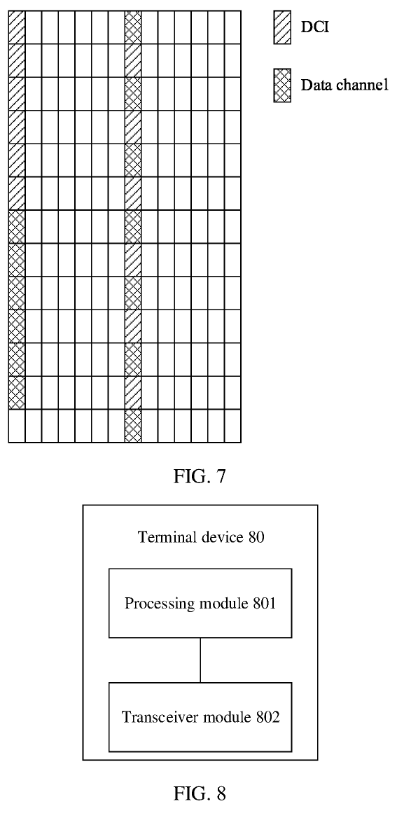

For example, as shown in FIG. 7, the first DCI may be on a same symbol as a data channel, that is, transmitted on a single symbol. This embodiment of this application may be used as an independent embodiment, or may be combined with another embodiment of this application. This is not specifically limited in this application.

Optionally, a DMRS of a control channel and a DMRS of the data channel may be shared.

Optionally, there is a correspondence between a frequency domain location of the control channel and a frequency domain location of the data channel.

For example, a relationship between the frequency domain location of the data channel and the frequency domain location of the control channel may be predefined. This reduces indication overheads of the frequency domain location of the data channel and improves communication efficiency.

For example, the frequency domain location of the data channel may be determined by indicating an offset between the frequency domain location of the data channel and the frequency domain location of the control channel. This reduces indication overheads of the frequency domain location of the data channel and improves communication efficiency.

In this embodiment of this application, pilot overheads can be reduced by using the shared DMRS for demodulation. For example, when a configuration 1 is used, the pilot overheads can be increased by 50%, and when a configuration 2 is used, the pilot overheads can be increased by 33%. In addition, a frequency domain location of the DCI may be determined in a manner of frequency domain location indication or a manner of fixed location, for example, in a frequency domain interleaving/non-interleaving manner. In addition, no time domain location indication is required. This can quickly implement scheduling and transmission of small data and reduce the communication latency.

According to the method shown in FIG. 5a, the DCI parameter corresponding to the terminal type and the candidate set of the value of the DCI parameter are determined based on the terminal type, and the first DCI corresponding to the terminal device is determined based on the candidate set of the value of the DCI parameter. This can reduce signaling overheads of the DCI, improve spectral efficiency of a communication system, and reduce power consumption of the terminal device.

Based on the method shown in FIG. 5a, alternatively, as shown in FIG. 5b, the communication method provided in embodiments of this application may be described from a perspective of a first communication apparatus.

FIG. 5b is a flowchart of a communication method according to an embodiment of this application. As shown in FIG. 5b, the method may include the following steps.

Step 501a: The first communication apparatus determines a DCI parameter corresponding to a terminal type of the first communication apparatus and a candidate set of a value of the DCI parameter.

Specifically, for specific descriptions of determining, by the first communication apparatus, the DCI parameter corresponding to the terminal type of the first communication apparatus and the candidate set of the value of the DCI parameter, refer to the specific descriptions of determining, by the terminal device, the DCI parameter corresponding to the terminal type of the terminal device and the candidate set of the value of the DCI parameter in step 501. Details are not described again.

It should be noted that the step may be omitted.

Step 502a: The first communication apparatus sends second request information and/or second feature information.

Specifically, for specific descriptions of sending the second request information and/or the second feature information by the first communication apparatus, refer to the specific descriptions of sending the second request information and/or the second feature information by the terminal device in step 501. Details are not described again.

It should be noted that the step may be omitted.

Step 503a: The first communication apparatus receives a DCI parameter corresponding to the terminal type and a candidate set of a value of the DCI parameter.

Specifically, for specific descriptions of receiving, by the first communication apparatus, the DCI parameter corresponding to the terminal type and the candidate set of the value of the DCI parameter, refer to the related descriptions of receiving, by the terminal device, the DCI parameter corresponding to the terminal type and the candidate set of the value of the DCI parameter in step 501. Details are not described again.

Step 504a: The first communication apparatus receives first DCI.

Specifically, for specific descriptions of receiving the first DCI by the first communication apparatus, refer to the related descriptions of receiving the first DCI by the terminal device in step 501. Details are not described again.

Step 505a: The first communication apparatus performs communication based on the first DCI.

Specifically, for specific descriptions of performing communication by the first communication apparatus based on the first DCI, refer to the related descriptions of performing communication by the terminal device based on the first DCI in step 502. Details are not described again.

Based on the methods shown in FIG. 5a and FIG. 5b, alternatively, as shown in FIG. 5c, the communication method provided in embodiments of this application may be described from a perspective of a second communication apparatus.

FIG. 5c is a flowchart of a communication method according to an embodiment of this application. As shown in FIG. 5c, the method may include the following steps.

Step 501b: The second communication apparatus receives the second request information and/or the first second information.

Specifically, for specific descriptions of receiving the second request information and/or the second feature information by the second communication apparatus, refer to the specific descriptions of receiving the second request information and/or the second feature information by the network device in step 501. Details are not described again.

It should be noted that the step may be omitted.

Step 502b: The second communication apparatus determines the DCI parameter corresponding to the terminal type and the candidate set of the value of the DCI parameter.

Specifically, for specific descriptions of determining, by the second communication apparatus, the DCI parameter corresponding to the terminal type and the candidate set of the value of the DCI parameter, refer to the specific descriptions of determining, by the network device, the DCI parameter corresponding to the terminal type and the candidate set of the value of the DCI parameter in step 501. Details are not described again.

Step 503b: The second communication apparatus sends the DCI parameter corresponding to the terminal type and the candidate set of the value of the DCI parameter.

Specifically, for specific descriptions of sending, by the second communication apparatus, the DCI parameter corresponding to the terminal type and the candidate set of the value of the DCI parameter, refer to the specific descriptions of sending, by the network device, the DCI parameter corresponding to the terminal type and the candidate set of the value of the DCI parameter in step 501. Details are not described again.

Step 504b: The second communication apparatus sends the first DCI.

Specifically, for specific descriptions of sending the first DCI by the second communication apparatus, refer to the specific descriptions of sending the first DCI by the network device in step 501. Details are not described again.

This embodiment of this application may be used as an independent embodiment, or may be combined with another embodiment of this application. This is not specifically limited in this application.

According to the communication method shown in FIG. 5a, in this embodiment of this application, a DCI format corresponding to the terminal type may be further determined based on the DCI parameter corresponding to the terminal type and the candidate set of the value of the DCI parameter. This embodiment of this application may be used as an independent embodiment, or may be combined with another embodiment of this application. This is not specifically limited in this application.

For example, for a terminal type 1, a DCI format F1 corresponding to the terminal type 1 may be determined based on a DCI parameter corresponding to the terminal type 1 and a candidate set of a value of the DCI parameter; for a terminal type 2, a DCI format F2 corresponding to the terminal type 1 may be determined based on a DCI parameter corresponding to the terminal type 2 and a candidate set of a value of the DCI parameter; ...; and for the terminal type X, a DCI format FX corresponding to the terminal type 1 may be determined based on a DCI parameter corresponding to the terminal type 1 and a candidate set of a value of the DCI parameter.

Further, corresponding to uplink communication and downlink communication, a corresponding uplink DCI format and a corresponding downlink DCI format may be determined for the terminal type. For example, for the terminal type 1, an uplink DCI format UF1 corresponding to the terminal type 1 may be determined based on a DCI parameter corresponding to the terminal type 1 during uplink communication and a candidate set of a value of the DCI parameter, and an uplink DCI format DF1 corresponding to the terminal type 1 may be determined based on a DCI parameter corresponding to the terminal type 1 during downlink communication and a candidate set of a value of the DCI parameter; for the terminal type 2, an uplink DCI format UF2 corresponding to the terminal type 1 may be determined based on a DCI parameter corresponding to the terminal type 2 during uplink communication and a candidate set of a value of the DCI parameter, and an uplink DCI format DF2 corresponding to the terminal type 2 may be determined based on a DCI parameter corresponding to the terminal type 2 during downlink communication and a candidate set of a value of the DCI parameter; ...; and for the terminal type X, an uplink DCI format UF1 corresponding to the terminal type X may be determined based on a DCI parameter corresponding to the terminal type X during uplink communication and a candidate set of a value of the DCI parameter, and an uplink DCI format DFX corresponding to the terminal type X may be determined based on a DCI parameter corresponding to the terminal type X during downlink communication and a candidate set of a value of the DCI parameter.

The terminal type 1, the terminal type 2, ..., and the terminal type X may be at least one of the foregoing terminal types, such as the eMBB, the URLLC, the IoT, the CPE, a V2X, an AR/VR, and the like.

Optionally, in this embodiment of this application, the DCI format may be further determined based on the terminal type, and a DCI parameter corresponding to the DCI and a candidate set of a value of the DCI parameter may be further determined based on the DCI format. This embodiment of this application may be used as an independent embodiment, or may be combined with another embodiment of this application. This is not specifically limited in this application.

Optionally, the terminal type and/or the network device may determine the DCI format based on the terminal type, and determine, based on the DCI format, the DCI parameter corresponding to the DCI and the candidate set of the value of the DCI parameter.

Optionally, there is a correspondence between the terminal type and the DCI format. The correspondence may be predefined in a protocol, or may be notified by the network device to the terminal device by using higher layer signaling or physical layer signaling. This is not specifically limited in this application.

Optionally, there is a correspondence between the DCI format, the DCI parameter, and the candidate set of the value of the DCI parameter. The correspondence may be predefined in a protocol, or may be notified by the network device to the terminal device by using higher layer signaling or physical layer signaling. This is not specifically limited in this application.

For example, for the terminal type 1, the DCI format F1 corresponding to the terminal type 1 may be determined based on the terminal type 1, and a DCI parameter corresponding to DCI and a candidate set of a value of the DCI parameter may be determined based on the DCI format F1; for the terminal type 2, the DCI format F2 corresponding to the terminal type 1 may be determined based on the terminal type 2, and a DCI parameter corresponding to DCI and a candidate set of a value of the DCI parameter may be determined based on the DCI format F2; ...; and for the terminal type X, the DCI format FX corresponding to the terminal type X may be determined based on the terminal type X, and a DCI parameter corresponding to DCI and a candidate set of a value of the DCI parameter may be determined based on the DCI format FX.

Further, corresponding to uplink communication and downlink communication, the corresponding uplink DCI format and the corresponding downlink DCI format may be determined for the terminal type.

Optionally, in this embodiment of this application, the DCI format may be further determined based on the terminal type and the communication link, and the DCI parameter corresponding to the DCI and the candidate set of the value of the DCI parameter may be further determined based on the DCI format. This embodiment of this application may be used as an independent embodiment, or may be combined with another embodiment of this application. This is not specifically limited in this application.

Optionally, the terminal type and/or the network device may determine the DCI format based on the terminal type and the communication link, and determine, based on the DCI format, the DCI parameter corresponding to the DCI and the candidate set of the value of the DCI parameter.

Optionally, there is a correspondence between the terminal type, the communication link, and the DCI format. The correspondence may be predefined in a protocol, or may be notified by the network device to the terminal device by using higher layer signaling or physical layer signaling. This is not specifically limited in this application.

Optionally, there is the correspondence between the DCI format, the DCI parameter, and the candidate set of the value of the DCI parameter. The correspondence may be predefined in the protocol, or may be notified by the network device to the terminal device by using the higher layer signaling or the physical layer signaling. This is not specifically limited in this application.

For example, for the terminal type 1, the uplink DCI format UF1 corresponding to the terminal type 1 may be determined based on the terminal type 1, a DCI parameter corresponding to DCI during uplink communication and a candidate set of a value of the DCI parameter may be determined based on the uplink DCI format UF1, the downlink DCI format DF1 corresponding to the terminal type 1 may be determined based on the terminal type 1, and a DCI parameter corresponding to DCI during downlink communication and a candidate set of a value of the DCI parameter may be determined based on the downlink DCI format DF1; for the terminal type 2, the uplink DCI format UF2 corresponding to the terminal type 2 may be determined based on the terminal type 2, a DCI parameter corresponding to DCI during uplink communication and a candidate set of a value of the DCI parameter may be determined based on the uplink DCI format UF2, the downlink DCI format DF2 corresponding to the terminal type 2 may be determined based on the terminal type 2, and a DCI parameter corresponding to DCI during downlink communication and a candidate set of a value of the DCI parameter may be determined based on the downlink DCI format DF2; ...; and for the terminal type X, the uplink DCI format UF1 corresponding to the terminal type X may be determined based on the terminal type X, a DCI parameter corresponding to DCI during uplink communication and a candidate set of a value of the DCI parameter may be determined based on the uplink DCI format UF1, the downlink DCI format DFX corresponding to the terminal type X may be determined based on the terminal type X, and a DCI parameter corresponding to DCI during downlink communication and a candidate set of a value of the DCI parameter may be determined based on the downlink DCI format DFX.

The terminal type 1, the terminal type 2, ..., and the terminal type X may be at least one of the foregoing terminal types, such as the eMBB, the URLLC, the IoT, the CPE, the V2X, the AR/VR, and the like.

For example, when the terminal type is the eMBB, a DCI format corresponding to the eMBB may be a format 1. A DCI parameter corresponding to the format 1 and a candidate set of a value of the DCI parameter are as follows: A quantity of bits corresponding to a candidate set of a value of an MCS parameter is 5, and a quantity of bits corresponding to a candidate set of a value of a HARQ process number parameter is 4.

For example, when the terminal type is the URLLC, a DCI format corresponding to the URLLC may be a format 2. A DCI parameter corresponding to the format 2 and a candidate set of a value of the DCI parameter are as follows: A quantity of bits corresponding to a candidate set of a value of an MCS parameter is 2 or 3, a quantity of bits corresponding to a candidate set of a value of a HARQ process number parameter is 1, a quantity of bits corresponding to a candidate set of a value of an SRS request parameter is 1, and a quantity of bits corresponding to a candidate set of a value of a CSI request parameter is 1.

For example, when the terminal type is the IoT, a DCI format corresponding to the IoT may be a format 3. A DCI parameter corresponding to the format 3 and a candidate set of a value of the DCI parameter are as follows: A quantity of bits corresponding to a candidate set of a value of an MCS parameter is 2 or 3, and a quantity of bits corresponding to a candidate set of a value of a HARQ process number parameter is 1 or 2.

For example, when the terminal type is the CPE, a DCI format corresponding to the IoT may be a format 4. A DCI parameter corresponding to the format 4 and a candidate set of a value of the DCI parameter are as follows: A quantity of bits corresponding to a candidate set of a value of an MCS parameter is 2, 3, 4, or 5, and a quantity of bits corresponding to a candidate set of a value of a HARQ process number parameter is 4.

Further, the network device may send, to the terminal device, the DCI format corresponding to the terminal type of the terminal device, so that the terminal device receives, based on the DCI format corresponding to the terminal type of the terminal device, the DCI sent by the network device.

Further, the terminal device may further determine, based on the DCI format sent by the network device and the correspondence between the DCI format and the candidate set of the value of the DCI parameter, the candidate set of the value of the DCI parameter in the DCI format sent by the network device, and parse the DCI based on the candidate set of the value of the DCI parameter and the DCI sent by the network device.

For example, a DCI format corresponding to the terminal device 1 is a first DCI format. The network device may send the first DCI format to the terminal device, so that the terminal device receives, based on the first DCI format, first DCI sent by the network device, determines a candidate set of a value of a DCI parameter in first DCI based on the first DCI format and a correspondence between the DCI format and the candidate set of the value of the DCI parameter, determines a value of each DCI parameter in the first DCI based on the candidate set of the value of the DCI parameter in the first DCI and the first DCI, and performs communication based on the value of each DCI parameter in the first DCI.

According to the foregoing method, the network device determines, based on the terminal type, the DCI format corresponding to the terminal type, so that the terminal device receives the DCI based on the DCI format sent by the network device. This improves a success rate of receiving the DCI by the terminal device, helps the terminal device parse the received DCI based on the correspondence between the DCI format and the candidate set of the value of the DCI parameter, meets the communication requirements of the different terminal types, reduces the signaling overheads, and improves communication quality.

The foregoing mainly describes the solutions provided in embodiments of this application from a perspective of interaction between the devices. It may be understood that, to implement the foregoing functions, each device includes a corresponding hardware structure and/or software module for performing each function. A person skilled in the art should easily be aware that, in combination with algorithms and steps in the examples described in embodiments disclosed in this specification, this application can be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, each device may be divided into function modules based on the foregoing method examples, for example, each function module may be obtained through division based on each corresponding function, or two or more functions may be integrated into one processing module. The integrated module may be implemented in a form of hardware, or may be implemented in a form of a software function module. It should be noted that, in embodiments of this application, division into the modules is an example, and is merely logical function division. In actual implementation, another division manner may be used.

When each function module is obtained through division based on each corresponding function, FIG. 8 shows a terminal device. The terminal device 80 may include a processing module 801 and a transceiver module 802. For example, the terminal device 80 may be a terminal device, or may be a chip used in a terminal device or another combined component or part that has a function of the terminal device. When the terminal device 80 is a terminal device, the processing module 801 may be a processor (or a processing circuit), for example, a baseband processor. The baseband processor may include one or more CPUs. The transceiver module 802 may be a transceiver. The transceiver may include an antenna, a radio frequency circuit, and the like. When the terminal device 80 is a part that has a function of the terminal device, the processing module 801 may be a processor (or a processing circuit), for example, a baseband processor. The transceiver module 802 may be a radio frequency unit. When the terminal device 80 is a chip system, the processing module 801 may be a processor (or a processing circuit) of the chip system, and may include one or more central processing units. The transceiver module 802 may be an input/output interface of a chip (for example, a baseband chip). It should be understood that, in this embodiment of this application, the processing module 801 may be implemented by a processor or a processor-related circuit component (or referred to as a processing circuit), and the transceiver module 802 may be implemented by a transceiver or a transceiver-related circuit component.

For example, the processing module 801 may be configured to perform all operations, other than receiving and sending operations, performed by the terminal device in the embodiments shown in FIG. 3a to FIG. 7, and/or configured to support another process of the technology described in this specification. The transceiver module 802 may be configured to perform all the receiving and sending operations performed by the terminal device in the embodiments shown in FIG. 3a to FIG. 7, and/or configured to support another process of the technology described in this specification.

The processing module 801 is configured to determine a first value candidate set. The first value candidate set corresponds to a terminal type of the terminal device, and the first value candidate set includes a value candidate set of a radio resource control RRC parameter corresponding to the terminal type. The transceiver module 802 is configured to receive a first value from a network device. The first value includes a group of RRC parameter values in the first value candidate set. The processing module 801 is configured to perform communication based on the first value.

In a possible design, a type of the RRC parameter corresponding to the terminal type includes one or more of the following: a data transmission configuration parameter, a channel state information CSI measurement and feedback configuration parameter, an initial access configuration parameter, a mobility configuration parameter, a power control configuration parameter, and a beam management configuration parameter.

In a possible design, the value candidate set of the RRC parameter indicates a configuration manner of the RRC parameter. The configuration manner includes a configuration parameter field, and the configuration parameter field includes a configuration parameter of the configuration manner. Alternatively, the configuration manner includes a configuration parameter.

In a possible design, the transceiver module 802 is further configured to receive the first value candidate set from the network device.

In a possible design, before receiving the first value candidate set from the network device, the transceiver module 802 is further configured to send first request information to the network device. The first request information is used to request the value candidate set of the RRC parameter corresponding to the terminal type.

In a possible design, the transceiver module 802 is further configured to send first feature information to the network device. The first feature information indicates the terminal type.

In a possible design, when the terminal type is an enhanced mobile broadband eMBB device, a type of an RRC parameter corresponding to the eMBB includes the data transmission configuration parameter, the channel state information CSI measurement and feedback configuration parameter, the initial access configuration parameter, the mobility configuration parameter, the power control configuration parameter, and the beam management configuration parameter; and/or when the terminal type is an ultra-reliable low-latency communication URLLC device, a type of an RRC parameter corresponding to the URLLC includes the data transmission configuration parameter, the channel state information CSI measurement and feedback configuration parameter, and the beam management configuration parameter; and/or when the terminal type is an Internet of Things IoT device, a type of an RRC parameter corresponding to the IoT includes the data transmission configuration parameter, the initial access configuration parameter, and the mobility configuration parameter; and/or; when the terminal type is customer premises equipment CPE, a type of an RRC parameter corresponding to the CPE includes the data transmission configuration parameter and the channel state information CSI measurement and feedback configuration parameter.

In a possible design, when the terminal type is the enhanced mobile broadband eMBB device, a value candidate set of a subcarrier spacing configuration parameter in the data transmission configuration parameter is 15 kHz, 30 kHz, 120 kHz, and 240 kHz, a value candidate set of a CSI reporting time domain configuration parameter in the CSI measurement and feedback configuration parameter is periodic reporting, aperiodic reporting, and semi-persistent reporting, and a value candidate set of a beam failure recovery timing parameter in the beam management configuration parameter is 10 ms, 20 ms, 40 ms, 60 ms, 80 ms, 100 ms, 150 ms, and 200 ms; and/or when the terminal type is the ultra-reliable low-latency communication URLLC device, a value candidate set of a subcarrier spacing configuration parameter in the data transmission configuration parameter is 30 kHz, 60 kHz, and 120 kHz, a value candidate set of a CSI reporting time domain configuration parameter in the CSI measurement and feedback configuration parameter is aperiodic reporting, and a value candidate set of a beam failure recovery timing parameter in the beam management configuration parameter is 10 ms, 20 ms, and 40 ms; and/or when the terminal type is the Internet of Things IoT device, a value candidate set of a subcarrier spacing configuration parameter in the data transmission configuration parameter is 15 kHz and 120 kHz; and/or; when the terminal type is the customer premises equipment CPE, a value of a subcarrier spacing configuration parameter in the data transmission configuration parameter is 15 kHz or 120 kHz, and a value candidate set of a CSI reporting time domain configuration parameter in the CSI measurement and feedback configuration parameter is periodic reporting.

In a possible design, the terminal type is determined based on one or more of the following factors: a service type, mobility, a transmission latency requirement, a channel environment, a reliability requirement, a coverage requirement, and a communication scenario.

In another possible implementation, the processing module 801 and the transceiver module 802 in the terminal device 80 shown in FIG. 8 may be further configured as follows.

The transceiver module 802 is configured to receive first downlink control information DCI from a network device. The first DCI includes values of a plurality of DCI parameters, and the DCI parameter included in the first DCI corresponds to a terminal type of the terminal device. A candidate set of the value of the DCI parameter corresponds to the terminal type, and the candidate set includes at least one value of the DCI parameter corresponding to the terminal type. The processing module 801 is configured to perform communication based on the first DCI.

In a possible design, the processing module 801 is further configured to determine a first DCI format. The first DCI format corresponds to the terminal type. The transceiver module 802 is further configured to receive the first DCI from the network device based on the first DCI format.

In a possible design, the processing module 801 is further configured to determine the candidate set of the value of the DCI parameter based on the first DCI format and a correspondence between a DCI format and the candidate set of the value of the DCI parameter.

In a possible design, the transceiver module 802 is further configured to receive, by the terminal device, indication information from the network device. The indication information indicates the DCI parameter corresponding to the terminal type and the candidate set of the value of the DCI parameter.

In a possible design, before receiving the indication information from the network device, the transceiver module 802 is further configured to send, by the terminal device, second request information to the network device. The second request information is used to request the DCI parameter corresponding to the terminal type and the candidate set of the value of the DCI parameter.

In a possible design, the transceiver module 802 is further configured to send second feature information to the network device. The second feature information indicates the terminal type.

In a possible design, when the terminal type is an enhanced mobile broadband eMBB device, a DCI parameter corresponding to the eMBB includes time domain resource assignment, frequency domain resource assignment, a bandwidth part BWP indicator, a modulation and coding scheme MCS, a new data indicator, a redundancy version, a hybrid automatic repeat request HARQ process number, HARQ timing, a transmit power control TPC command, an antenna port, precoding and a number of layers, a sounding reference signal SRS request, and a channel state information CSI request; and/or when the terminal type is an ultra-reliable low-latency communication URLLC device, a DCI parameter corresponding to the URLLC includes a time domain resource indicator, a frequency domain resource indicator, a modulation and coding scheme MCS, a new data indicator, a hybrid automatic repeat request HARQ process number, a transmit power control command, a sounding reference signal SRS request, and a channel state information CSI request; and/or when the terminal type is an Internet of Things IoT device, a DCI parameter corresponding to the IoT includes a frequency domain resource indicator, a modulation and coding scheme MCS, and a hybrid automatic repeat request HARQ process number; and/or when the terminal type is customer premises equipment CPE, a DCI parameter corresponding to the CPE includes time domain resource assignment, frequency domain resource assignment, a bandwidth part BWP indicator, a modulation and coding scheme MCS, a new data indicator, a redundancy version, a hybrid automatic repeat request HARQ process number, HARQ timing, a transmit power control TPC command, an antenna port, precoding and a number of layers, a sounding reference signal SRS request, and a channel state information CSI request.

In a possible design, when the terminal type is the enhanced mobile broadband eMBB device, a quantity of bits corresponding to a candidate set of a value of the MCS parameter is 5, and a quantity of bits corresponding to a candidate set of a value of the HARQ process number parameter is 4; and/or when the terminal type is the ultra-reliable low-latency communication URLLC device, a quantity of bits corresponding to a candidate set of a value of the MCS parameter is 2 or 3, a quantity of bits corresponding to a candidate set of a value of the HARQ process number parameter is 1, a quantity of bits corresponding to a candidate set of a value of the sounding reference signal SRS request parameter is 1, and a quantity of bits corresponding to a candidate set of a value of the channel state information CSI request parameter is 1; and/or when the terminal type is the Internet of Things IoT device, a quantity of bits corresponding to a candidate set of a value of the MCS parameter is 2 or 3, and a quantity of bits corresponding to a candidate set of a value of the HARQ process number parameter is 1 or 2; and/or when the terminal type is the customer premises equipment CPE, a quantity of bits corresponding to a candidate set of a value of the MCS parameter is 2, 3, 4, or 5, and a quantity of bits corresponding to a candidate set of a value of the HARQ process number parameter is 4.

In a possible design, when the terminal type is an enhanced mobile broadband eMBB device, a DCI format corresponding to the eMBB is a format 1, and a DCI parameter corresponding to the format 1 and a candidate set of a value of the DCI parameter are as follows: A quantity of bits corresponding to a candidate set of a value of a modulation and coding scheme MCS parameter is 5, and a quantity of bits corresponding to a candidate set of a value of a hybrid automatic repeat request HARQ process number parameter is 4; and/or when the terminal type is an ultra-reliable low-latency communication URLLC device, a DCI format corresponding to the URLLC is a format 2, and a DCI parameter corresponding to the format 2 and a candidate set of a value of the DCI parameter are as follows: A quantity of bits corresponding to a candidate set of a value of a modulation and coding scheme MCS parameter is 2 or 3, a quantity of bits corresponding to a candidate set of a value of a hybrid automatic repeat request HARQ process number parameter is 1, a quantity of bits corresponding to a candidate set of a value of a sounding reference signal SRS request parameter is 1, and a quantity of bits corresponding to a candidate set of a value of a channel state information CSI request parameter is 1; and/or when the terminal type is an Internet of Things IoT device, a DCI format corresponding to the IoT is a format 3, and a DCI parameter corresponding to the format 3 and a candidate set of a value of the DCI parameter are as follows: A quantity of bits corresponding to a candidate set of a value of a modulation and coding scheme MCS parameter is 2 or 3, and a quantity of bits corresponding to a candidate set of a value of a hybrid automatic repeat request HARQ process number parameter is 1 or 2; and/or when the terminal type is customer premises equipment CPE, a DCI format corresponding to the CPE is a format 4, and a DCI parameter corresponding to the format 4 and a candidate set of a value of the DCI parameter are as follows: a quantity of bits corresponding to a candidate set of a value of a modulation and coding scheme MCS parameter is 2, 3, 4, or 5, and a quantity of bits corresponding to a candidate set of a value of a hybrid automatic repeat request HARQ process number parameter is 4.

In a possible design, the terminal type is determined based on one or more of the following factors: a service type, mobility, a transmission latency requirement, a channel environment, a reliability requirement, a coverage requirement, and a communication scenario.

In still another possible implementation, the processing module 801 in FIG. 8 may be replaced with a processor, and functions of the processing module 801 may be integrated into the processor. The transceiver module 802 may be replaced with a transceiver, and functions of the transceiver module 802 may be integrated into the transceiver. Further, the terminal device 80 shown in FIG. 8 may further include a memory. When the processing module 801 is replaced with the processor, and the transceiver module 802 is replaced with the transceiver, the terminal device 80 in this embodiment of this application may be the communication apparatus shown in FIG. 2.

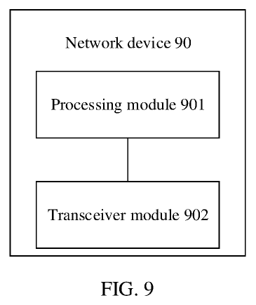

When each function module is obtained through division based on each corresponding function, FIG. 9 shows a network device. The network device 90 may include a processing module 901 and a transceiver module 902. For example, the network device 90 may be a network device, or may be a chip used in a network device or another combined component or part that has a function of the network device. When the network device 90 is a network device, the transceiver module 902 may be a transceiver. The transceiver may include an antenna, a radio frequency circuit, and the like. The processing module 901 may be a processor (or a processing circuit), for example, a baseband processor. The baseband processor may include one or more CPUs. When the network device 90 is a part that has a function of the network device, the transceiver module 902 may be a radio frequency unit, and the processing module 901 may be a processor (or a processing circuit), for example, a baseband processor. When the network device 90 is a chip system, the transceiver module 902 may be an input/output interface of a chip (for example, a baseband chip), and the processing module 901 may be a processor (or a processing circuit) of the chip system, and may include one or more central processing units. It should be understood that, in this embodiment of this application, the transceiver module 902 may be implemented by a transceiver or a transceiver-related circuit component, and the processing module 901 may be implemented by a processor or a processor-related circuit component (or referred to as a processing circuit).

For example, the processing module 901 may be configured to perform all operations, other than the receiving and sending operations, performed by the network device in the embodiments shown in FIG. 3a to FIG. 7, and/or configured to support another process of the technology described in this specification. For example, the transceiver module 902 may be configured to perform all the sending and receiving operations performed by the network device in the embodiments shown in FIG. 3a to FIG. 7, and/or configured to support another process of the technology described in this specification.

The processing module 901 is configured to determine a first value. The transceiver module 902902 is configured to send the first value to a terminal device. The first value includes a group of RRC parameter values in a first value candidate set. The first value candidate set corresponds to a terminal type of the terminal device, and the first value candidate set includes a value candidate set of a radio resource control RRC parameter corresponding to the terminal type.

In a possible design, a type of the RRC parameter corresponding to the terminal type includes one or more of the following: a data transmission configuration parameter, a channel state information CSI measurement and feedback configuration parameter, an initial access configuration parameter, a mobility configuration parameter, a power control configuration parameter, and a beam management configuration parameter.

In a possible design, the value candidate set of the RRC parameter indicates a configuration manner of the RRC parameter. The configuration manner includes a configuration parameter field, and the configuration parameter field includes a configuration parameter of the configuration manner. Alternatively, the configuration manner includes a configuration parameter.

In a possible design, the transceiver module 902 is further configured to send the first value candidate set to the terminal device.

In a possible design, before sending the first value candidate set to the terminal device, the transceiver module 902 is further configured to receive first request information from the terminal device. The first request information is used to request the value candidate set of the RRC parameter corresponding to the terminal type.

In a possible design, the transceiver module 902 is further configured to receive first feature information from the terminal device. The first feature information indicates the terminal type.

In a possible design, when the terminal type is an enhanced mobile broadband eMBB device, a type of an RRC parameter corresponding to the eMBB includes the data transmission configuration parameter, the channel state information CSI measurement and feedback configuration parameter, the initial access configuration parameter, the mobility configuration parameter, the power control configuration parameter, and the beam management configuration parameter; and/or when the terminal type is an ultra-reliable low-latency communication URLLC device, a type of an RRC parameter corresponding to the URLLC includes the data transmission configuration parameter, the channel state information CSI measurement and feedback configuration parameter, and the beam management configuration parameter; and/or when the terminal type is an Internet of Things IoT device, a type of an RRC parameter corresponding to the IoT includes the data transmission configuration parameter, the initial access configuration parameter, and the mobility configuration parameter; and/or; when the terminal type is customer premises equipment CPE, a type of an RRC parameter corresponding to the CPE includes the data transmission configuration parameter and the channel state information CSI measurement and feedback configuration parameter.

In a possible design, when the terminal type is the enhanced mobile broadband eMBB device, a value candidate set of a subcarrier spacing configuration parameter in the data transmission configuration parameter is 15 kHz, 30 kHz, 120 kHz, and 240 kHz, a value candidate set of a CSI reporting time domain configuration parameter in the CSI measurement and feedback configuration parameter is periodic reporting, aperiodic reporting, and semi-persistent reporting, and a value candidate set of a beam failure recovery timing parameter in the beam management configuration parameter is 10 ms, 20 ms, 40 ms, 60 ms, 80 ms, 100 ms, 150 ms, and 200 ms; and/or when the terminal type is the ultra-reliable low-latency communication URLLC device, a value candidate set of a subcarrier spacing configuration parameter in the data transmission configuration parameter is 30 kHz, 60 kHz, and 120 kHz, a value candidate set of a CSI reporting time domain configuration parameter in the CSI measurement and feedback configuration parameter is aperiodic reporting, and a value candidate set of a beam failure recovery timing parameter in the beam management configuration parameter is 10 ms, 20 ms, and 40 ms; and/or when the terminal type is the Internet of Things IoT device, a value candidate set of a subcarrier spacing configuration parameter in the data transmission configuration parameter is 15 kHz and 120 kHz; and/or; when the terminal type is the customer premises equipment CPE, a value of a subcarrier spacing configuration parameter in the data transmission configuration parameter is 15 kHz or 120 kHz, and a value candidate set of a CSI reporting time domain configuration parameter in the CSI measurement and feedback configuration parameter is periodic reporting.

In a possible design, the terminal type is determined based on one or more of the following factors: a service type, mobility, a transmission latency requirement, a channel environment, a reliability requirement, a coverage requirement, and a communication scenario.

In another possible implementation, the processing module 901 and the transceiver module 902 in the terminal device 90 shown in FIG. 9 may be further configured as follows.

The processing module 901 is configured to determine first DCI. The first DCI includes values of a plurality of DCI parameters, and the DCI parameter included in the first DCI corresponds to a terminal type of a terminal device. A candidate set of the value of the DCI parameter corresponds to the terminal type, and the candidate set includes at least one value of the DCI parameter corresponding to the terminal type. The transceiver module 902 is configured to send the first DCI to the terminal device.

In a possible design, the transceiver module 902 is further configured to send, by the network device, a first DCI format to the terminal device, so that the terminal device receives the first DCI from the network device based on the first DCI format. The first DCI format corresponds to the terminal type.

In a possible design, before sending the first DCI to the terminal device, the transceiver module 902 is further configured to send indication information to the terminal device. The indication information indicates the DCI parameter corresponding to the terminal type and the candidate set of the value of the DCI parameter.

In a possible design, before sending the indication information to the terminal device, the transceiver module 902 is further configured to receive second request information from the terminal device. The second request information is used to request the DCI parameter corresponding to the terminal type and the candidate set of the value of the DCI parameter.

In a possible design, the transceiver module 902 is further configured to receive second feature information from the terminal device. The second feature information indicates the terminal type.

In a possible design, when the terminal type is an enhanced mobile broadband eMBB device, a DCI parameter corresponding to the eMBB includes time domain resource assignment, frequency domain resource assignment, a bandwidth part BWP indicator, a modulation and coding scheme MCS, a new data indicator, a redundancy version, a hybrid automatic repeat request HARQ process number, HARQ timing, a transmit power control TPC command, an antenna port, precoding and a number of layers, a sounding reference signal SRS request, and a channel state information CSI request; and/or when the terminal type is an ultra-reliable low-latency communication URLLC device, a DCI parameter corresponding to the URLLC includes a time domain resource indicator, a frequency domain resource indicator, a modulation and coding scheme MCS, a new data indicator, a hybrid automatic repeat request HARQ process number, a transmit power control command, a sounding reference signal SRS request, and a channel state information CSI request; and/or when the terminal type is an Internet of Things IoT device, a DCI parameter corresponding to the IoT includes a frequency domain resource indicator, a modulation and coding scheme MCS, and a hybrid automatic repeat request HARQ process number; and/or when the terminal type is customer premises equipment CPE, a DCI parameter corresponding to the CPE includes time domain resource assignment, frequency domain resource assignment, a bandwidth part BWP indicator, a modulation and coding scheme MCS, a new data indicator, a redundancy version, a hybrid automatic repeat request HARQ process number, HARQ timing, a transmit power control TPC command, an antenna port, precoding and a number of layers, a sounding reference signal SRS request, and a channel state information CSI request.

In a possible design, when the terminal type is the enhanced mobile broadband eMBB device, a quantity of bits corresponding to a candidate set of a value of the MCS parameter is 5, and a quantity of bits corresponding to a candidate set of a value of the HARQ process number parameter is 4; and/or when the terminal type is the ultra-reliable low-latency communication URLLC device, a quantity of bits corresponding to a candidate set of a value of the MCS parameter is 2 or 3, a quantity of bits corresponding to a candidate set of a value of the HARQ process number parameter is 1, a quantity of bits corresponding to a candidate set of a value of the sounding reference signal SRS request parameter is 1, and a quantity of bits corresponding to a candidate set of a value of the channel state information CSI request parameter is 1; and/or when the terminal type is the Internet of Things IoT device, a quantity of bits corresponding to a candidate set of a value of the MCS parameter is 2 or 3, and a quantity of bits corresponding to a candidate set of a value of the HARQ process number parameter is 1 or 2; and/or when the terminal type is the customer premises equipment CPE, a quantity of bits corresponding to a candidate set of a value of the MCS parameter is 2, 3, 4, or 5, and a quantity of bits corresponding to a candidate set of a value of the HARQ process number parameter is 4.

In a possible design, when the terminal type is an enhanced mobile broadband eMBB device, a DCI format corresponding to the eMBB is a format 1, and a DCI parameter corresponding to the format 1 and a candidate set of a value of the DCI parameter are as follows: A quantity of bits corresponding to a candidate set of a value of a modulation and coding scheme MCS parameter is 5, and a quantity of bits corresponding to a candidate set of a value of a hybrid automatic repeat request HARQ process number parameter is 4; and/or when the terminal type is an ultra-reliable low-latency communication URLLC device, a DCI format corresponding to the URLLC is a format 2, and a DCI parameter corresponding to the format 2 and a candidate set of a value of the DCI parameter are as follows: A quantity of bits corresponding to a candidate set of a value of a modulation and coding scheme MCS parameter is 2 or 3, a quantity of bits corresponding to a candidate set of a value of a hybrid automatic repeat request HARQ process number parameter is 1, a quantity of bits corresponding to a candidate set of a value of a sounding reference signal SRS request parameter is 1, and a quantity of bits corresponding to a candidate set of a value of a channel state information CSI request parameter is 1; and/or when the terminal type is an Internet of Things IoT device, a DCI format corresponding to the IoT is a format 3, and a DCI parameter corresponding to the format 3 and a candidate set of a value of the DCI parameter are as follows: A quantity of bits corresponding to a candidate set of a value of a modulation and coding scheme MCS parameter is 2 or 3, and a quantity of bits corresponding to a candidate set of a value of a hybrid automatic repeat request HARQ process number parameter is 1 or 2; and/or when the terminal type is customer premises equipment CPE, a DCI format corresponding to the CPE is a format 4, and a DCI parameter corresponding to the format 4 and a candidate set of a value of the DCI parameter are as follows: a quantity of bits corresponding to a candidate set of a value of a modulation and coding scheme MCS parameter is 2, 3, 4, or 5, and a quantity of bits corresponding to a candidate set of a value of a hybrid automatic repeat request HARQ process number parameter is 4.

In a possible design, the terminal type is determined based on one or more of the following factors: a service type, mobility, a transmission latency requirement, a channel environment, a reliability requirement, a coverage requirement, and a communication scenario.

In still another possible implementation, the transceiver module 902 in FIG. 9 may be replaced with a transceiver, and functions of the transceiver module 902 may be integrated into the transceiver. The processing module 901 may be replaced with a processor, and functions of the processing module 901 may be integrated into the processor. Further, the network device 90 shown in FIG. 9 may further include a memory. When the transceiver module 902 is replaced with the transceiver, and the processing module 901 is replaced with the processor, the network device 90 in this embodiment of this application may be the communication apparatus shown in FIG. 2.

An embodiment of this application further provides a computer-readable storage medium. All or some of the procedures in the foregoing method embodiments may be implemented by a computer program instructing related hardware. The program may be stored in the computer-readable storage medium. When the program is executed, the procedures of the foregoing method embodiments may be included. The computer-readable storage medium may be an internal storage unit of the terminal (including a data transmit end and/or a data receive end) in any one of the foregoing embodiments, for example, a hard disk or a memory of the terminal. The computer-readable storage medium may be alternatively an external storage device of the terminal, for example, a plug-in hard disk, a smart media card (SMC), a secure digital (SD) card, a flash card, or the like that is configured on the terminal. Further, the computer-readable storage medium may alternatively include both an internal storage unit and an external storage device of the terminal. The computer-readable storage medium is configured to store the computer program and another program and data that are required by the terminal. The computer-readable storage medium may be further configured to temporarily store data that has been output or is to be output.

It should be noted that, in the specification, claims, and accompanying drawings of this application, the terms “first”, “second”, and the like are intended to distinguish between different objects but do not indicate a particular order. In addition, the terms “including”, “having”, and any other variants thereof are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

It should be understood that, in this application, “at least one” means one or more, “a plurality of” means two or more, “at least two” means two, three, or more, and “and/or” is used to describe an association relationship between associated objects, and indicates that there may be three relationships. For example, “A and/or B” may indicate the following three cases: Only A exists, only B exists, and both A and B exist, where A and B may be singular or plural. The character “/” generally indicates an “or” relationship between associated objects. “At least one of the following items (pieces)” or a similar expression thereof refers to any combination of these items, including any combination of singular items (pieces) or plural items (pieces). For example, at least one of a, b, or c may indicate a, b, c, a and b, a and c, b and c, or a, b, and c, where a, b, and c may be singular or plural.

Based on the descriptions of the foregoing implementations, it may be clearly understood by a person skilled in the art that, for ease and brevity of description, division into the foregoing function modules is merely used as an example for description. In actual application, the foregoing functions may be allocated to different function modules for implementation based on a requirement, that is, an internal structure of the apparatus is divided into different function modules, to implement all or some of the functions described above.

In the several embodiments provided in this application, it should be understood that the disclosed apparatus and method may be implemented in other manners. For example, the described apparatus embodiment is merely an example. For example, division into the modules or the units is merely logical function division and may be other division in actual implementation. For example, a plurality of units or components may be combined or integrated into another apparatus, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may be one or more physical units, may be located in one place, or may be distributed in different places. Some or all of the units may be selected based on actual requirements, to achieve the objectives of the solutions of embodiments.

In addition, functional units in embodiments of this application may be integrated into one processing unit, each of the units may exist alone physically, or two or more units may be integrated into one unit. The integrated unit may be implemented in a form of hardware, or may be implemented in a form of a software functional unit.

When the integrated unit is implemented in a form of a software function unit and sold or used as an independent product, the integrated unit may be stored in a readable storage medium. Based on such an understanding, the technical solutions of this application essentially, or the part contributing to the conventional technology, or all or some of the technical solutions may be implemented in the form of a software product. The software product is stored in a storage medium and includes several instructions for instructing a device (which may be a single-chip microcomputer, a chip or the like) or a processor to perform all or some of the steps of the methods described in embodiments of this application. The foregoing storage medium includes any medium that can store program code, for example, a USB flash drive, a removable hard disk, a ROM, a RAM, a magnetic disk, or an optical disc.

What is claimed is:

1. A communication method, comprising:
determining, by a terminal device, a first value candidate set, wherein the first value candidate set corresponds to a terminal type of the terminal device, and the first value candidate set comprises a value candidate set of a radio resource control (RRC) parameter corresponding to the terminal type;
receiving, by the terminal device, a first value from a network device, wherein the first value comprises a group of RRC parameter values in the first value candidate set; and
performing, by the terminal device, communication based on the first value.

2. The method according to claim 1, wherein
a type of the RRC parameter corresponding to the terminal type comprises one or more of a data transmission configuration parameter, a channel state information (CSI) measurement and feedback configuration parameter, an initial access configuration parameter, a mobility configuration parameter, a power control configuration parameter, or a beam management configuration parameter.

3. The method according to claim 2, wherein at least one of:
the terminal type is an enhanced mobile broadband (eMBB) device, a type of an RRC parameter corresponding to the eMBB comprises the data transmission configuration parameter, the channel state information (CSI) measurement and feedback configuration parameter, the initial access configuration parameter, the mobility configuration parameter, the power control configuration parameter, and the beam management configuration parameter;
the terminal type is an ultra-reliable low-latency communication (URLLC) device, a type of an RRC parameter corresponding to the URLLC comprises the data transmission configuration parameter, the channel state information (CSI) measurement and feedback configuration parameter, and the beam management configuration parameter;
the terminal type is an Internet of Things (IoT) device, a type of an RRC parameter corresponding to the IoT comprises the data transmission configuration parameter, the initial access configuration parameter, and the mobility configuration parameter; or
the terminal type is customer premises equipment (CPE), a type of an RRC parameter corresponding to the CPE comprises the data transmission configuration parameter and the channel state information (CSI) measurement and feedback configuration parameter.

4. The method according to claim 3, wherein at least one of:
the terminal type is the enhanced mobile broadband (eMBB) device, a value candidate set of a subcarrier spacing configuration parameter in the data transmission configuration parameter is 15 kHz, 30 kHz, 120 kHz, and 240 kHz, a value candidate set of a CSI reporting time domain configuration parameter in the CSI measurement and feedback configuration parameter is periodic reporting, aperiodic reporting, and semi-persistent reporting, and a value candidate set of a beam failure recovery timing parameter in the beam management configuration parameter is 10 ms, 20 ms, 40 ms, 60 ms, 80 ms, 100 ms, 150 ms, and 200 ms;
the terminal type is the ultra-reliable low-latency communication (URLLC) device, a value candidate set of a subcarrier spacing configuration parameter in the data transmission configuration parameter is 30 kHz, 60 kHz, and 120 kHz, a value candidate set of a CSI reporting time domain configuration parameter in the CSI measurement and feedback configuration parameter is aperiodic reporting, and a value candidate set of a beam failure recovery timing parameter in the beam management configuration parameter is 10 ms, 20 ms, and 40 ms;
the terminal type is the Internet of Things (IoT) device, a value candidate set of a subcarrier spacing configuration parameter in the data transmission configuration parameter is 15 kHz and 120 kHz; or
the terminal type is the customer premises equipment (CPE), a value of a subcarrier spacing configuration parameter in the data transmission configuration parameter is 15 kHz or 120 kHz, and a value candidate set of a CSI reporting time domain configuration parameter in the CSI measurement and feedback configuration parameter is periodic reporting.

5. The method according to claim 1, wherein the value candidate set of the RRC parameter indicates a configuration manner of the RRC parameter, and wherein the configuration manner comprises one of:
a configuration parameter field, and the configuration parameter field comprises a configuration parameter of the configuration manner; or
a configuration parameter.

6. The method according to claim 1, wherein the determining, by a terminal device, the first value candidate set comprises:
receiving, by the terminal device, the first value candidate set from the network device.

7. The method according to claim 6, wherein the method further comprises, before the receiving, by the terminal device, the first value candidate set from the network device:
sending, by the terminal device, first request information to the network device, wherein the first request information requests the value candidate set of the RRC parameter corresponding to the terminal type.

8. The method according to claim 1, wherein the method further comprises:
sending, by the terminal device, first feature information to the network device, wherein the first feature information indicates the terminal type.

9. The method according to claim 1, wherein the terminal type is determined based on one or more of a service type, mobility, a transmission latency requirement, a channel environment, a reliability requirement, a coverage requirement, or a communication scenario.

10. A communication method, comprising:
receiving, by a terminal device, first downlink control information (DCI) from a network device, wherein the first DCI comprises values of a plurality of DCI parameters, the DCI parameter comprised in the first DCI corresponds to a terminal type of the terminal device, a candidate set of the value of the DCI parameter corresponds to the terminal type, and the candidate set comprises at least one value of the DCI parameter corresponding to the terminal type; and
performing, by the terminal device, communication based on the first DCI.

11. The method according to claim 10, wherein the receiving, by a terminal device, first DCI from a network device comprises:
determining, by the terminal device, a first DCI format, wherein the first DCI format corresponds to the terminal type; and
receiving, by the terminal device, the first DCI from the network device based on the first DCI format.

12. A terminal device, comprising:
a processing module, configured to determine a first value candidate set, wherein the first value candidate set corresponds to a terminal type of the terminal device, and the first value candidate set comprises a value candidate set of a radio resource control RRC parameter corresponding to the terminal type; and
a transceiver module, configured to receive a first value from a network device, wherein the first value comprises a group of RRC parameter values in the first value candidate set;
wherein the terminal device performs communication based on the first value.

13. The terminal device according to claim 12, wherein a type of the RRC parameter corresponding to the terminal type comprises one or more of a data transmission configuration parameter, a channel state information (CSI) measurement and feedback configuration parameter, an initial access configuration parameter, a mobility configuration parameter, a power control configuration parameter, or a beam management configuration parameter.

14. The terminal device according to claim 13, wherein at least one of:
the terminal type is an enhanced mobile broadband (eMBB) device, a type of an RRC parameter corresponding to the eMBB comprises the data transmission configuration parameter, the channel state information (CSI) measurement and feedback configuration parameter, the initial access configuration parameter, the mobility configuration parameter, the power control configuration parameter, and the beam management configuration parameter;
the terminal type is an ultra-reliable low-latency communication (URLLC) device, a type of an RRC parameter corresponding to the URLLC comprises the data transmission configuration parameter, the channel state information (CSI) measurement and feedback configuration parameter, and the beam management configuration parameter;
the terminal type is an Internet of Things (IoT) device, a type of an RRC parameter corresponding to the IoT comprises the data transmission configuration parameter, the initial access configuration parameter, and the mobility configuration parameter; or
the terminal type is customer premises equipment (CPE), a type of an RRC parameter corresponding to the CPE comprises the data transmission configuration parameter and the channel state information (CSI) measurement and feedback configuration parameter.

15. The terminal device according to claim 14, wherein at least one of:
the terminal type is the enhanced mobile broadband (eMBB) device, a value candidate set of a subcarrier spacing configuration parameter in the data transmission configuration parameter is 15 kHz, 30 kHz, 120 kHz, and 240 kHz, a value candidate set of a CSI reporting time domain configuration parameter in the CSI measurement and feedback configuration parameter is periodic reporting, aperiodic reporting, and semi-persistent reporting, and a value candidate set of a beam failure recovery timing parameter in the beam management configuration parameter is 10 ms, 20 ms, 40 ms, 60 ms, 80 ms, 100 ms, 150 ms, and 200 ms;
the terminal type is the ultra-reliable low-latency communication (URLLC) device, a value candidate set of a subcarrier spacing configuration parameter in the data transmission configuration parameter is 30 kHz, 60 kHz, and 120 kHz, a value candidate set of a CSI reporting time domain configuration parameter in the CSI measurement and feedback configuration parameter is aperiodic reporting, and a value candidate set of a beam failure recovery timing parameter in the beam management configuration parameter is 10 ms, 20 ms, and 40 ms;
the terminal type is the Internet of Things (IoT) device, a value candidate set of a subcarrier spacing configuration parameter in the data transmission configuration parameter is 15 kHz and 120 kHz; or
the terminal type is the customer premises equipment (CPE), a value of a subcarrier spacing configuration parameter in the data transmission configuration parameter is 15 kHz or 120 kHz, and a value candidate set of a CSI reporting time domain configuration parameter in the CSI measurement and feedback configuration parameter is periodic reporting.

16. The terminal device according to claim 12, wherein the value candidate set of the RRC parameter indicates a configuration manner of the RRC parameter, and wherein the configuration manner comprises one of:
a configuration parameter field, and the configuration parameter field comprises a configuration parameter of the configuration manner; or
a configuration parameter.

17. The terminal device according to claim 12, wherein the transceiver module is further configured to receive the first value candidate set from the network device.

18. The terminal device according to claim 17, wherein the transceiver module is further configured to send, before receiving the first value candidate set from the network device, first request information to the network device, wherein the first request information requests the value candidate set of the RRC parameter corresponding to the terminal type.

19. The terminal device according to claim 12, wherein the transceiver module is further configured to send first feature information to the network device, wherein the first feature information indicates the terminal type.

20. The terminal device according to claim 12, wherein the terminal type is determined based on one or more of a service type, mobility, a transmission latency requirement, a channel environment, a reliability requirement, a coverage requirement, or a communication scenario.
